(19) United States
(12) Patent Application Publication
(10) Pub. No.: US 2024/0189970 A1
(43) Pub. Date: Jun. 13, 2024

(54) IMPACT WRENCH

(71) Applicant: MAKITA CORPORATION, Anjo-shi (JP)

(72) Inventors: Tokuo HIRABAYASHI, Anjo-shi (JP); Kihiro KUSUMOTO, Anjo-shi (JP); Tomoya HATTORI, Anjo-shi (JP)

(73) Assignee: MAKITA CORPORATION, Anjo-shi (JP)

(21) Appl. No.: 18/528,934

(22) Filed: Dec. 5, 2023

(30) Foreign Application Priority Data
Dec. 9, 2022 (JP) 2022-197261
Nov. 9, 2023 (JP) 2023-191828

(51) Int. Cl. B25B 21/02; B25B 23/00

(52) U.S. Cl. CPC B25B 21/02; B25B 23/0035; B25F 5/001

(57) ABSTRACT

An impact wrench includes a motor including a rotor rotatable about a rotation axis extending in a front-rear direction, a spindle rotatable with a rotational force from the rotor, an anvil frontward from at least a part of the spindle and including an anvil shaft and an anvil projection, and a hammer including a hammer projection that strikes the anvil projection in a rotation direction. The anvil shaft includes a first shaft having a circular cross section, a second shaft having a rectangular cross section, and an intermediate portion between the first and second shafts. The second shaft includes four flat portions and four flat portion connectors. Each flat portion has a first edge and a second edge. The intermediate portion includes support portions each connected to the first edge and is connected to the second edge of each flat portion at positions rearward from the support portions.

### CROSS-REFERENCE TO RELATED APPLICATIONS

This application claims the benefit of priority to Japanese Patent Application No. 2022-197261, filed on Dec. 9, 2022, and Japanese Patent Application No. 2023-191828, filed on Nov. 9, 2023, the entire contents of which are hereby incorporated by reference.

### BACKGROUND

### 1. Technical Field

The present disclosure relates to an impact wrench.

### 2. Description of the Background

In the field of impact wrenches, a known impact wrench is described in Japanese Unexamined Patent Application Publication No. 2018-187700.

### BRIEF SUMMARY

An impact wrench includes an anvil strikable by a hammer in a rotation direction. An anvil with lower durability may be cracked.

One or more aspects of the present disclosure are directed to increasing the durability of an anvil.

A first aspect of the present disclosure provides an impact wrench, including:
a motor including a rotor rotatable about a rotation axis extending in a front-rear direction;
a spindle rotatable with a rotational force from the rotor;
an anvil located frontward from at least a part of the spindle, the anvil including
   an anvil shaft extending in an axial direction parallel to the rotation axis, the anvil shaft including
      a first shaft having a circular cross section orthogonal to the rotation axis,
      a second shaft located frontward from the first shaft and having a rectangular cross section orthogonal to the rotation axis, the second shaft including
         four flat portions each having
         a first edge at an end of the flat portion in a first circumferential direction of the rotation axis, and
         a second edge at an end of the flat portion in a second circumferential direction of the rotation axis, and
         four flat portion connectors, and
      an intermediate portion between the first shaft and the second shaft, the intermediate portion including support portions each connected to the first edge, the intermediate portion being connected to the second edge of each of the four flat portions at positions rearward from the support portions, and
   an anvil projection protruding outward from the anvil shaft in a radial direction of the rotation axis; and
a hammer supported by the spindle, the hammer including a hammer projection configured to strike the anvil projection in a rotation direction.

A second aspect of the present disclosure provides an impact wrench, including:
a motor including a rotor rotatable about a rotation axis extending in a front-rear direction;
a spindle rotatable with a rotational force from the rotor;
an anvil located frontward from at least a part of the spindle, the anvil including
   an anvil shaft extending in an axial direction parallel to the rotation axis, the anvil shaft including
      a first shaft having a circular cross section orthogonal to the rotation axis,
      a second shaft located frontward from the first shaft and having a rectangular cross section orthogonal to the rotation axis, the second shaft including
         four flat portions each having
         a first edge at an end of the flat portion in a first circumferential direction of the rotation axis, and
         a second edge at an end of the flat portion in a second circumferential direction of the rotation axis, and
         four flat portion connectors, and
      an intermediate portion between the first shaft and the second shaft, the intermediate portion including, in a plane parallel to each of the four flat portions, a first portion and a second portion, the first portion being located in the first circumferential direction from a center line of a corresponding flat portion of the four flat portions in a circumferential direction and connected to the first edge, the second portion being located in the second circumferential direction from the center line and connected to the second edge, the first portion and the second portion having different shapes, and
   an anvil projection protruding outward from the anvil shaft in a radial direction of the rotation axis; and
a hammer supported by the spindle, the hammer including a hammer projection configured to strike the anvil projection in a rotation direction.

A third aspect of the present disclosure provides an impact wrench, including:
a motor including a rotor rotatable about a rotation axis extending in a front-rear direction;
a spindle rotatable with a rotational force from the rotor;
an anvil located frontward from at least a part of the spindle, the anvil including
   an anvil shaft extending in an axial direction parallel to the rotation axis, the anvil shaft including
      a first shaft having a circular cross section orthogonal to the rotation axis,
      a second shaft located frontward from the first shaft and having a rectangular cross section orthogonal to the rotation axis, the second shaft including
         four flat portions, and
         four flat portion connectors, and
      an intermediate portion between the first shaft and the second shaft, and
   an anvil projection protruding outward from the anvil shaft in a radial direction of the rotation axis;
a hammer supported by the spindle, the hammer including a hammer projection configured to strike the anvil projection in a rotation direction; and
an anvil bearing supporting the anvil,
wherein the anvil is a first anvil including the intermediate portion in a first shape or a second anvil including the intermediate portion in a second shape, and
the anvil bearing supports the first anvil to be replaceable with the second anvil.

The structure according to any one of the above aspects of the present disclosure increases the durability of an anvil.

### BRIEF DESCRIPTION OF DRAWINGS

FIG. 1 is a perspective view of an impact tool according to a first embodiment as viewed from the right front.

FIG. 2 is a side view of the impact tool according to the first embodiment.

FIG. 3 is a longitudinal sectional view of an upper portion of the impact tool according to the first embodiment.

FIG. 4 is a horizontal sectional view of the upper portion of the impact tool according to the first embodiment.

FIG. 5 is a partially enlarged longitudinal sectional view of the impact tool according to the first embodiment.

FIG. 6 is an exploded perspective view of the impact tool according to the first embodiment as viewed from the right front.

FIG. 7 is a perspective view of an anvil in the first embodiment as viewed from the right front.

FIG. 8 is a side view of the anvil in the first embodiment.

FIG. 9 is a front view of the anvil in the first embodiment.

FIG. 10 is a partially enlarged view of the anvil in the first embodiment.

FIG. 11 is a side view of an anvil in a second embodiment.

FIG. 12 is a partially enlarged view of the anvil in the second embodiment.

FIG. 13 is a side view of an anvil in a third embodiment.

FIG. 14 is a side view of an anvil in a fourth embodiment.

FIG. 15 is a partially enlarged view of the anvil in the fourth embodiment.

FIG. 16 is a side view of an anvil in a fifth embodiment.

FIG. 17 is a perspective view of an anvil in a sixth embodiment as viewed from the right front.

FIG. 18 is a perspective view of the anvil in the sixth embodiment as viewed from the left rear.

FIG. 19 is a side view of the anvil in the sixth embodiment.

FIG. 20 is a sectional view of the anvil in the sixth embodiment.

FIG. 21 is a partially enlarged view of the anvil in the sixth embodiment.

FIG. 22 is a perspective view of an anvil in a seventh embodiment as viewed from the right front.

FIG. 23 is a perspective view of the anvil in the seventh embodiment as viewed from the left rear.

FIG. 24 is a side view of the anvil in the seventh embodiment.

FIG. 25 is a sectional view of the anvil in the seventh embodiment.

FIG. 26 is a partially enlarged view of the anvil in the seventh embodiment.

FIG. 27 is a perspective view of an anvil in an eighth embodiment as viewed from the right front.

FIG. 28 is a perspective view of the anvil in the eighth embodiment as viewed from the left rear.

FIG. 29 is a side view of the anvil in the eighth embodiment.

FIG. 30 is a sectional view of the anvil in the eighth embodiment.

FIG. 31 is a perspective view of an anvil in a ninth embodiment as viewed from the right front.

FIG. 32 is a perspective view of the anvil in the ninth embodiment as viewed from the left rear.

FIG. 33 is a side view of the anvil in the ninth embodiment.

FIG. 34 is a sectional view of the anvil in the ninth embodiment.

FIG. 35 is a perspective view of an anvil in a tenth embodiment as viewed from the right front.

FIG. 36 is a perspective view of the anvil in the tenth embodiment as viewed from the left rear.

FIG. 37 is a side view of the anvil in the tenth embodiment.

FIG. 38 is a sectional view of the anvil in the tenth embodiment.

FIG. 39 is a perspective view of an anvil in an eleventh embodiment as viewed from the right front.

FIG. 40 is a perspective view of the anvil in the eleventh embodiment as viewed from the left rear.

FIG. 41 is a side view of the anvil in the eleventh embodiment.

FIG. 42 is a sectional view of the anvil in the eleventh embodiment.

FIG. 43 is a perspective view of an anvil in a twelfth embodiment as viewed from the right front.

FIG. 44 is a perspective view of the anvil in the twelfth embodiment as viewed from the left rear.

FIG. 45 is a side view of the anvil in the twelfth embodiment.

FIG. 46 is a sectional view of the anvil in the twelfth embodiment.

FIG. 47 is a perspective view of an anvil in a thirteenth embodiment as viewed from the right front.

FIG. 48 is a perspective view of the anvil in the thirteenth embodiment as viewed from the left rear.

FIG. 49 is a side view of the anvil in the thirteenth embodiment.

FIG. 50 is a sectional view of the anvil in the thirteenth embodiment.

FIG. 51 is a perspective view of an anvil in a fourteenth embodiment as viewed from the right front.

FIG. 52 is a perspective view of the anvil in the fourteenth embodiment as viewed from the left rear.

FIG. 53 is a side view of the anvil in the fourteenth embodiment.

FIG. 54 is a sectional view of the anvil in the fourteenth embodiment.

FIG. 55 is a perspective view of an anvil in a fifteenth embodiment as viewed from the right front.

FIG. 56 is a perspective view of the anvil in the fifteenth embodiment as viewed from the left rear.

FIG. 57 is a side view of the anvil in the fifteenth embodiment.

FIG. 58 is a sectional view of the anvil in the fifteenth embodiment.

FIG. 59 is a diagram describing an anvil set in a sixteenth embodiment.

FIG. 60 is a table describing the anvil set in the sixteenth embodiment.

FIG. 61 is a diagram describing a spindle and an anvil in a seventeenth embodiment.

### DETAILED DESCRIPTION

One or more embodiments will now be described with reference to the drawings. In the embodiments, the positional relationships between the components will be described using the directional terms such as right and left (or lateral), front and rear (or frontward and rearward), and up and down (or vertical). The terms indicate relative positions or directions with respect to the center of an impact tool 1. The impact tool 1 includes a motor 6 as a power source.

In the embodiments, a direction parallel to a rotation axis AX of the motor 6 is referred to as an axial direction for convenience. A direction about the rotation axis AX is referred to as a circumferential direction or circumferentially, or a rotation direction for convenience. A direction radial from the rotation axis AX is referred to as a radial direction or radially for convenience.

The rotation axis AX extends in the front-rear direction. A first axial direction is from the rear to the front, and a second axial direction is from the front to the rear. A position nearer the rotation axis AX in the radial direction, or a radial direction toward the rotation axis AX, is referred to as radially inward for convenience. A position farther from the rotation axis AX in the radial direction, or a radial direction away from the rotation axis AX, is referred to as radially outward for convenience.

### First Embodiment

### Impact Tool

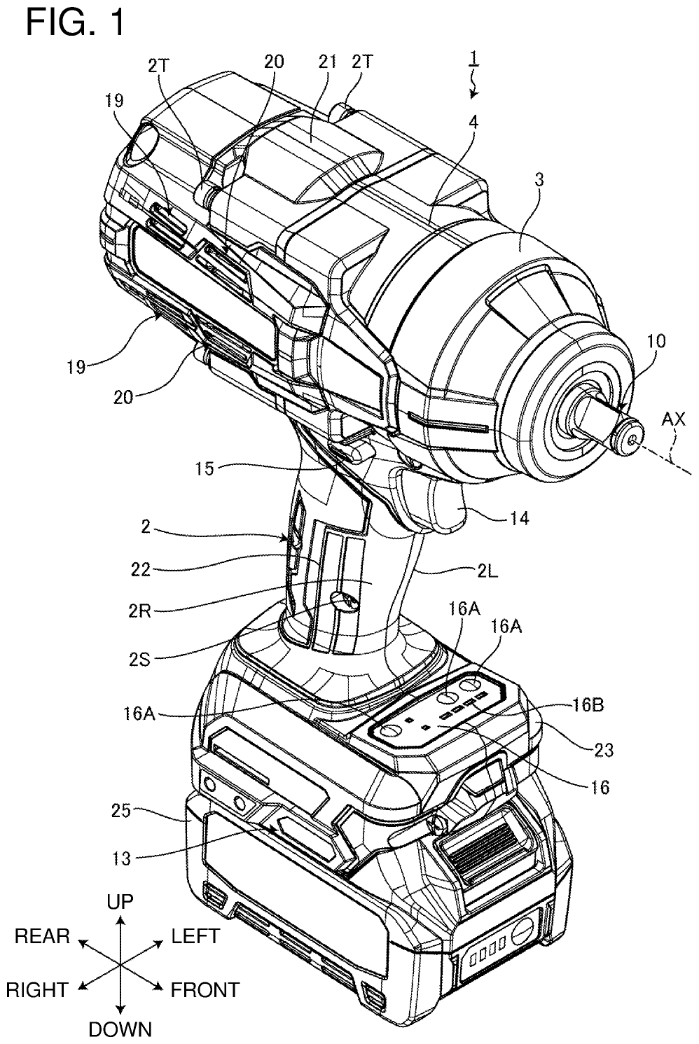

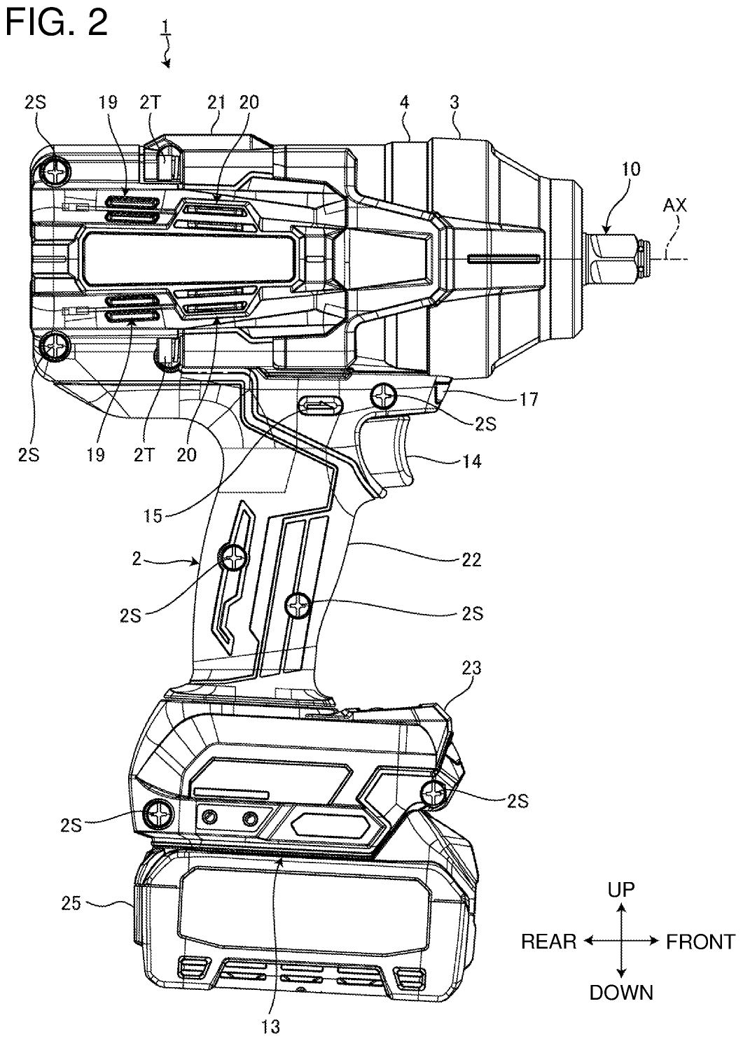

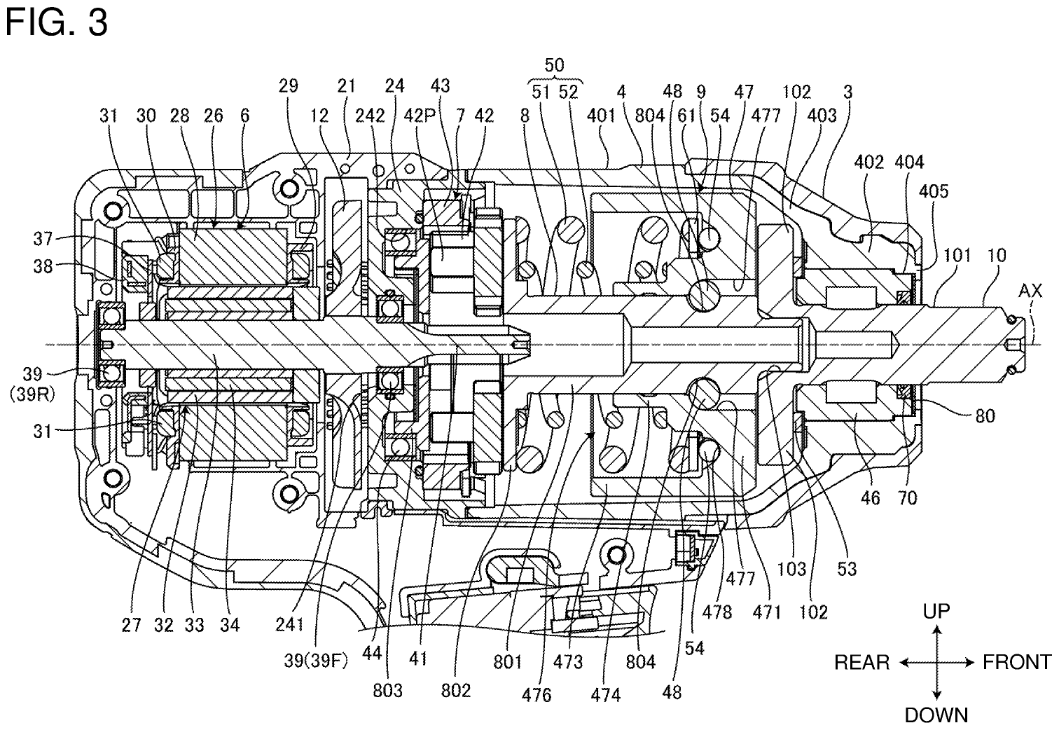

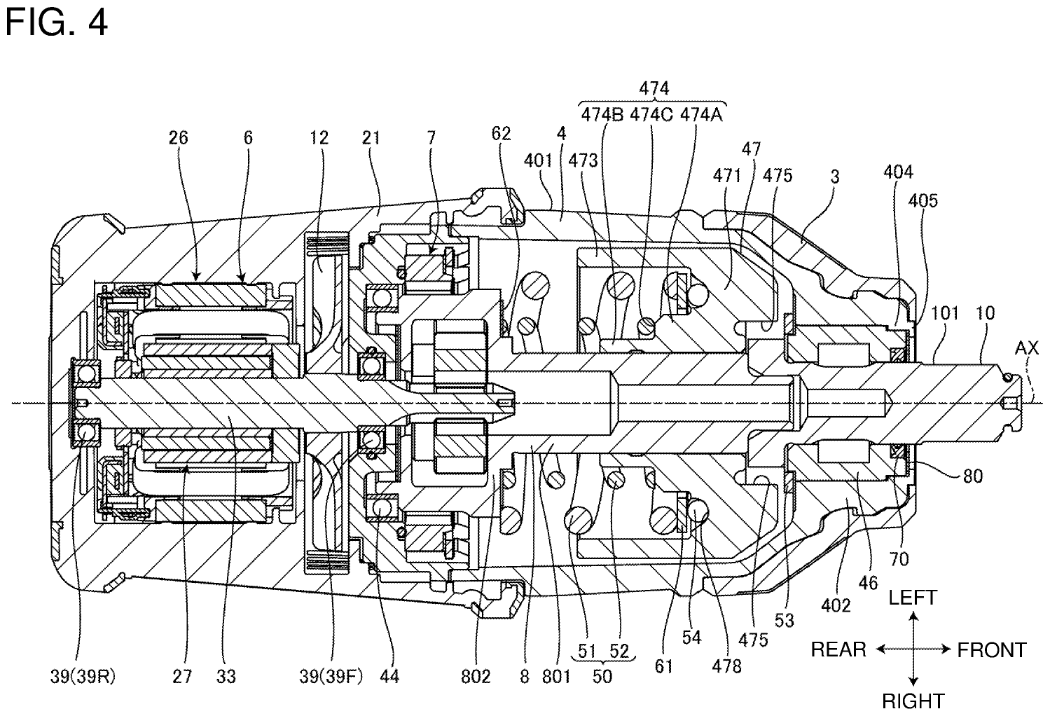

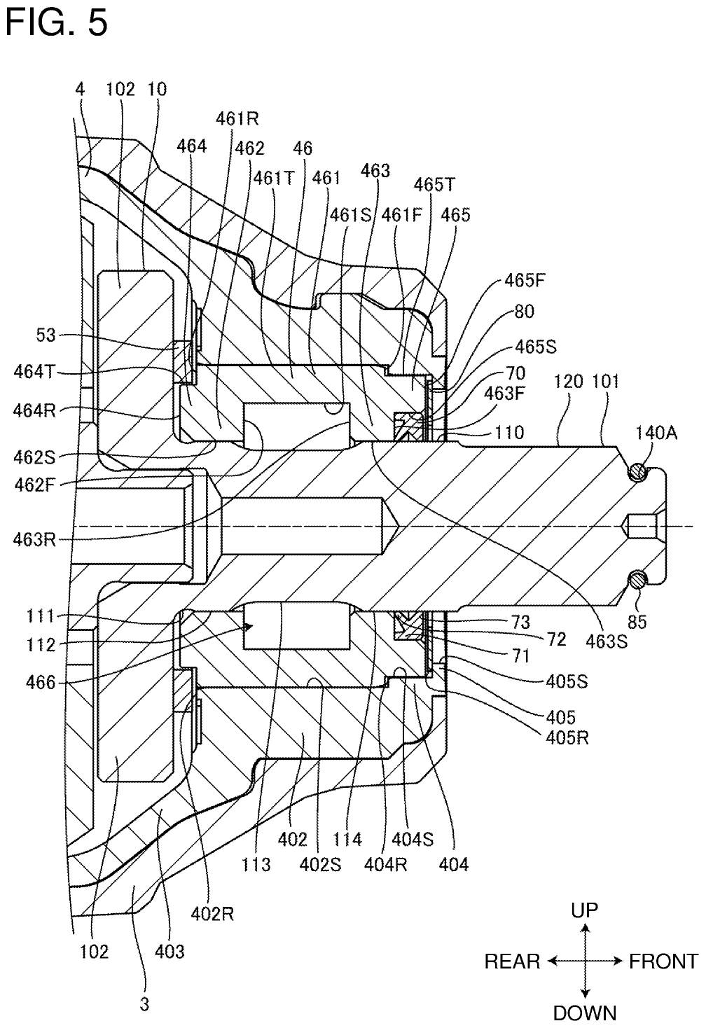

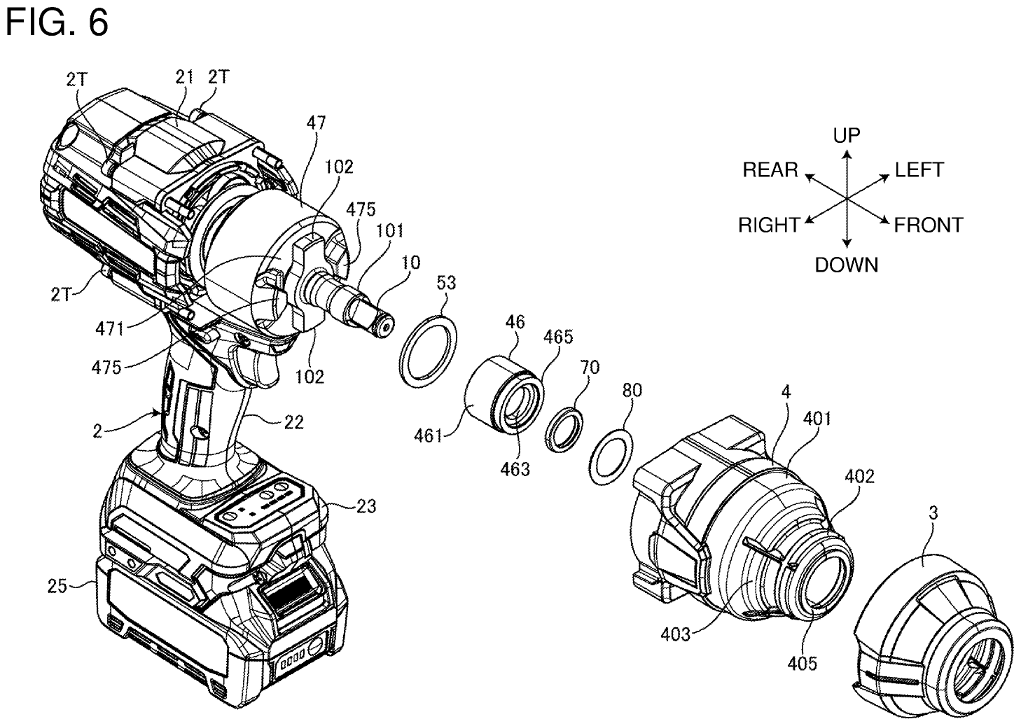

FIG. 1 is a perspective view of an impact tool 1 according to the present embodiment as viewed from the right front. FIG. 2 is a side view of the impact tool 1. FIG. 3 is a longitudinal sectional view of an upper portion of the impact tool 1. FIG. 4 is a horizontal sectional view of the upper portion of the impact tool 1. FIG. 5 is a partially enlarged longitudinal sectional view of the impact tool 1. FIG. 6 is an exploded perspective view of the impact tool 1 as viewed from the right front.

The impact tool 1 according to the embodiment is an impact wrench. The impact tool 1 includes a housing 2, a hammer case 4, a cover 3, the motor 6, a reducer 7, a spindle 8, a striker 9, an anvil 10, a fan 12, a battery mount 13, a trigger lever 14, a forward-reverse switch lever 15, an operation display 16, a light 17, a seal 70, and a support 80.

The housing 2 is formed from a synthetic resin. The housing 2 in the embodiment is formed from nylon. The housing 2 includes a left housing 2L and a right housing 2R. The right housing 2R is located on the right of the left housing 2L. The left and the right housings 2L and 2R are fastened together with multiple screws 2S. The housing 2 includes a pair of housing halves.

The housing 2 includes a motor compartment 21, a grip 22, and a battery holder 23.

The motor compartment 21 accommodates the motor 6. The motor compartment 21 and the hammer case 4 are fastened together with multiple screws 2T.

The grip 22 is grippable by an operator. The grip 22 extends downward from the motor compartment 21. The trigger lever 14 is located in an upper portion of the grip 22.

The battery holder 23 holds a battery pack 25 with the battery mount 13. The battery holder 23 is connected to the lower end of the grip 22. The battery holder 23 has larger outer dimensions than the grip 22 in the front-rear direction and in the lateral direction.

The motor compartment 21 has inlets 19 and outlets 20. The outlets 20 are located frontward from the inlets 19. Air outside the housing 2 flows into the internal space of the housing 2 through the inlets 19, and then flows out of the housing 2 through the outlets 20.

The hammer case 4 accommodates the reducer 7, the spindle 8, the striker 9, and at least a part of the anvil 10. The reducer 7 is at least partially located inside a bearing box 24 The reducer 7 includes multiple gears.

The hammer case 4 is formed from a metal. The hammer case 4 in the embodiment is formed from aluminum. The hammer case 4 is cylindrical. The hammer case 4 is connected to the front of the motor compartment 21. The bearing box 24 is fixed to a rear portion of the hammer case 4. A front portion of the bearing box 24 is fitted into the rear portion of the hammer case 4 to fasten the bearing box 24 and the hammer case 4 together.

The cover 3 covers at least a part of the outer surface of the hammer case 4.

The motor 6 is a power source for the impact tool 1. The motor 6 is an inner-rotor brushless motor. The motor 6 includes a stator 26 and a rotor 27. The stator 26 is supported on the motor compartment 21. The rotor 27 is at least partially located inward from the stator 26. The rotor 27 rotates relative to the stator 26. The rotor 27 rotates about the rotation axis AX extending in the front-rear direction.

The reducer 7 connects the rotor 27 and the spindle 8 together. The reducer 7 transmits rotation of the rotor 27 to the spindle 8. The reducer 7 rotates the spindle 8 at a lower rotational speed than the rotor 27. The reducer 7 is located frontward from the motor 6. The reducer 7 includes a planetary gear assembly. The reducer 7 includes multiple gears. The rotor 27 drives the gears in the reducer 7.

The spindle 8 rotates with a rotational force from the rotor 27 transmitted through the reducer 7. The spindle 8 is located frontward from at least a part of the motor 6. The spindle 8 is located frontward from the stator 26. The spindle 8 is at least partially located frontward from the rotor 27. The spindle 8 is at least partially located in front of the reducer 7. The spindle 8 is located behind the anvil 10.

The striker 9 strikes the anvil 10 in the rotation direction with a rotational force of the spindle 8 rotated by the motor 6. A rotational force from the motor 6 is transmitted to the striker 9 through the reducer 7 and the spindle 8.

The anvil 10 is an output shaft in the impact tool 1. The anvil 10 is rotatable with a rotational force of the rotor 27. The anvil 10 is strikable by the striker 9 in the rotation direction. The anvil 10 is located frontward from the motor 6. The anvil 10 receives a socket as one type of tip tool on its front end. The anvil 10 is located frontward from at least a part of the spindle 8.

The fan 12 generates an airflow for cooling the motor 6. The fan 12 is located frontward from the stator 26 in the motor 6. The fan 12 is fastened to at least a part of the rotor 27. As the fan 12 rotates, air outside the housing 2 flows into the internal space of the housing 2 through the inlets 19 to cool the motor 6. As the fan 12 rotates, the air passing through the housing 2 flows out of the housing 2 through the outlets 20.

The battery mount 13 is connected to the battery pack 25. The battery pack 25 is attached to the battery mount 13 in a detachable manner. The battery mount 13 is located in a lower portion of the battery holder 23. The battery pack 25 is placed onto the battery mount 13 from the front of the battery holder 23 and is thus attached to the battery mount 13. The battery pack 25 is pulled forward along the battery mount 13 and is thus detached from the battery mount 13. The battery pack 25 includes a secondary battery. The battery pack 25 in the embodiment includes a rechargeable lithium-ion battery. The battery pack 25 is attached to the battery mount 13 to power the impact tool 1. The motor 6 is driven by power supplied from the battery pack 25.

The trigger lever 14 is operable by the operator to activate the motor 6. The trigger lever 14 is operable to switch the motor 6 between the driving state and the stopped state. The trigger lever 14 is located on the grip 22.

The forward-reverse switch lever 15 is operable by the operator. The forward-reverse switch lever 15 is operable to switch the rotation direction of the motor 6 between forward and reverse. This operation switches the rotation direction of the spindle 8. The forward-reverse switch lever 15 is located above the grip 22.

The operation display 16 includes multiple operation buttons 16A and an indicator 16B. The operation buttons 16A are operable by the operator to change the operation mode of the motor 6. The indicator 16B includes multiple light emitters. The indicator 16B indicates the operation mode of the motor 6 by changing the lighting patterns of the multiple light emitters. The operation display 16 is located on the battery holder 23. The operation display 16 is located on the upper surface of the battery holder 23 frontward from the grip 22.

The light 17 emits illumination light. The light 17 illuminates the anvil 10 and an area around the anvil 10 with illumination light. The light 17 illuminates an area ahead of the anvil 10 with illumination light. The light 17 also illuminates the tip tool attached to the anvil 10 and an area around the tip tool with illumination light. The light 17 is located above the trigger lever 14.

The hammer case 4 includes a first cylinder 401, a second cylinder 402, a case connector 403, a third cylinder 404, and a fourth cylinder 405. The first cylinder 401 surrounds the striker 9. The second cylinder 402 is located frontward from the first cylinder 401. The second cylinder 402 has a smaller outer diameter than the first cylinder 401. The case connector 403 connects a front portion of the first cylinder 401 and a rear portion of the second cylinder 402. The third cylinder 404 is located frontward from the second cylinder 402. The fourth cylinder 405 is located frontward from the third cylinder 404. The second cylinder 402 has a smaller inner diameter than the first cylinder 401. The third cylinder 404 has a smaller inner diameter than the second cylinder 402. The fourth cylinder 405 has a smaller inner diameter than the third cylinder 404.

As shown in FIG. 5, the second cylinder 402 has a rear surface 402R facing rearward and an inner circumferential surface 402S facing radially inward. The third cylinder 404 has a rear surface 404R facing rearward and an inner circumferential surface 404S facing radially inward. The fourth cylinder 405 has a rear surface 405R facing rearward and an inner circumferential surface 405S facing radially inward. The front end of the inner circumferential surface 402S is connected to the outer end of the rear surface 404R in the radial direction. The front end of the inner circumferential surface 404S is connected to the outer end of the rear surface 405R in the radial direction. The inner circumferential surface 405S defines an opening of the hammer case 4 at the front end of the hammer case 4.

The motor 6 includes the stator 26 and the rotor 27. The stator 26 includes a stator core 28, a front insulator 29, a rear insulator 30, and multiple coils 31. The rotor 27 rotates about the rotation axis AX. The rotor 27 includes a rotor core 32, a rotor shaft 33, and a rotor magnet 34.

The stator core 28 is located radially outward from the rotor 27. The stator core 28 includes multiple steel plates stacked on one another. The steel plates are metal plates formed from iron as a main component. The stator core 28 is cylindrical. The stator core 28 includes multiple teeth to support the coils 31.

The front insulator 29 is located at the front of the stator core 28. The rear insulator 30 is located at the rear of the stator core 28. The front insulator 29 and the rear insulator 30 are electrical insulating members formed from a synthetic resin. The front insulator 29 covers parts of the surfaces of the teeth. The rear insulator 30 covers parts of the surfaces of the teeth.

The coils 31 are attached to the stator core 28 with the front insulator 29 and the rear insulator 30 in between. The coils 31 surround the teeth on the stator core 28 with the front insulator 29 and the rear insulator 30 in between. The coils 31 and the stator core 28 are electrically insulated from each other by the front insulator 29 and the rear insulator 30. The multiple coils 31 are connected to one another with a busbar unit 38.

The rotor core 32 and the rotor shaft 33 are formed from steel. The rotor shaft 33 is located inward from the rotor core 32. The rotor core 32 is fixed to the rotor shaft 33. The rotor shaft 33 has its front end protruding frontward from the front end face of the rotor core 32. The rotor shaft 33 has its rear end protruding rearward from the rear end face of the rotor core 32.

The rotor magnet 34 is fixed to the rotor core 32. The rotor magnet 34 is located inside the rotor core 32.

A sensor board 37 is attached to the rear insulator 30. The sensor board 37 includes a circuit board and a rotation detector. The circuit board is a disk with a hole at the center. The rotation detector is supported on the circuit board. The sensor board 37 at least partially faces the rotor magnet 34. The rotation detector detects the position of the rotor magnet 34 to detect the position of the rotor 27 in the rotation direction.

The rotor shaft 33 is rotatably supported by rotor bearings 39. The rotor bearings 39 include a front rotor bearing 39F and a rear rotor bearing 39R. The front rotor bearing 39F supports the front end of the rotor shaft 33 in a rotatable manner. The rear rotor bearing 39R supports the rear end of the rotor shaft 33 in a rotatable manner.

The front rotor bearing 39F is held by the bearing box 24. The bearing box 24 has a recess 241. The recess 241 is recessed frontward from the rear surface of the bearing box 24. The front rotor bearing 39F is received in the recess 241. The rear rotor bearing 39R is held by a rear portion of the motor compartment 21. The front end of the rotor shaft 33 is located in the internal space of the hammer case 4 through an opening of the bearing box 24.

The fan 12 is fixed to the front of the rotor shaft 33. The fan 12 is located between the front rotor bearing 39F and the stator 26. As the rotor shaft 33 rotates, the fan 12 rotates together with the rotor shaft 33.

A pinion gear 41 is located on the front end of the rotor shaft 33. The pinion gear 41 is connected to at least a part of the reducer 7. The rotor shaft 33 is connected to the reducer 7 with the pinion gear 41.

The reducer 7 includes multiple planetary gears 42 and an internal gear 43. The multiple planetary gears 42 surround the pinion gear 41. The internal gear 43 surrounds the multiple planetary gears 42. The pinion gear 41, the planetary gears 42, and the internal gear 43 are accommodated in the hammer case 4. Each planetary gear 42 meshes with the pinion gear 41. The planetary gears 42 are rotatably supported by the spindle 8 with a pin 42P. The spindle 8 is rotated by the planetary gears 42. The internal gear 43 includes internal teeth that mesh with the planetary gears 42. The internal gear 43 is fixed to the hammer case 4. The internal gear 43 is constantly nonrotatable relative to the hammer case 4.

When the rotor shaft 33 rotates as driven by the motor 6, the pinion gear 41 rotates, and the planetary gears 42 revolve about the pinion gear 41. The planetary gears 42 revolve while meshing with the internal teeth on the internal gear 43. The spindle 8, which is connected to the planetary gears 42 with the pin 42P, rotates at a lower rotational speed than the rotor shaft 33.

The spindle 8 rotates with a rotational force from the motor 6. The spindle 8 transmits the rotational force from the motor 6 to the anvil 10 through the striker 9. The striker 9 rotates with a rotational force from the rotor 27. The spindle 8 includes a spindle shaft 801 and a flange 802. The flange 802 is located on a rear portion of the spindle shaft 801. The planetary gears 42 are rotatably supported by the flange 802 with the pin 42P. The rotation axis of the spindle 8 aligns with the rotation axis AX of the motor 6. The spindle 8 rotates about the rotation axis AX. The spindle 8 is rotatably supported by a spindle bearing 44. The spindle 8 includes a protrusion 803 on its rear end. The protrusion 803 protrudes rearward from the flange 802. The spindle bearing 44 surrounds the protrusion 803.

The bearing box 24 at least partially surrounds the spindle 8. The spindle bearing 44 is held by the bearing box 24. The bearing box 24 has a recess 242. The recess 242 is recessed rearward from the front surface of the bearing box 24. The spindle bearing 44 is received in the recess 242.

The striker 9 includes a hammer 47, hammer balls 48, coil springs 50, and a washer 61. The striker 9 is accommodated in the first cylinder 401 in the hammer case 4. The first cylinder 401 surrounds the hammer 47.

The hammer 47 is located frontward from the reducer 7. The hammer 47 surrounds the spindle shaft 801. The hammer 47 is supported by the spindle shaft 801.

The hammer 47 is rotated by the motor 6. A rotational force from the motor 6 is transmitted to the hammer 47 through the reducer 7 and the spindle 8. The hammer 47 is rotatable together with the spindle 8 with the rotational force of the spindle 8 rotated by the motor 6. The rotation axis of the hammer 47 and the rotation axis of the spindle 8 align with the rotation axis AX of the motor 6. The hammer 47 rotates about the rotation axis AX.

The hammer 47 includes a base 471, a rear ring 473, a support ring 474, and hammer projections 475.

The base 471 surrounds the spindle shaft 801. The base 471 is annular. The spindle shaft 801 is located inward from the base 471.

The rear ring 473 protrudes rearward from the outer circumference of the base 471. The rear ring 473 is cylindrical. The rear ring 473 has its rear end located rearward from the rear end of the support ring 474.

The support ring 474 protrudes rearward from the inner circumference of the base 471. The support ring 474 is cylindrical. The support ring 474 surrounds the spindle shaft 801. The support ring 474 is supported by the spindle shaft 801 with the hammer balls 48 in between. The support ring 474 includes a larger-diameter portion 474A and a smaller-diameter portion 474B. The smaller-diameter portion 474B is located rearward from the larger-diameter portion 474A. The larger-diameter portion 474A has a larger outer diameter than the smaller-diameter portion 474B. A step 474C is at the boundary between the larger-diameter portion 474A and the smaller-diameter portion 474B.

The hammer projections 475 protrude frontward from the front surface of the base 471. The front surfaces of the hammer projections 475 are located frontward from the front surface of the base 471. The hammer projections 475 are two hammer projections 475 arranged circumferentially.

The rear surface of the base 471, the inner circumferential surface of the rear ring 473, and the outer circumferential surface of the support ring 474 define a recess 476. The recess 476 is located on the rear of the hammer 47. The recess 476 is recessed frontward from the rear surface of the hammer 47.

The hammer balls 48 are formed from a metal such as steel. The hammer balls 48 are between the spindle shaft 801 and the hammer 47. The spindle 8 has spindle grooves 804. The spindle grooves 804 receive at least parts of the hammer balls 48. The spindle grooves 804 are on the outer circumferential surface of the spindle shaft 801. The hammer 47 has hammer grooves 477. The hammer grooves 477 receive at least parts of the hammer balls 48. The hammer grooves 477 are on the inner circumferential surface of the support ring 474. Each hammer ball 48 is between the spindle grooves 804 and the hammer grooves 477. The hammer balls 48 roll along the spindle grooves 804 and the hammer grooves 477. The hammer 47 is movable together with the hammer balls 48. The spindle 8 and the hammer 47 are movable relative to each other in the axial direction and in the rotation direction within a movable range defined by the spindle grooves 804 and the hammer grooves 477.

The coil springs 50 surround the spindle shaft 801. The coil springs 50 in the embodiment include a first coil spring 51 and a second coil spring 52 located parallel to each other. The second coil spring 52 is located radially inward from the first coil spring 51. The first coil spring 51 in the embodiment has a greater spring constant than the second coil spring 52. The first coil spring 51 has a larger wire diameter than the second coil spring 52.

The first coil spring 51 and the second coil spring 52 have their rear ends supported on the front surface of the flange 802. The rear end of the first coil spring 51 is in contact with the front surface of the flange 802. The rear end of the second coil spring 52 is supported on the front surface of the flange 802 with a washer 62 in between.

The first coil spring 51 and the second coil spring 52 have their front ends received in the recess 476. The washer 61 is received in the recess 476. The front ends of the first coil spring 51 and the second coil spring 52 are supported by the washer 61. The washer 61 is annular. The first coil spring 51 and the second coil spring 52 each constantly generate an elastic force for moving the hammer 47 forward.

The washer 61 is located behind the base 471. The washer 61 supports the front end of the first coil spring 51 and the front end of the second coil spring 52. The washer 61 is between the rear ring 473 and the support ring 474 in the radial direction. The washer 61 is received in the recess 476. The washer 61 is supported by the hammer 47 with multiple support balls 54 in between. With the hammer 47 at the frontmost position in its movable range in the front-rear direction, the support balls 54 are located frontward from the rear ends of the hammer balls 48.

The support balls 54 are receive in a support groove 478. The support groove 478 is located on the hammer 47 in the recess 476. In the present embodiment, the support groove 478 is located on the rear surface of the base 471. The support groove 478 is annular and surrounds the rotation axis AX. The support balls 54 support the washer 61.

The washer 61 is held between the coil springs 50 and the support balls 54 in the front-rear direction. The washer 61 is spaced from the hammer 47 and the spindle 8.

The anvil 10 includes an anvil shaft 101, anvil projections 102, and a recess 103.

The anvil shaft 101 extends in the axial direction (front-rear direction). The anvil shaft 101 has the rotation axis AX. The anvil shaft 101 is located frontward from the spindle 8 and the hammer 47. The anvil shaft 101 is at least partially received in the opening at the front end of the hammer case 4. As described above, the inner circumferential surface 405S of the fourth cylinder 405 defines the opening at the front end of the hammer case 4. The anvil shaft 101 has its front end protruding frontward through the opening of the hammer case 4. The anvil shaft 101 receives a socket as one type of tip tool on its front end.

The anvil projections 102 protrude radially outward from the rear end of the anvil shaft 101. The anvil projections 102 are struck by the hammer projections 475 in the rotation direction. A washer 53 is between the front surfaces of the anvil projections 102 and the rear surface 402R of the second cylinder 402. The washer 53 reduces contact between the anvil projections 102 and the second cylinder 402. The rear end of the second cylinder 402 receives a load from the anvil projections 102 through the washer 53.

The recess 103 is recessed frontward from a middle portion on the rear surface of the anvil 10. The spindle 8 has its front end received in the recess 103.

The base 471 is located rearward from the anvil projections 102. The rear surfaces of the anvil projections 102 are spaced from the front surface of the base 471.

The anvil 10 is rotatably supported by an anvil bearing 46. The rotation axis of the anvil 10, the rotation axis of the hammer 47, and the rotation axis of the spindle 8 align with the rotation axis AX of the motor 6. The anvil 10 rotates about the rotation axis AX. The anvil bearing 46 surrounds the anvil shaft 101. The anvil bearing 46 is partially located inside the second cylinder 402 in the hammer case 4. The anvil bearing 46 is partially located inside the third cylinder 404 in the hammer case 4. The anvil bearing 46 is held on the second cylinder 402 in the hammer case 4. The anvil bearing 46 is press-fitted in the second cylinder 402. The anvil bearing 46 is fixed to the hammer case 4 inside the hammer case 4. The anvil bearing 46 supports the anvil shaft 101 in a rotatable manner.

As shown in FIG. 5, the anvil bearing 46 includes an outer ring 461, a rear support 462, a front support 463, a rear protrusion 464, and a front protrusion 465. The rear support 462 protrudes radially inward from a rear portion of the outer ring 461. The front support 463 protrudes radially inward from a front portion of the outer ring 461. The rear protrusion 464 protrudes rearward from the rear support 462. The front protrusion 465 protrudes frontward from the front support 463. The outer ring 461, the rear support 462, and the front support 463 define a recess 466 on the anvil bearing 46.

The outer ring 461 has a front surface 461F facing frontward, a rear surface 461R facing rearward, an inner circumferential surface 461S facing radially inward, and an outer circumferential surface 461T facing radially outward.

The rear support 462 has a front surface 462F facing frontward, a rear surface 462R facing rearward, and an inner circumferential surface 462S facing radially inward.

The front support 463 has a front surface 463F facing frontward, a rear surface 463R facing rearward, and an inner circumferential surface 463S facing radially inward.

The rear protrusion 464 has a rear surface 464R facing rearward and an outer circumferential surface 464T facing radially outward.

The front protrusion 465 has a front surface 465F facing frontward, an inner circumferential surface 465S facing radially inward, and an outer circumferential surface 465T facing radially outward.

The outer circumferential surface 461T of the outer ring 461 is in contact with the inner circumferential surface 402S of the second cylinder 402. The inner circumferential surface 461S of the outer ring 461 is spaced from the outer circumferential surface of the anvil shaft 101. The inner circumferential surface 461S of the outer ring 461, the front surface 462F of the rear support 462, and the rear surface 463R of the front support 463 define the recess 466.

As described later, the anvil shaft 101 includes a rear columnar portion 112, a front columnar portion 114, and a recess 113. The inner circumferential surface 461S of the outer ring 461 faces the outer circumferential surface of the recess 113. The inner circumferential surface 462S of the rear support 462 is in contact with the outer circumferential surface of the rear columnar portion 112. The inner circumferential surface 463S of the front support 463 is in contact with the outer circumferential surface of the front columnar portion 114.

The washer 53 has a front surface with its radially outer edge facing the rear surface 402R of the second cylinder 402 and its radially inner edge facing the rear surface 461R of the outer ring 461. The inner circumferential surface of the washer 53 facing radially inward faces the outer circumferential surface 464T of the rear protrusion 464. The rear surface 464R of the rear protrusion 464 faces the front surface of the anvil projections 102 across a gap. The front surface 461F of the outer ring 461 faces the rear surface 404R of the third cylinder 404. The outer circumferential surface 465T of the front protrusion 465 is in contact with the inner circumferential surface 404S of the third cylinder 404.

The hammer projections 475 can come in contact with the anvil projections 102. When the motor 6 operates, with the hammer 47 and the anvil projections 102 in contact with each other, the anvil 10 rotates together with the hammer 47 and the spindle 8.

The anvil 10 is strikable by the hammer 47 in the rotation direction. When, for example, the anvil 10 receives a higher load during an operation for tightening a bolt, the anvil 10 may no longer rotate with urging forces from the coil springs 50 alone. This stops the rotation of the anvil 10 and the hammer 47. The spindle 8 and the hammer 47 are movable relative to each other in the axial direction and in the circumferential direction with the hammer balls 48 in between. When the hammer 47 stops rotating, the spindle 8 continues to rotate with power generated by the motor 6. When the hammer 47 stops rotating and the spindle 8 rotates, the hammer balls 48 move backward while being guided along the spindle grooves 804 and the hammer grooves 477. The hammer 47 receives a force from the hammer balls 48 to move backward with the hammer balls 48. In other words, the hammer 47 moves backward when the anvil 10 stops rotating and the spindle 8 rotates. Thus, the hammer 47 and the anvil projections 102 come out of contact with each other.

When moving backward, the hammer 47 rotates relative to the spindle shaft 801. The washer 61 is spaced from the hammer 47 and the spindle 8. The rotation of the hammer 47 is thus not restricted by the washer 61. The support balls 54 are between the washer 61 and the hammer 47. The support balls 54 rotate to allow the hammer 47 to rotate smoothly.

As described above, the coil springs 50 constantly generate elastic forces for moving the hammer 47 forward. The hammer 47 that has moved backward then moves forward under the elastic forces from the coil springs 50. When moving forward, the hammer 47 receives a force in the rotation direction from the hammer balls 48. In other words, the hammer 47 moves forward while rotating. The hammer projections 475 then come in contact with the anvil projections 102 while rotating. Thus, the anvil projections 102 are struck by the hammer projections 475 in the rotation direction. The anvil 10 receives power from the motor 6 and an inertial force from the hammer 47. The anvil 10 thus rotates with high torque about the rotation axis AX.

### Seal and Support

The seal 70 is located inside the hammer case 4. The seal 70 is located radially inward from the third cylinder 404 in the hammer case 4. The seal 70 is at the boundary between the anvil bearing 46 and the anvil shaft 101 inside the hammer case 4. The seal 70 is at least partially in contact with the outer circumferential surface of the anvil shaft 101. The seal 70 is supported by the anvil bearing 46. The seal 70 is located radially inward from the front protrusion 465 of the anvil bearing 46. The seal 70 in the embodiment is a lip seal.

The seal 70 seals the boundary between the anvil bearing 46 and the anvil shaft 101. The seal 70 reduces the likelihood that a lubricant oil (grease) contained in the hammer case 4 leaks outside the hammer case 4 through the opening at the front end of the hammer case 4. The seal 70 also reduces the likelihood that foreign objects outside the hammer case 4 enter the hammer case 4.

As shown in FIG. 5, the seal 70 includes an outer ring 71, a rear lip 72, and a front lip 73. The outer ring 71 has its outer circumferential surface facing radially outward and being in contact with the inner circumferential surface 465S of the front protrusion 465. The outer ring 71 has its rear surface facing rearward and being in contact with the front surface 463F of the front support 463. The rear lip 72 and the front lip 73 are located radially inward from the outer ring 71. The rear lip 72 is located rearward from the front lip 73. The rear lip 72 and the front lip 73 are in contact with the outer circumferential surface of the anvil shaft 101. The rear lip 72 and the front lip 73 are in contact with the outer circumferential surface of the front columnar portion 114.

The support 80 is located inside the hammer case 4. The support 80 is located frontward from the seal 70. The support 80 faces the seal 70. The support 80 supports the seal 70 from the front. As described above, the hammer case 4 has the opening, at its front end, receiving the anvil shaft 101. The inner circumferential surface 405S of the fourth cylinder 405 defines the opening of the hammer case 4. The support 80 faces the opening of the hammer case 4. The support 80 reduces the likelihood that the seal 70 slips off forward through the opening of the hammer case 4.

The support 80 is annular. The support 80 is a washer surrounding the anvil shaft 101. The support 80 is spaced from the anvil shaft 101.

The support 80 is fixed to at least one of the hammer case 4 or the anvil bearing 46. The support 80 in the embodiment is held between the anvil bearing 46 and a part of the hammer case 4 in the front-rear direction. In the embodiment, the support 80 has a radially outer edge held between the front surface 465F of the front protrusion 465 and the rear surface 405R of the fourth cylinder 405.

The support 80 is placed inside the hammer case 4 through an opening at the rear end of the hammer case 4. The support 80 is received inside the hammer case 4 with the front surface of the support 80 in contact with the rear surface 405R of the fourth cylinder 405. The seal 70 and the anvil bearing 46 are then placed inside the hammer case 4 through the opening at the rear end of the hammer case 4. The anvil bearing 46 is press-fitted into the second cylinder 402 and fixed to the hammer case 4. In response to the front surface 461F of the outer ring 461 being in contact with the rear surface 404R of the third cylinder 404, the hammer case 4 and the anvil bearing 46 are positioned relative to each other in the front-rear direction.

The support 80 may surround a part of the anvil shaft 101. The support 80 may partially have cutouts. The support 80 may be a circlip. In this structure, the support 80 may be placed inside the hammer case 4 through the opening at the front end of the hammer case 4.

### Anvil

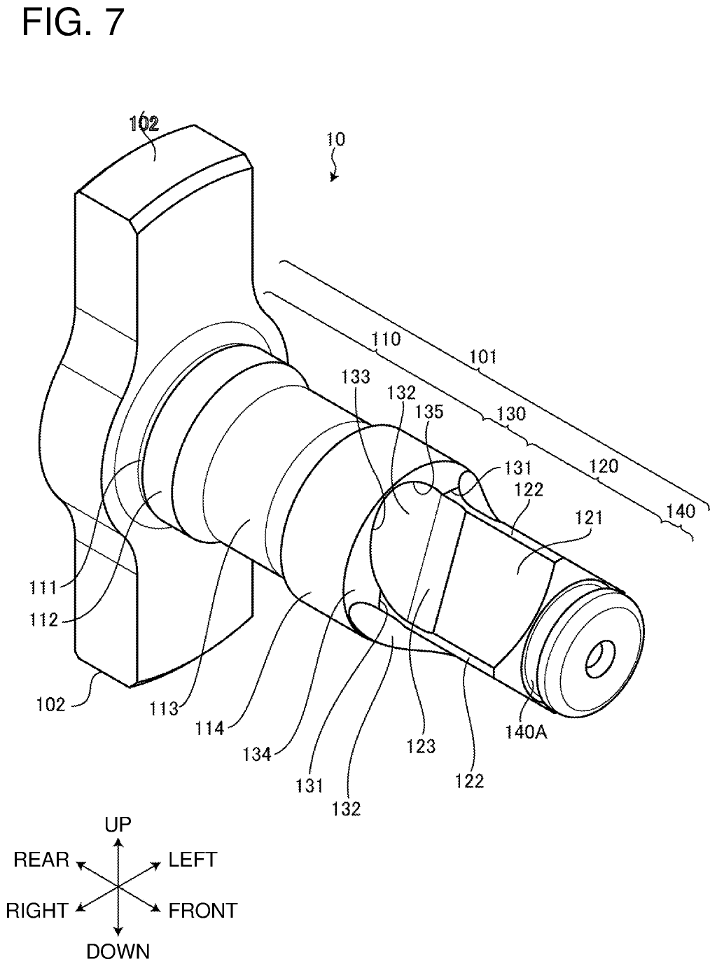

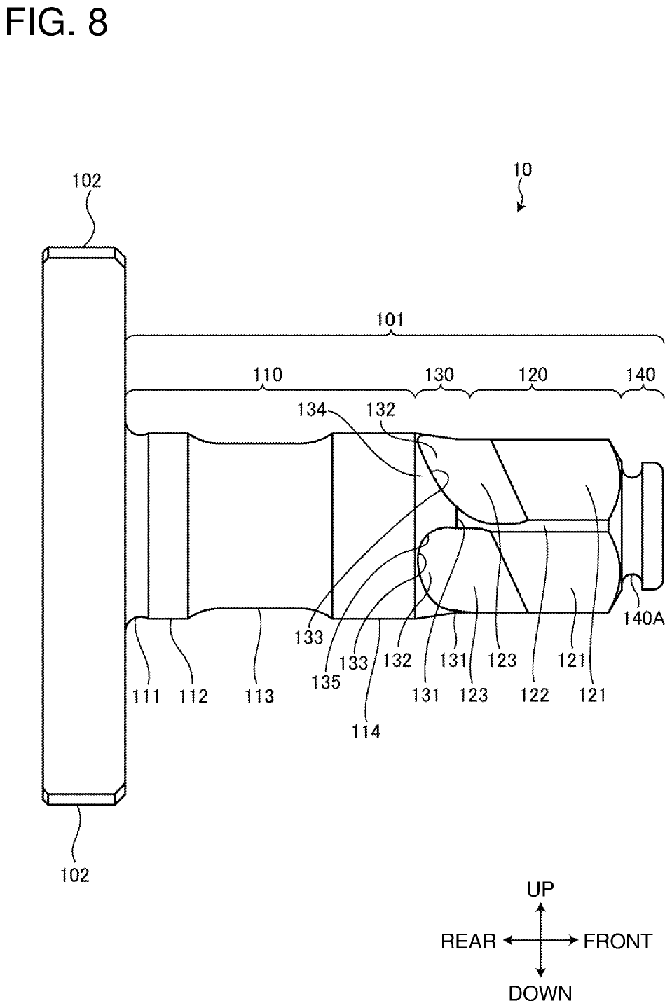

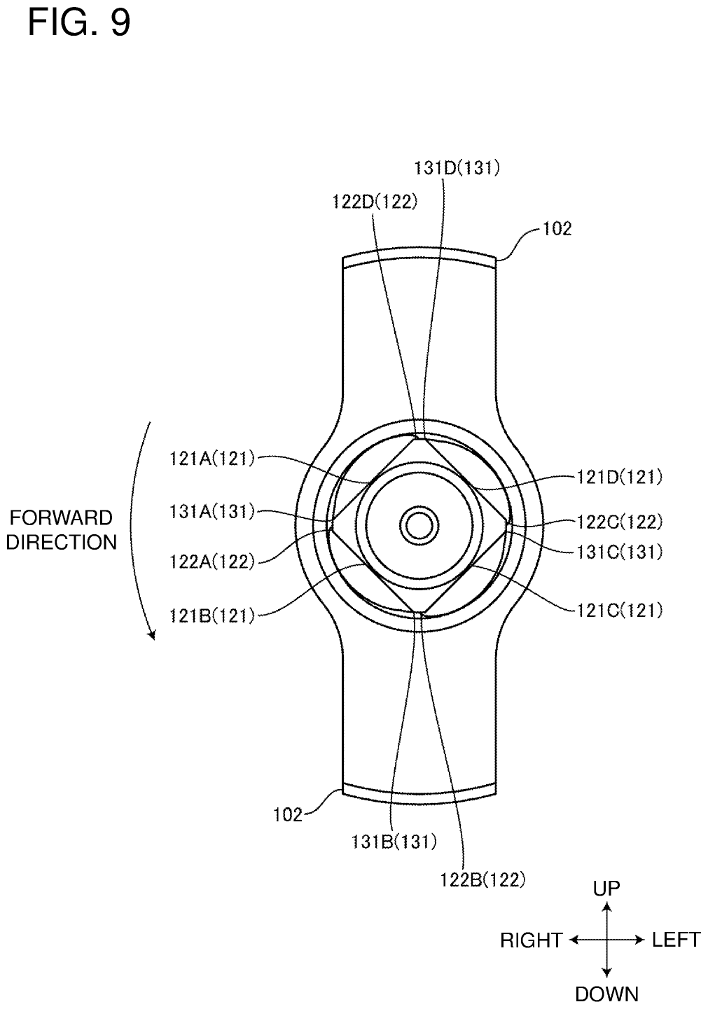

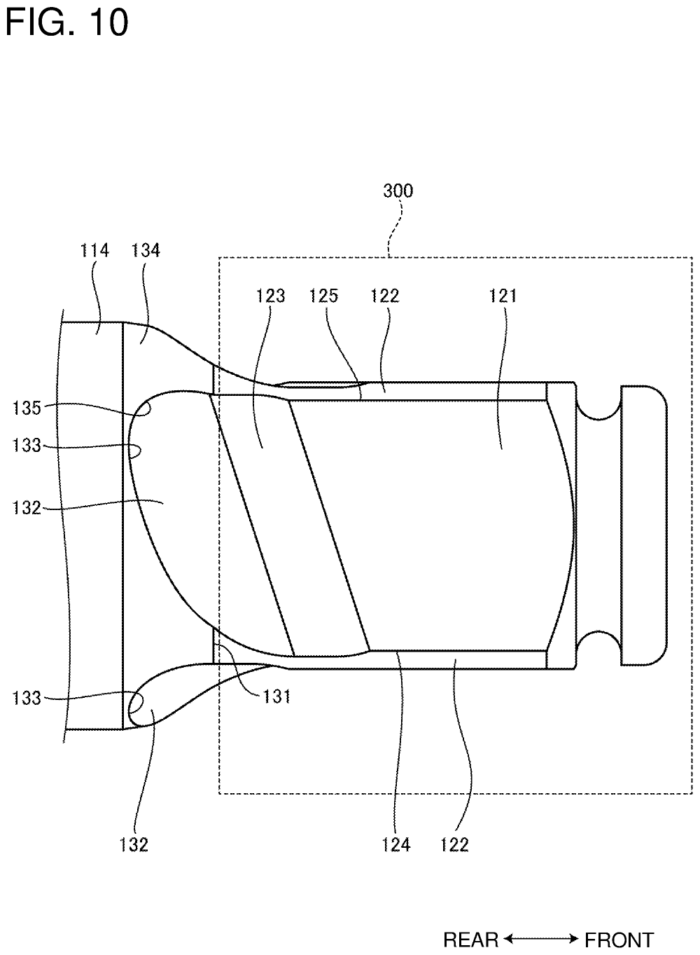

FIG. 7 is a perspective view of the anvil 10 in the present embodiment as viewed from the right front. FIG. 8 is a side view of the anvil 10. FIG. 9 is a front view of the anvil 10. FIG. 10 is a partially enlarged view of the anvil 10.

The anvil 10 includes the anvil shaft 101 and two anvil projections 102. The anvil shaft 101 extends in the axial direction. Each anvil projection 102 protrudes radially outward from the anvil shaft 101.

The anvil shaft 101 includes a first shaft 110, a second shaft 120, an intermediate portion 130, and a distal end 140. The first shaft 110 has its rear end connected to the anvil projections 102. The second shaft 120 is located frontward from the first shaft 110. The second shaft 120 is located nearer the output end than the first shaft 110. The intermediate portion 130 is between the first shaft 110 and the second shaft 120 in the front-rear direction. The first shaft 110 has its front end connected to the rear end of the intermediate portion 130. The second shaft 120 has its rear end connected to the front end of the intermediate portion 130. The first shaft 110 and the second shaft 120 are connected with the intermediate portion 130 in between. The distal end 140 is located frontward from the second shaft 120.

The first shaft 110 is located inside the hammer case 4. The first shaft 110 is at least partially supported by the anvil bearing 46. The first shaft 110 has a circular cross section orthogonal to the rotation axis AX. The first shaft 110 includes a recess 111, the rear columnar portion 112, the recess 113, and the front columnar portion 114. The recess 111 is located rearward from the rear columnar portion 112. The recess 111 is at the boundary between the anvil shaft 101 and the anvil projections 102. The recess 111 has a smaller outer diameter than the rear columnar portion 112. As shown in FIG. 5, the rear columnar portion 112 is supported by the rear support 462 in the anvil bearing 46. The rear columnar portion 112 has its outer circumferential surface in contact with the inner circumferential surface 462S of the rear support 462. The recess 113 is located frontward from the rear columnar portion 112. The recess 113 has a smaller outer diameter than the rear columnar portion 112. The front columnar portion 114 is located frontward from the recess 113. The front columnar portion 114 has an outer diameter substantially equal to the outer diameter of the rear columnar portion 112. As shown in FIG. 5, the front columnar portion 114 is supported by the front support 463 in the anvil bearing 46. The outer circumferential surface of the front columnar portion 114 is in contact with the inner circumferential surface 463S of the front support 463.

The second shaft 120 is located outside the hammer case 4. The second shaft 120 protrudes frontward through the opening at the front end of the hammer case 4. A socket 300 is attached to the second shaft 120. The second shaft 120 has a regular polygonal cross section orthogonal to the rotation axis AX. The second shaft 120 has at least three flat portions 121 and at least three flat portion connectors 122. In the embodiment, the second shaft 120 has a substantially rectangular cross section orthogonal to the rotation axis AX. The second shaft 120 has four flat portions 121 and four flat portion connectors 122. As shown in FIG. 9, the flat portions 121 include a flat portion 121A, a flat portion 121B, a flat portion 121C, and a flat portion 121D. The flat portion 121B is adjacent to the flat portion 121A in the circumferential direction. The flat portion 121C is adjacent to the flat portion 121B in the circumferential direction. The flat portion 121D is adjacent to the flat portion 121C in the circumferential direction. The flat portion connectors 122 include a flat portion connector 122A, a flat portion connector 122B, a flat portion connector 122C, and a flat portion connector 122D. The flat portion connector 122A is at the boundary between the flat portion 121A and the flat portion 121B. The flat portion connector 122B is at the boundary between the flat portion 121B and the flat portion 121C. The flat portion connector 122C is at the boundary between the flat portion 121C and the flat portion 121D. The flat portion connector 122D is at the boundary between the flat portion 121D and the flat portion 121A.

As shown in FIG. 10, each flat portion 121 has a first edge 124 extending in the front-rear direction and a second edge 125 extending in the front-rear direction. The first edge 124 is located at the end of the flat portion 121 in a first circumferential direction. The second edge 125 is located at the end of the flat portion 121 in a second circumferential direction. The four flat portions 121 each have the first edge 124 and the second edge 125.

As indicated by the arrow in FIG. 9, the anvil 10 rotates in the forward direction when rotating counterclockwise as viewed from the front. The first edge 124 is located more forward in the forward direction than the second edge 125. The anvil 10 is rotated in the first circumferential direction when a bolt received in the socket 300 is tightened. In other words, the anvil 10 is rotated in the forward direction in the bolt tightening operation.

The intermediate portion 130 connects the first shaft 110, which is a column, and the second shaft 120, which is a regular polygonal prism (square prism). At least a part of the intermediate portion 130 smoothly connects the outer circumferential surface of the front columnar portion 114 of the first shaft 110 and the outer surface of the second shaft 120. The intermediate portion 130 includes support portions 131 and joints 135. Each support portion 131 is connected to the corresponding first edge 124 of the second shaft 120. Each joint 135 is connected to the corresponding second edge 125 of the second shaft 120. The support portions 131 are substantially aligned with the first edges 124 in the circumferential direction. The joints 135 are substantially aligned with the second edges 125 in the circumferential direction. The support portions 131 are located immediately behind the first edges 124. More specifically, the support portions 131 are located on an extension rearward from the first edges 124 in the axial direction. The joints 135 are located immediately behind the second edges 125. More specifically, the joints 135 are located on an extension rearward from the second edges 125 in the axial direction. The joints 135 are located rearward from the support portions 131 in the front-rear direction. The intermediate portion 130 is connected to the second edges 125 at positions rearward from the support portions 131.

The intermediate portion 130 is connected to the four first edges 124. The intermediate portion 130 is connected to the four second edges 125. The support portions 131 are four support portions 131 located at intervals in the circumferential direction. The joints 135 are four joints 135 located at intervals in the circumferential direction. As shown in FIG. 9, the support portions 131 include a support portion 131A, a support portion 131B, a support portion 131C, and a support portion 131D. The support portion 131A is connected to the first edge 124 of the flat portion 121A. The support portion 131B is connected to the first edge 124 of the flat portion 121B. The support portion 131C is connected to the first edge 124 of the flat portion 121C. The support portion 131D is connected to the first edge 124 of the flat portion 121D.

The socket 300 attached to the second shaft 120 has its rear end coming in contact with the four support portions 131. The rear end of the socket 300 attached to the second shaft 120 is out of contact with the four joints 135.

The socket 300 attached to the second shaft 120 comes in contact with the intermediate portion 130 behind the first edges 124 and is out of contact with the intermediate portion 130 behind the second edges 125. When the striker 9 strikes the anvil 10, the first edges 124 receive higher stress, and the second edges 125 receive lower stress.

The socket 300 attached to the second shaft 120 may come contact with the intermediate portion 130 behind the second edges 125 and may be out of contact with the intermediate portion 130 behind the first edges 124. When the striker 9 strikes the anvil 10, the second edges 125 may receive higher stress, and the first edges 124 may receive lower stress.

The intermediate portion 130 includes a tapered portion 134 connected to the front columnar portion 114. The tapered portion 134 has its rear end connected to the front end of the front columnar portion 114. The tapered portion 134 has an outer diameter gradually decreasing toward the front. The tapered portion 134 has its front end connected to the flat portions 121 and the flat portion connectors 122. The tapered portion 134 is partially removed to define the support portions 131 and the joints 135. The tapered portion 134 has curved portions in its partially removed portions. The intermediate portion 130 has curved portions 132 connected to the flat portions 121. Each curved portion 132 is between the corresponding joint 135 and support portion 131 in the circumferential direction. Curves 133 are defined at the boundaries between the outer surface of the tapered portion 134 and the curved portions 132. Each curve 133 connects the corresponding joint 135 and support portion 131. The curve 133 slopes frontward in the first circumferential direction (forward direction).

In the embodiment, each flat portion 121 partially has a recess 123. The recess 123 is recessed radially inward from the flat portion 121. The recess 123 is a strip and slopes frontward in the first circumferential direction (forward direction). The recess 123 may be eliminated.

The impact tool 1 according to the embodiment includes the motor 6 including the rotor 27, the striker 9 rotatable with a rotational force from the rotor 27, and the anvil 10 strikable by the striker 9 in the rotation direction. The anvil 10 includes the anvil shaft 101 having the rotation axis AX. The anvil shaft 101 includes the first shaft 110 having a circular cross section orthogonal to the rotation axis AX, the second shaft 120 located nearer the output end than the first shaft 110 and having a regular polygonal cross section orthogonal to the rotation axis AX, and the intermediate portion 130 between the first shaft 110 and the second shaft 120. The second shaft 120 includes at least three flat portions 121 and at least three flat portion connectors 122. The at least three flat portions 121 each have the first edge 124 at its end in the first circumferential direction of the rotation axis AX and the second edge 125 at its end in the second circumferential direction of the rotation axis AX. The socket 300 attached to the second shaft 120 comes in contact with the intermediate portion 130 behind the first edges 124 or the second edges 125 and is out of contact with the intermediate portion 130 behind the second edges 125 or the first edges 124. When the anvil 10 is struck, the first edges 124 receive higher stress and the second edges 125 receive lower stress, or the second edges 125 receive higher stress and the first edges 124 receive lower stress.

This improves the durability of the anvil 10.

### Operation of Impact Tool

The operation of the impact tool 1 will now be described. In an operation for tightening a bolt on a workpiece, for example, the operator grips the grip 22 with, for example, the right hand, and pulls the trigger lever 14 with the right index finger. In response to the trigger lever 14 being pulled, power is supplied from the battery pack 25 to the motor 6 to activate the motor 6 and turn on the light 17 simultaneously. In response to the activation of the motor 6, the rotor shaft 33 rotates. A rotational force of the rotor shaft 33 is then transmitted to the planetary gears 42 through the pinion gear 41. The planetary gears 42 revolve about the pinion gear 41 while rotating and meshing with the internal teeth on the internal gear 43. The planetary gears 42 are rotatably supported by the spindle 8 with the pin 42P. The revolving planetary gears 42 rotate the spindle 8 at a lower rotational speed than the rotor shaft 33.

As the spindle 8 rotates with the hammer projections 475 and the anvil projections 102 in contact with each other, the anvil 10 rotates together with the hammer 47 and the spindle 8. The bolt tightening operation proceeds in this manner.

When the anvil 10 receives a predetermined or higher load during the bolt tightening operation, the anvil 10 and the hammer 47 stop rotating. When the spindle 8 rotates in this state, the hammer 47 moves backward. Thus, the hammer projections 475 and the anvil projections 102 come out of contact with each other.

When moving backward, the hammer 47 rotates relative to the spindle shaft 801. The washer 61 is spaced from the hammer 47 and the spindle 8. The rotation of the hammer 47 is thus not restricted by the washer 61. The support balls 54 are between the washer 61 and the hammer 47. The support balls 54 rotate to allow the hammer 47 to rotate smoothly.

The hammer 47 that has moved backward then moves forward while rotating under elastic forces from the first coil spring 51 and the second coil spring 52. Thus, the anvil projections 102 are struck by the hammer projections 475 in the rotation direction. The anvil 10 thus rotates about the rotation axis AX at high torque. The screw is thus tightened into the workpiece at high torque.

As described above, the impact tool 1 according to the embodiment includes the motor 6 including the rotor 27 rotatable about the rotation axis AX extending in the front-rear direction, the spindle 8 rotatable with a rotational force from the rotor 27, the anvil 10 located frontward from at least a part of the spindle 8 and including the anvil shaft 101 extending in the axial direction parallel to the rotation axis AX and the anvil projections 102 protruding outward from the anvil shaft 101 in the radial direction of the rotation axis AX, and the hammer 47 supported by the spindle 8 and including the hammer projections 475 that strike the anvil projections 102 in the rotation direction. The anvil shaft 101 includes the first shaft 110 having a circular cross section orthogonal to the rotation axis AX, the second shaft 120 located frontward from the first shaft 110 and having the rectangular cross section orthogonal to the rotation axis AX, and the intermediate portion 130 between the first shaft 110 and the second shaft 120. The second shaft 120 includes the four flat portions 121 and the four flat portion connectors 122. The four flat portions 121 each have the first edge 124 at its end in the first circumferential direction of the rotation axis AX and the second edge 125 at its end in the second circumferential direction of the rotation axis AX. The intermediate portion 130 includes the support portions 131 each connected to the first edge 124 and is connected to the second edge 125 at positions rearward from the support portions 131.

In the above structure, the intermediate portion 130 is less likely to receive a large force locally, thus increasing the durability of the anvil 10. When being attached to the second shaft 120, the socket 300 has its rear end coming in contact with at least a part of the intermediate portion 130. When the anvil 10 is struck by the hammer 47, the socket 300 vibrates. The intermediate portion 130 receives vibration from the socket 300, together with a rotational force generated during a bolt tightening operation. In the above structure, the socket 300 comes in contact with the support portions 131 connected to the first edges 124 under a first contact force, whereas the socket 300 comes in contact with the areas near the second edges 125 under a second contact force smaller than the first contact force or is out of contact with the areas near the second edges 125. This reduces vibration from the socket 300 applied to the areas near the second edges 125 when, for example, tensile stress in the rotation direction is applied to the areas near the second edges 125 during the bolt tightening operation. In other words, the areas near the second edges 125 are less likely to receive vibration from the socket 300 and tensile stress in the rotation direction. Vibration from the socket 300 is mainly applied to the areas near the first edges 124, whereas tensile stress in the rotation direction is mainly applied to the areas near the second edges 125. The force applied to the intermediate portion 130 is distributed to the areas near the first edges 124 and to the areas near the support portions 131, thus increasing the durability of the anvil 10.

In the embodiment, the socket 300 is attachable to the second shaft 120. The socket 300 comes in contact with the four support portions 131.

The anvil 10 can thus support the socket 300 stably.

In the embodiment, the anvil 10 is rotated in the first circumferential direction (forward direction) when a bolt received in the socket 300 is tightened.

During the bolt tightening operation, tensile stress concentrates on the second edges 125 located in the reverse direction from the first edges 124. This reduces vibration from the socket 300 applied to the areas near the second edges 125 when tensile stress in the rotation direction is applied to the areas near the second edges 125 during the bolt tightening operation. In other words, the areas near the second edges 125 are less likely to receive vibration from the socket 300 and tensile stress in the rotation direction. Vibration from the socket 300 is mainly applied to the areas near the support portions 131, whereas tensile stress in the rotation direction is mainly applied to the areas near the second edges 125. During the bolt tightening operation, the force applied to the intermediate portion 130 is distributed to the areas near the support portions 131 and to the areas near the second edges 125, thus increasing the durability of the anvil 10.

The intermediate portion 130 in the embodiment includes the joints 135 connected to the second edges 125. The joints 135 are located rearward from the support portions 131. The socket 300 comes in contact with the four support portions 131 and is out of contact with the four joints 135.

This increases the likelihood that the tensile stress in the rotation direction concentrates on the joints 135 during the bolt tightening operation. The socket 300 comes in contact with the support portions 131 and is apart from the joints 135. Thus, the joints 135 are less likely to receive vibration from the socket 300 together with tensile stress in the rotation direction. Vibration from the socket 300 is mainly applied to the support portions 131, whereas tensile stress in the rotation direction is mainly applied to the joints 135. The force applied to the intermediate portion 130 is distributed to the support portions 131 and to the joints 135, thus increasing the durability of the anvil 10.

The intermediate portion 130 in the embodiment has the curved portions 132 between the joints 135 and the support portions 131. The curved portions 132 are connected to the flat portions 121. The socket 300 is out of contact with the curved portions 132.

In this structure, the intermediate portion 130 is less likely to receive a large force locally.

The impact tool 1 according to the embodiment includes the anvil bearing 46 supporting at least a part of the first shaft 110.

The anvil bearing 46 thus supports the first shaft 110, which is a column.

The impact tool 1 according to the embodiment includes the motor 6 including the rotor 27, the striker 9 rotatable with a rotational force from the rotor 27, and the anvil 10 strikable by the striker 9 in the rotation direction. The anvil 10 includes the anvil shaft 101 having the rotation axis AX. The anvil shaft 101 includes the first shaft 110 having a circular cross section orthogonal to the rotation axis AX, the second shaft 120 located nearer the output end than the first shaft 110 and having a regular polygonal cross section orthogonal to the rotation axis AX, and the intermediate portion 130 between the first shaft 110 and the second shaft 120. The second shaft 120 includes at least three flat portions 121 and at least three flat portion connectors 122. The at least three flat portions 121 each have the first edge 124 at its end in the first circumferential direction of the rotation axis AX and the second edge 125 at its end in the second circumferential direction of the rotation axis AX. The socket 300 attached to the second shaft 120 comes in contact with the intermediate portion 130 behind the first edges 124 or the second edges 125 and is out of contact with the intermediate portion 130 behind the second edges 125 or the first edges 124. When the anvil 10 is struck, the first edges 124 receive higher stress and the second edges 125 receive lower stress, or the second edges 125 receive higher stress and the first edges 124 receive lower stress.

This improves the durability of the anvil 10.

### Second Embodiment

A second embodiment will be described. The same reference numerals herein denote the same or corresponding components as those in the above embodiment, and such components will be described briefly or will not be described.

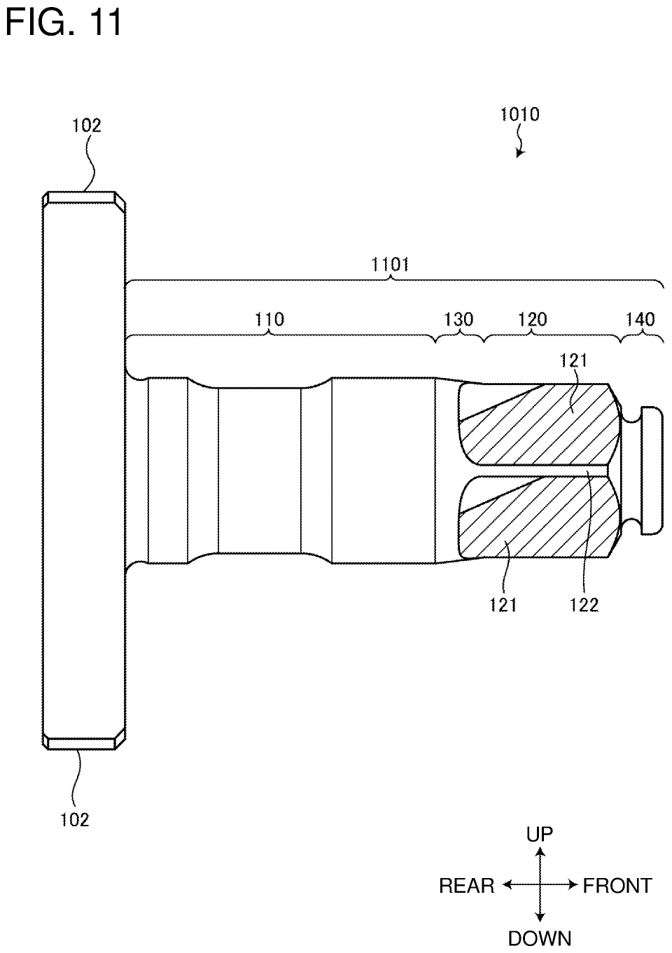

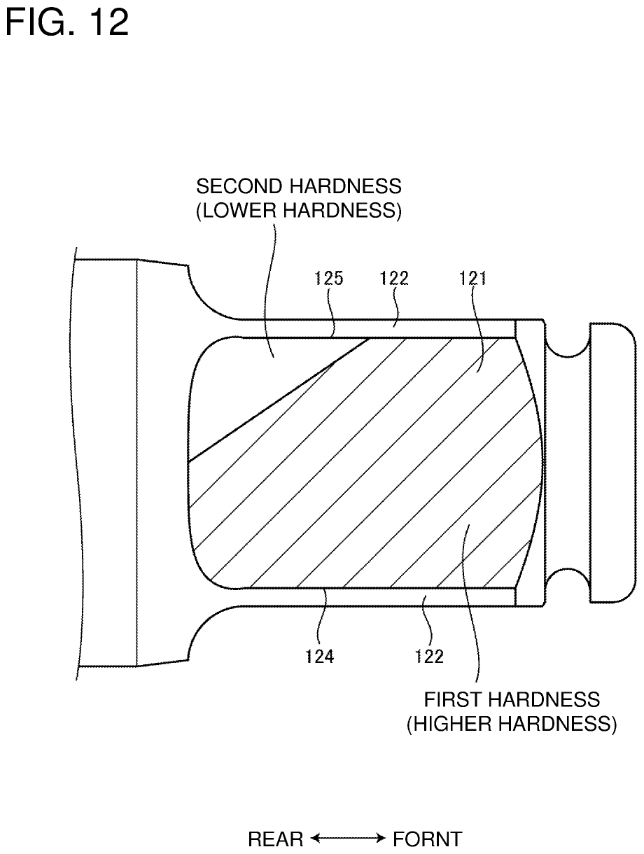

FIG. 11 is a side view of an anvil 1010 in the present embodiment. FIG. 12 is a partially enlarged view of the anvil 1010. As in the embodiment described above, the anvil 1010 includes an anvil shaft 1101 including a first shaft 110, a second shaft 120, and an intermediate portion 130. The first shaft 110 has a circular cross section orthogonal to the rotation axis AX. The second shaft 120 is located nearer the output end than the first shaft 110, and has a regular polygonal cross section. The intermediate portion 130 is between the first shaft 110 and the second shaft 120. The second shaft 120 includes at least three flat portions 121 and at least three flat portion connectors 122. The at least three flat portions 121 each have a first edge 124 and a second edge 125. The first edge 124 is located at the end of the flat portion 121 in the first circumferential direction of the rotation axis AX. The second edge 125 is located at the end of the flat portion 121 in the second circumferential direction.

In FIGS. 11 and 12, the hatched area as the area in the intermediate portion rearward from the flat portion 121 nearer the first edge 124 or the area in the flat portion 121 at its rear end nearer the first edge 124 has a first hardness. The unhatched area as the area in the intermediate portion rearward from the flat portion 121 nearer the second edge 125 or the area in the flat portion 121 at its rear end nearer the second edge 125 has a second hardness lower than the first hardness.

As described above, a heat treatment or a combination of materials allows the second shaft 120 of the anvil 10, onto which the socket 300 is fitted, to have a different hardness. Examples of the heat treatment include laser hardening applied to the area having a higher hardness. Examples of the combination of materials include an ultra-hard metal bonded to the area having a higher hardness. The area having a higher hardness receives the vibration or load in the axial direction, and the area having a lower hardness (higher toughness) receives the twisting load in the rotation direction. This increases the strength and the durability of the anvil 1010 when the bolt is received in the socket 300 and the anvil 1010 is rotated in the forward direction.

The impact tool 1 according to the embodiment includes the motor 6 including the rotor 27, the striker 9 rotatable with a rotational force from the rotor 27, and the anvil 10 strikable by the striker 9 in the rotation direction. The anvil 10 includes the anvil shaft 101 having the rotation axis AX. The anvil shaft 101 includes the first shaft 110 having a circular cross section orthogonal to the rotation axis AX, the second shaft 120 located nearer the output end than the first shaft 110 and having a regular polygonal cross section orthogonal to the rotation axis AX, and the intermediate portion 130 between the first shaft 110 and the second shaft 120. The second shaft 120 includes at least three flat portions 121 and at least three flat portion connectors 122. The at least three flat portions 121 each have the first edge 124 at its end in the first circumferential direction of the rotation axis AX and the second edge 125 at its end in the second circumferential direction of the rotation axis AX. The area in the intermediate portion rearward from the flat portion 121 nearer the first edge 124 or the area in the flat portion 121 at its rear end nearer the first edge 124 has the first hardness. The area in the intermediate portion rearward from the flat portion 121 nearer the second edge 125 or the area in the flat portion 121 at its rear end nearer the second edge 125 may have the second hardness lower than the first hardness.

This improves the durability of the anvil 10.

### Third Embodiment

A third embodiment will be described. The same reference numerals herein denote the same or corresponding components as those in the above embodiment, and such components will be described briefly or will not be described.

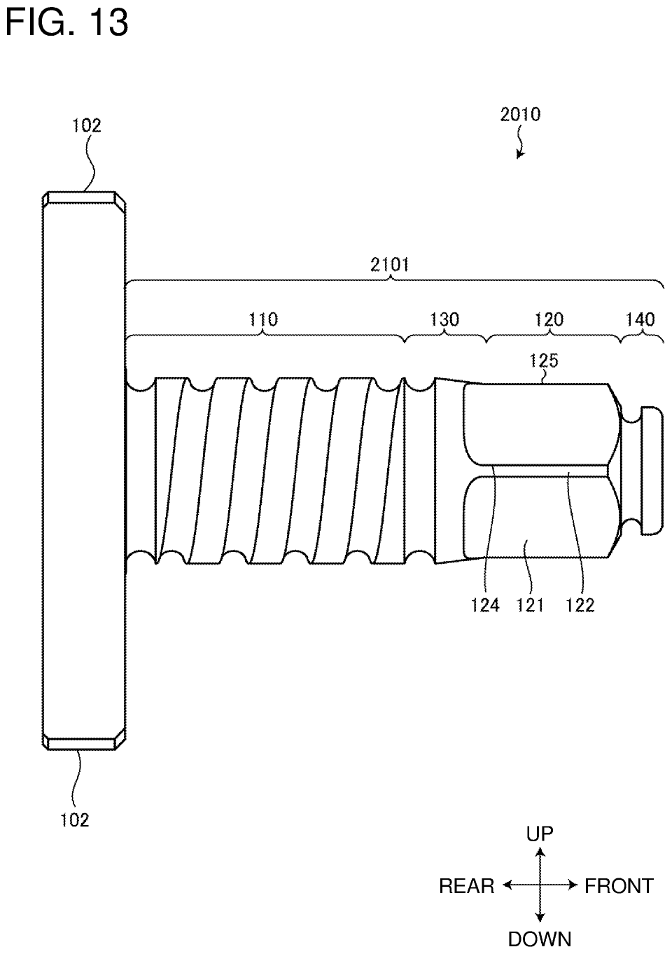

FIG. 13 is a side view of an anvil 2010 according to the present embodiment. The anvil 2010 includes an anvil shaft 2101 including a first shaft 110, a second shaft 120, and an intermediate portion 130. The second shaft 120 is located nearer the output end than the first shaft 110. The second shaft 120 has a regular polygonal cross section orthogonal to the rotation axis AX. The intermediate portion 130 is between the first shaft 110 and the second shaft 120. The second shaft 120 includes at least three flat portions 121 and at least three flat portion connectors 122. The at least three flat portions 121 each have a first edge 124 and a second edge 125. The first edge 124 is located at the end of the flat portion 121 in the first circumferential direction of the rotation axis AX. The second edge 125 is located at the end of the flat portion 121 in the second circumferential direction.

The socket 300 is attached to the second shaft 120. The anvil 2010 is rotated in the forward direction when a bolt received in the socket 300 is tightened. The first shaft 110 has a spiral surface, causing the anvil shaft 2101 to receive a compression load in the axial direction.

As described above, the first shaft 110 has the spiral surface and thus, a different stress is applied to the anvil 2010 in each rotation direction. The anvil shaft 2101 is at least partially twisted in spiral, allowing a load in the rotation direction to be partially distributed in the axial direction. When rotated in the forward direction, the anvil 2010 receives a compression load. When rotated in the reverse direction, the anvil 2010 receives a tensile load. The anvil 2010 is typically formed from a material having a greater strength in the compression direction. The structure according to the present embodiment increases the strength and the durability of the anvil 2010 when the anvil 2010 is rotated in the forward direction with the socket 300 receiving the bolt.

The impact tool 1 according to the embodiment includes the motor 6 including the rotor 27, the striker 9 rotatable with a rotational force from the rotor 27, and the anvil 10 strikable by the striker 9 in the rotation direction. The anvil 10 includes the anvil shaft 101 having the rotation axis AX. The anvil shaft 101 includes the first shaft 110, the second shaft 120 located nearer the output end than the first shaft 110 and having a regular polygonal cross section orthogonal to the rotation axis AX, and the intermediate portion 130 between the first shaft 110 and the second shaft 120. The second shaft 120 includes at least three flat portions 121 and at least three flat portion connectors 122. The at least three flat portions 121 each have the first edge 124 at its end in the first circumferential direction of the rotation axis AX and the second edge 125 at its end in the second circumferential direction of the rotation axis AX. The socket 300 is attached to the second shaft 120. The anvil 10 is rotated in the forward direction when the bolt received in the socket 300 is tightened. The first shaft 110 may have a spiral surface, causing the anvil shaft 101 to receive a compression load in the axial direction AX when the anvil 10 is rotated in the forward direction with the socket 300 receiving the bolt.

This improves the durability of the anvil 10.

### Fourth Embodiment

A fourth embodiment will be described. The same reference numerals herein denote the same or corresponding components as those in the above embodiment, and such components will be described briefly or will not be described.

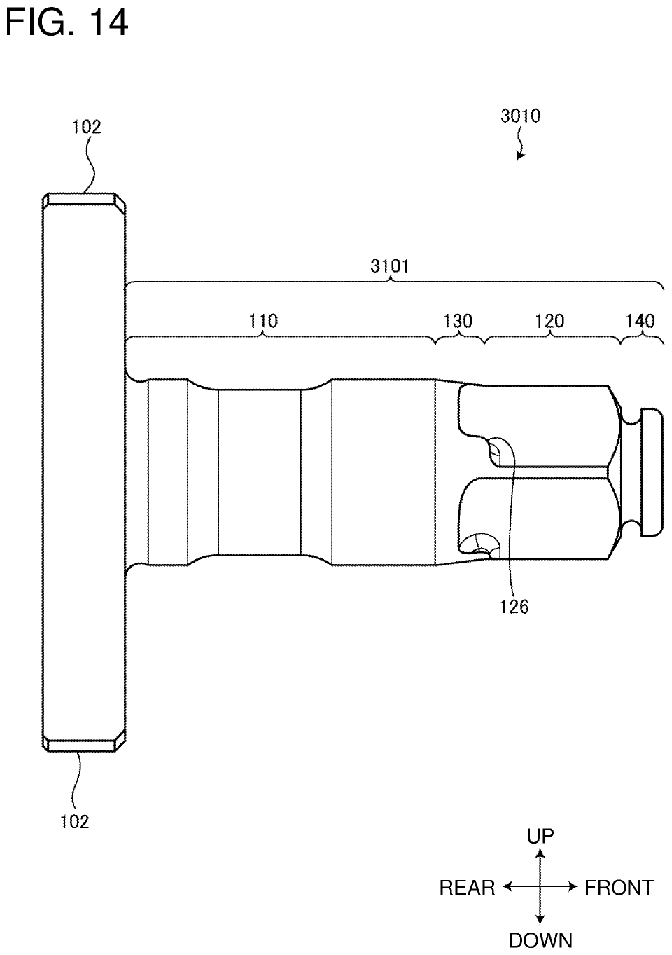

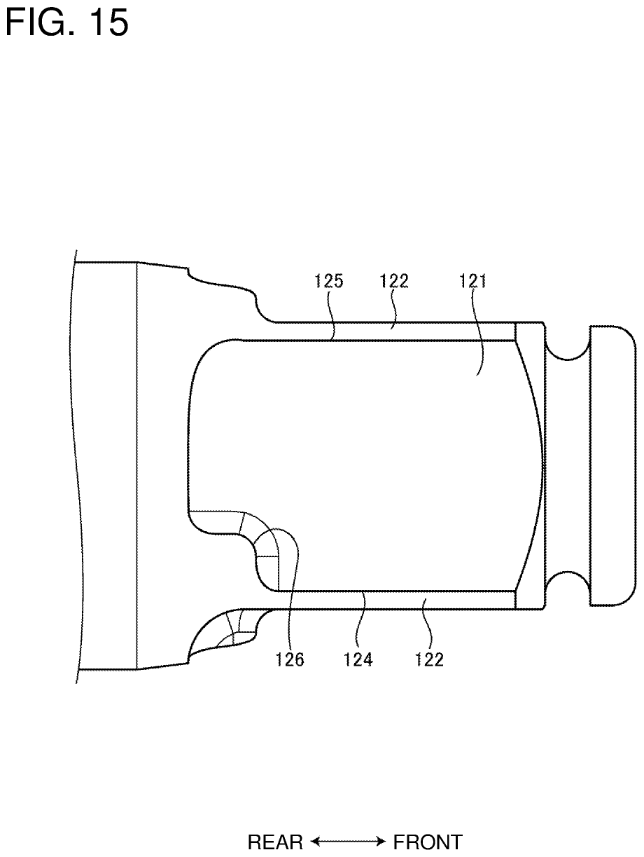

FIG. 14 is a side view of an anvil 3010 in the present embodiment. FIG. 15 is a partially enlarged view of the anvil 3010. The anvil 3010 includes an anvil shaft 3101 including a first shaft 110, a second shaft 120, and an intermediate portion 130. The first shaft 110 has a circular cross section orthogonal to the rotation axis AX. The second shaft 120 is located nearer the output end than the first shaft 110. The second shaft 120 has a regular polygonal cross section. The intermediate portion 130 is between the first shaft 110 and the second shaft 120. The second shaft 120 includes at least three flat portions 121 and at least three flat portion connectors 122. The at least three flat portions 121 each have a first edge 124 and a second edge 125. The first edge 124 is located at the end of the flat portion 121 in the first circumferential direction of the rotation axis AX. The second edge 125 is located at the end of the flat portion 121 in the second circumferential direction.

Each flat portion 121 includes a projection 126 on its rear end in the first circumferential direction. The socket 300 attached to the second shaft 120 has its rear end coming in contact with the projection 126.

The projection 126 increases the strength and the durability of the anvil 1010 when the anvil 1010 is rotated in the forward direction with the socket 300 receiving the bolt.

The impact tool 1 according to the embodiment includes the motor 6 including the rotor 27, the striker 9 rotatable with a rotational force from the rotor 27, and the anvil 10 strikable by the striker 9 in the rotation direction. The anvil 10 includes the anvil shaft 101 having the rotation axis AX. The anvil shaft 101 includes the first shaft 110 having a circular cross section orthogonal to the rotation axis AX, the second shaft 120 located nearer the output end than the first shaft 110 and having a regular polygonal cross section orthogonal to the rotation axis AX, and the intermediate portion 130 between the first shaft 110 and the second shaft 120. The second shaft 120 includes at least three flat portions 121 and at least three flat portion connectors 122. The at least three flat portions 121 each have the first edge 124 at its end in the first circumferential direction of the rotation axis AX and the second edge 125 at its end in the second circumferential direction of the rotation axis AX. The flat portion 121 includes the projection 126 on its rear end in the first circumferential direction. The socket 300 attached to the second shaft 120 has its rear end coming in contact with the projection 126. This improves the durability of the anvil 10.

### Fifth Embodiment

A fifth embodiment will be described. The same reference numerals herein denote the same or corresponding components as those in the above embodiment, and such components will be described briefly or will not be described.

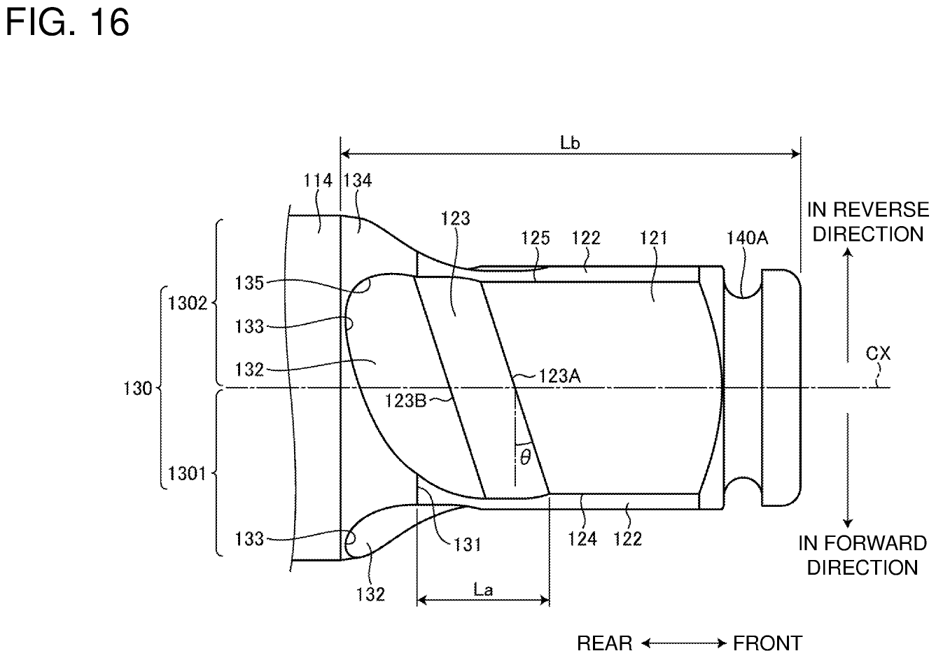

FIG. 16 is a side view of an anvil 10 according to the present embodiment. The anvil 10 in the present embodiment is the same as the anvil 10 in the first embodiment described above.

The anvil shaft 101 includes a first shaft 110, a second shaft 120, and an intermediate portion 130. The first shaft 110 has a circular cross section orthogonal to the rotation axis AX. The second shaft 120 is located frontward from the first shaft 100. The second shaft 120 has a rectangular cross section orthogonal to the rotation axis AX. The intermediate portion 130 is between the first shaft 110 and the second shaft 120 in the axial direction.

The second shaft 120 includes four flat portions 121 and four flat portion connectors 122. The four flat portions 121 each have a first edge 124 and a second edge 125. The first edge 124 is located at the end of the flat portion 121 in the first circumferential direction (forward direction) of the rotation axis AX. The second edge 125 is located at the end of the flat portion 121 in the second circumferential direction (reverse direction).

The anvil 10 comes in contact with the socket 300 at the end of the flat portion 121 in the forward direction.

The intermediate portion 130 includes, in a plane parallel to the flat portion 121, a first portion 1301 located in the first circumferential direction (forward direction) from a center line CX of the flat portion 121 in the circumferential direction and connected to the first edge 124, and a second portion 1302 located in the second circumferential direction from the center line CX and connected to the second edge 125. The first portion 1301 and the second portion 1302 have different shapes. The center line CX passes through the center of the flat portion 121 in the circumferential direction and extends in the axial direction.

As in the first embodiment described above, the intermediate portion 130 includes support portions 131 and joints 135. Each support portion 131 is connected to the corresponding first edge 124. Each joint 135 is connected to the corresponding second edge 125. The joints 135 are located rearward from the support portions 131. The socket 300 is attached to the second shaft 120. The socket 300 comes in contact with the support portions 131 and is out of contact with the joints 135.

As shown in FIGS. 5 and 16, a distal end 140 has a recess 140A. The recess 140A surrounds the rotation axis AX. The recess 140A receives a ring spring 85. The socket 300 attached to the second shaft 120 is fastened to the second shaft 120 under an elastic force from the ring spring 85. The method for fastening the socket 300 under an elastic force from the ring spring 85 is hereafter referred to as ring spring fastening as appropriate.

The intermediate portion 130 has curved portions 132. The curved portions 132 are located between the joints 135 and the support portions 131, and are connected to the flat portions 121. A recess 123 is between the intermediate portion 130 and the corresponding flat portion 121 in the axial direction. The recess 123 connects the first edge 124 and the second edge 125. The recess 123 has a front edge 123A defining its front end and a rear edge 123B defining its rear end. The front edge 123A and the rear edge 123B are parallel to each other.

The front edge 123A has a first end connected to the first edge 124 and a second end connected to the second edge 125. The first end and the second end are at different positions in the axial direction. In other words, the recess 123 (the front edge 123A and the rear edge 123B) is inclined with respect to the center line CX. In the example shown in FIG. 16, the front edge 123A connected to the first edge 124 has the first end located frontward from the second end connected to the second edge 125 in the axial direction.

The front edge 123A has the first end at a distance La of 4.3 mm from the support portion 131 in the axial direction.

The distance La between the first end of the front edge 123A and the support portion 131 is one-sixth to one-fifth inclusive of a distance Lb between the front end of the anvil 10 (anvil shaft 101) and the rear end of the intermediate portion 130 in the axial direction.

In the plane parallel to the flat portion 121, an angle θ formed between the front edge 123A and a reference line orthogonal to the center line CX is 15 to 25° inclusive. The angle θ may be, for example, 8°.

The anvil 10 is rotated in the forward direction when a bolt received in the socket 300 is tightened. As in the first embodiment described above, the anvil 10 includes the first portion 1301 in the forward direction. This increases the strength and the durability of the anvil 10 when the anvil 10 is rotated in the forward direction with the socket 300 receiving the bolt.

The distance La of 4.3 mm increases the strength and the durability of the anvil 10. When the distance La is greater, the flat portion 121 has a smaller area and may be susceptible to the stress concentration or the anvil 10 may have a greater total length. When the distance La is smaller, the anvil 10 may have insufficient strength or insufficient durability.

The angle θ of 15 to 25° inclusive increases the strength and the durability of the anvil 10. As described above, vibration from the socket 300 is mainly applied to the areas near the first edges 124, whereas tensile stress in the rotation direction is mainly applied to the areas near the second edges 125. The recess 123 is inclined, thus increasing the distance between the areas receiving the vibration and the areas receiving the tensile stress. This increases the strength and the durability of the anvil 10. The angle θ exceeding 25° and approaching 45° may be close to an angle that causes crack propagation. When the angle θ is less than 15°, the strength and durability of the anvil 10 are less likely to increase.

### Sixth Embodiment

A sixth embodiment will be described. The same reference numerals herein denote the same or corresponding components as those in the above embodiment, and such components will be described briefly or will not be described.

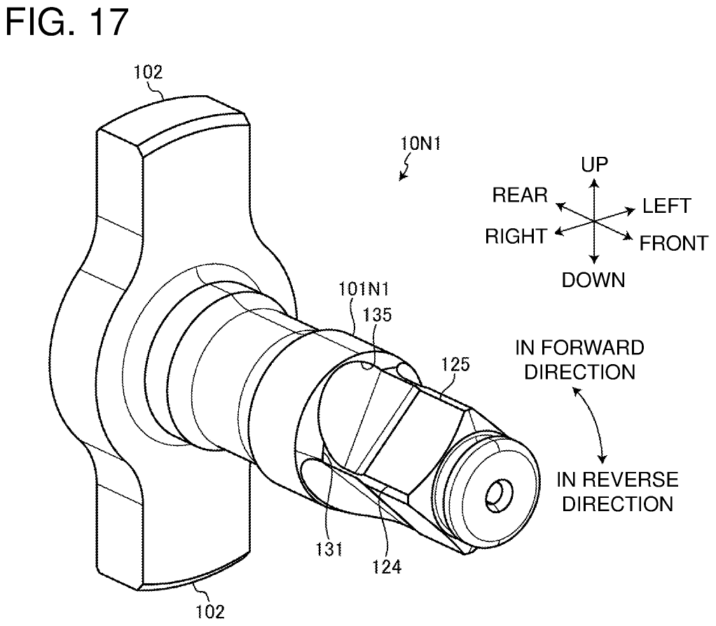

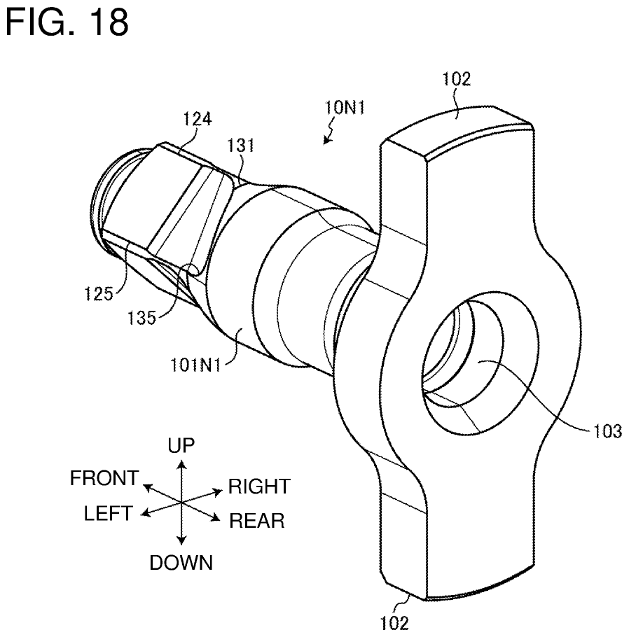

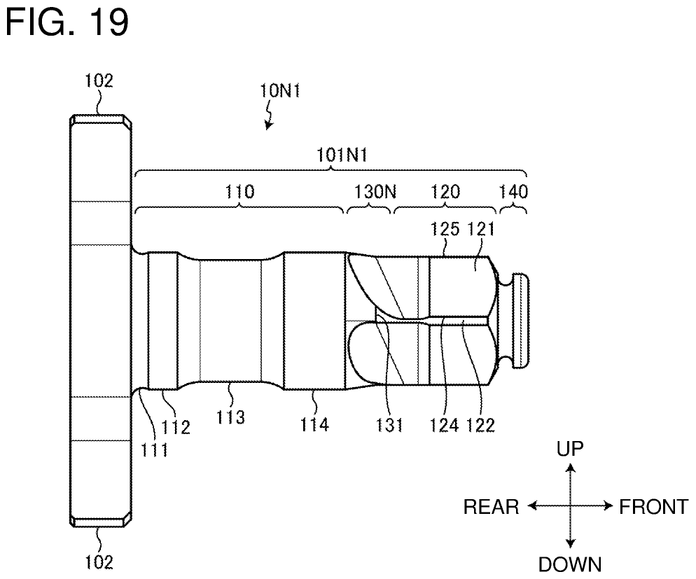

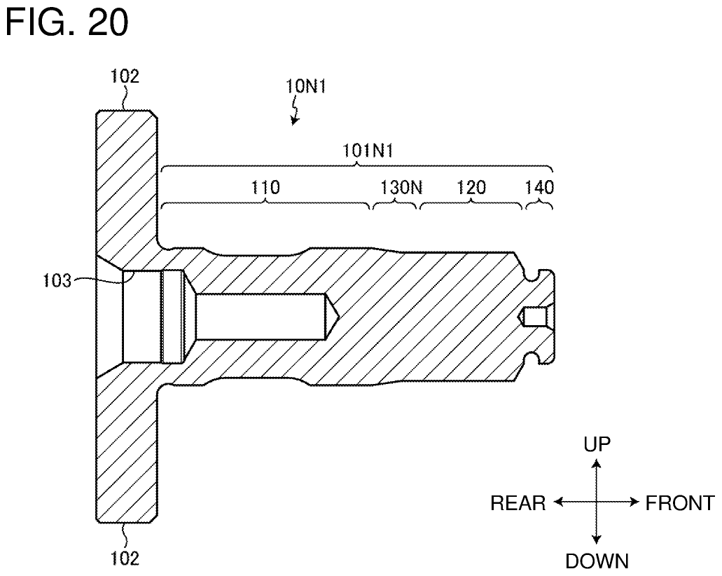

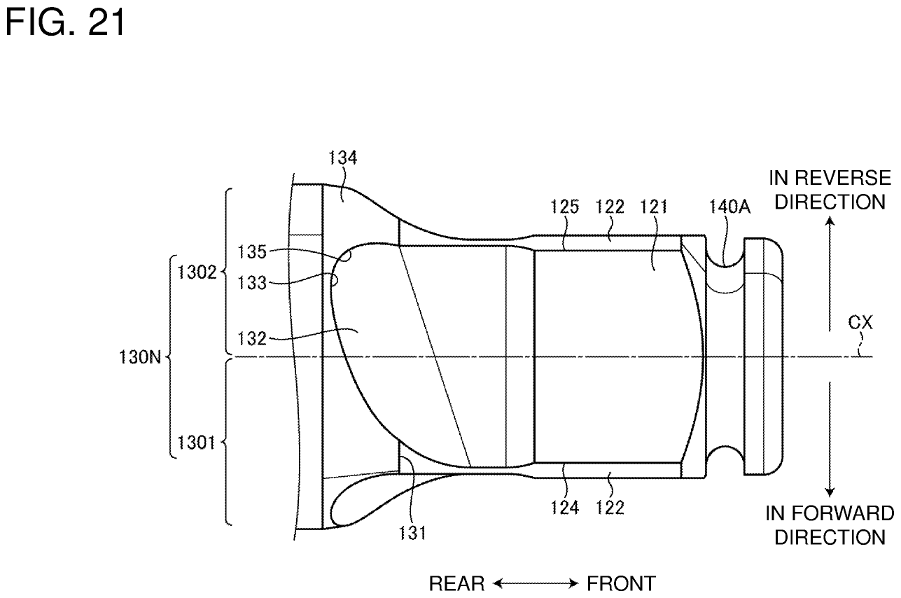

FIG. 17 is a perspective view of an anvil 10N1 in the present embodiment as viewed from the right front. FIG. 18 is a perspective view of the anvil 10N1 as viewed from the left rear. FIG. 19 is a side view of the anvil 10N1. FIG. 20 is a sectional view of the anvil 10N1. FIG. 21 is a partially enlarged view of the anvil 10N1.

The anvil 10N1 includes an anvil shaft 101N1, two anvil projections 102, and a recess 103. The anvil shaft 101N1 extends in the axial direction. Each anvil projection 102 protrudes radially outward from the rear end of the anvil shaft 101N1. The recess 103 is recessed frontward from a middle portion on the rear surface of the anvil 10N1. The spindle 8 has its front end received in the recess 103.

The anvil shaft 101N1 includes a first shaft 110, a second shaft 120, an intermediate portion 130N, and a distal end 140. The first shaft 110 has its rear end connected to the anvil projections 102. The second shaft 120 is located frontward from the first shaft 110. The intermediate portion 130N is between the first shaft 110 and the second shaft 120 in the front-rear direction. The first shaft 110 has its front end connected to the rear end of the intermediate portion 130N. The second shaft 120 has its rear end connected to the front end of the intermediate portion 130N. The first shaft 110 and the second shaft 120 are connected with the intermediate portion 130N in between. The distal end 140 is located frontward from the second shaft 120.

As in the embodiment described above, the first shaft 110 is at least partially supported by the anvil bearing 46. The first shaft 110 has a circular cross section orthogonal to the rotation axis AX. The first shaft 110 includes a recess 111, a rear columnar portion 112, a recess 113, and a front columnar portion 114. The recess 111 is located rearward from the rear columnar portion 112. The recess 111 is at the boundary between the anvil shaft 101 and the anvil projections 102. The recess 111 has a smaller outer diameter than the rear columnar portion 112.

The anvil 10N1 includes the first shaft 110, the anvil projections 102, and the recess 103, each having the same structure (the same shape and the same dimensions) as the first shaft 110, the anvil projections 102, and the recess 103 on the anvil 10 or other anvils in the embodiments described above. The first shaft 110, the anvil projections 102, and the recess 103 are common components between the anvil 10N1 and the anvil 10 or other anvils in the embodiments described above.

The socket 300 is attached to the second shaft 120. The distal end 140 has a recess 140A. The anvil 10N1 fastens the socket 300 by the ring spring fastening. The second shaft 120 has a substantially rectangular cross section orthogonal to the rotation axis AX. The second shaft 120 includes four flat portions 121 and four flat portion connectors 122.

Each flat portion 121 has a first edge 124 extending in the front-rear direction and a second edge 125 extending in the front-rear direction. The first edge 124 is located at the end of the flat portion 121 in the first circumferential direction (forward direction). The second edge 125 is located at the end of the flat portion 121 in the second circumferential direction (reverse direction). The four flat portions 121 each have the first edge 124 and the second edge 125.

The anvil 10N1 is rotated in the forward direction when a bolt received in the socket 300 is tightened.

The intermediate portion 130N connects the first shaft 110, which is a column, and the second shaft 120, which is a square prism. At least a part of the intermediate portion 130N smoothly connects the outer circumferential surface of the front columnar portion 114 of the first shaft 110 and the outer surface of the second shaft 120. The intermediate portion 130N includes support portions 131 and joints 135. Each support portion 131 is connected to the corresponding first edge 124 of the second shaft 120. Each joint 135 is connected to the corresponding second edge 125 of the second shaft 120. The support portions 131 are substantially aligned with the first edges 124 in the circumferential direction. The joints 135 are substantially aligned with the second edges 125 in the circumferential direction. The support portions 131 are located immediately behind the first edges 124. More specifically, the support portions 131 are located on an extension rearward from the first edges 124 in the axial direction. The joints 135 are located immediately behind the second edges 125. More specifically, the joints 135 are located on an extension rearward from the second edges 125 in the axial direction. The joints 135 are located rearward from the support portions 131 in the front-rear direction. The intermediate portion 130N is connected to the second edges 125 at positions rearward from the support portions 131.

The intermediate portion 130N is connected to the four first edges 124. The intermediate portion 130N is connected to the four second edges 125. The support portions 131 are four support portions 131 located at intervals in the circumferential direction. The joints 135 are four joints 135 located at intervals in the circumferential direction.

The socket 300 attached to the second shaft 120 has its rear end coming in contact with the four support portions 131. The rear end of the socket 300 attached to the second shaft 120 is out of contact with the four joints 135.

The socket 300 attached to the second shaft 120 comes in contact with the intermediate portion 130N behind the first edges 124 and is out of contact with the intermediate portion 130N behind the second edges 125. When the striker 9 strikes the anvil 10, the first edges 124 receive higher stress, and the second edges 125 receive lower stress.

The intermediate portion 130N includes a tapered portion 134 connected to the front columnar portion 114. The tapered portion 134 has its rear end connected to the front end of the front columnar portion 114. The tapered portion 134 has an outer diameter gradually decreasing toward the front. The tapered portion 134 has its front end connected to the flat portions 121 and the flat portion connectors 122. The tapered portion 134 is partially removed to define the support portions 131 and the joints 135. The tapered portion 134 has curved portions in its partially removed portions. The intermediate portion 130N has curved portions 132 connected to the flat portions 121. Each curved portion 132 is between the corresponding joint 135 and support portion 131 in the circumferential direction. Curves 133 are defined at the boundaries between the outer surface of the tapered portion 134 and the curved portions 132. Each curve 133 connects the corresponding joint 135 and support portion 131. The curve 133 slopes frontward in the first circumferential direction (forward direction).

As shown in FIG. 21, the intermediate portion 130N has, in the plane parallel to the flat portion 121, a first portion 1301 located in the first circumferential direction (forward direction) from the center line CX of the flat portion 121 in the circumferential direction and connected to the first edge 124, and a second portion 1302 located in the second circumferential direction (reverse direction) from the center line CX and connected to the second edge 125. The first portion 1301 and the second portion 1302 have different shapes. The center line CX passes through the center of the flat portion 121 in the circumferential direction and extends in the axial direction.

The anvil 10N1 is rotated in the forward direction when a bolt received in the socket 300 is tightened. The anvil 10N1 includes the first portion 1301 in the forward direction. This increases the strength and the durability of the anvil 10N1 when the anvil 10N1 is rotated in the forward direction with the socket 300 receiving the bolt.

In other words, the intermediate portion 130N has a shape to increase the strength and the durability of the anvil 10N1 when the anvil 10N1 is rotated in the forward direction. The intermediate portion 130N is hereafter referred to as a forward-rotation intermediate portion 130N as appropriate.

### Seventh Embodiment

A seventh embodiment will be described. The same reference numerals herein denote the same or corresponding components as those in the above embodiment, and such components will be described briefly or will not be described.

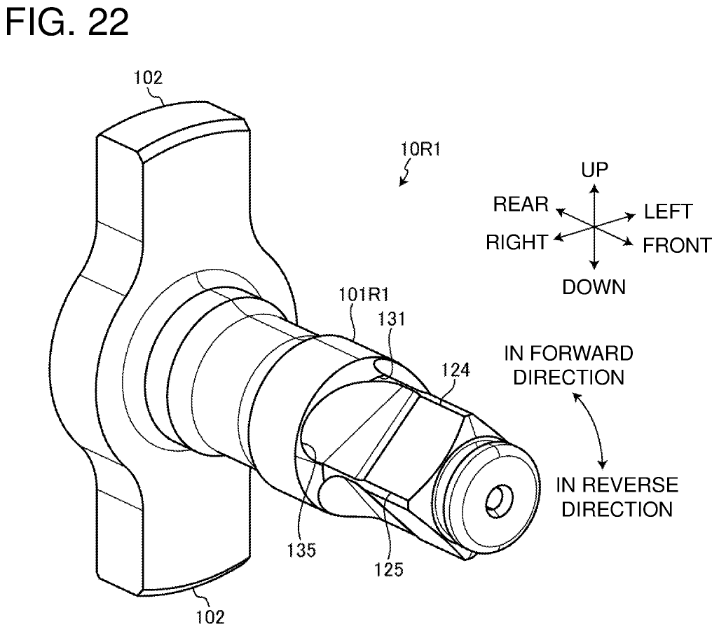

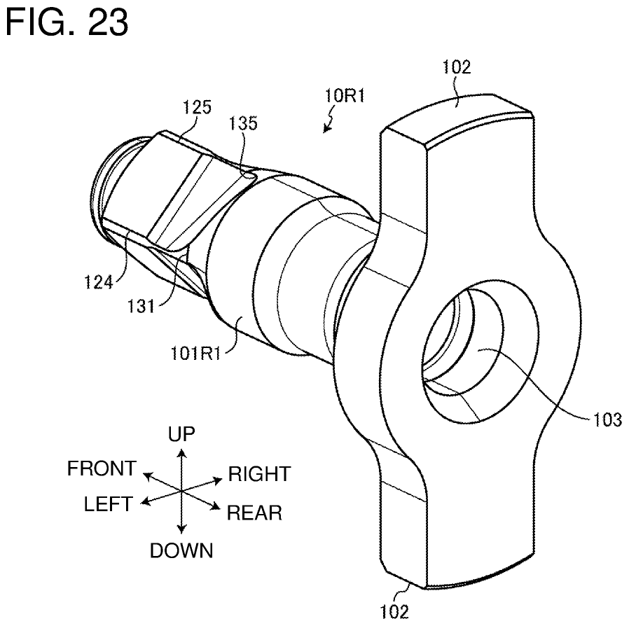

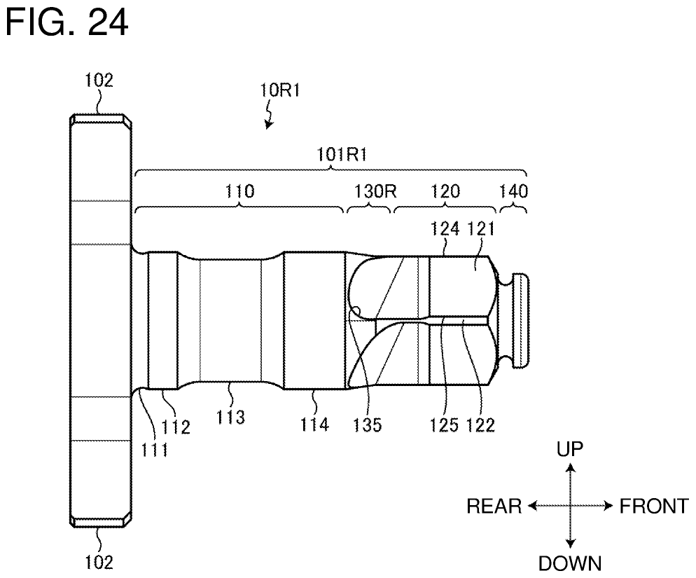

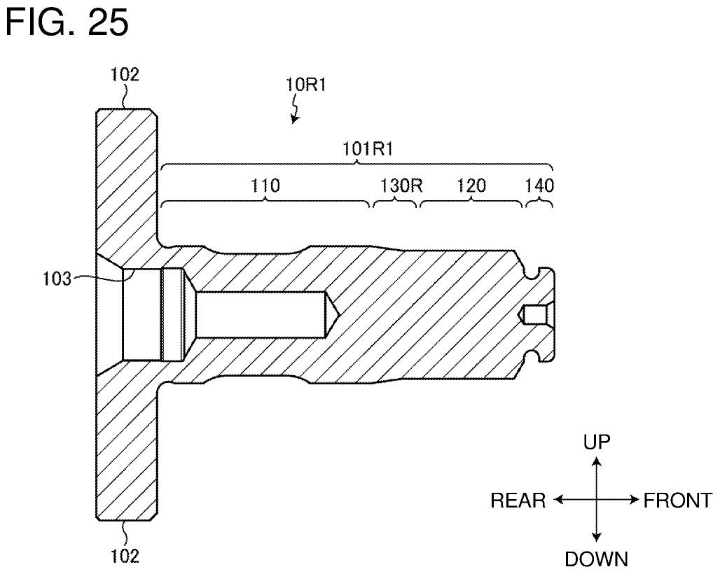

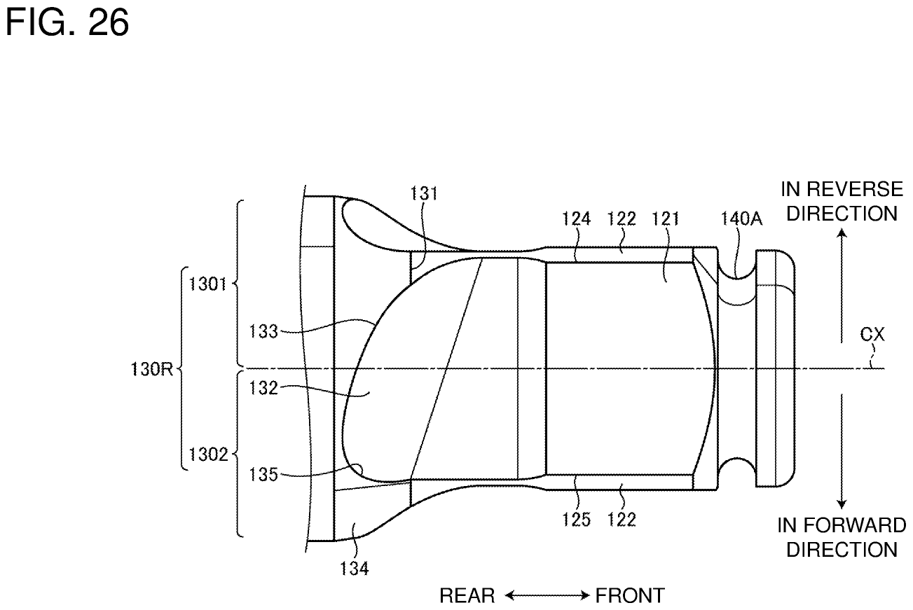

FIG. 22 is a perspective view of an anvil 10R1 in the present embodiment as viewed from the right front. FIG. 23 is a perspective view of the anvil 10R1 as viewed from the left rear. FIG. 24 is a side view of the anvil 10R1. FIG. 25 is a sectional view of the anvil 10R1. FIG. 26 is a partially enlarged view of the anvil 10R1.

The anvil 10R1 includes an anvil shaft 101R1, two anvil projections 102, and a recess 103. The anvil shaft 101R1 extends in the axial direction. Each anvil projection 102 protrudes radially outward from the rear end of the anvil shaft 101R1. The recess 103 is recessed frontward from a middle portion on the rear surface of the anvil 10R1. The spindle 8 has its front end received in the recess 103.

The anvil shaft 101R1 includes a first shaft 110, a second shaft 120, an intermediate portion 130R, and a distal end 140.

As in the embodiment described above, the first shaft 110 is at least partially supported by the anvil bearing 46. The anvil 10R1 includes the first shaft 110, the anvil projections 102, and the recess 103, each having the same structure (the same shape and the same dimensions) as the first shaft 110, the anvil projections 102, and the recess 103 on the anvil 10N1 or other anvils in the embodiments described above. The first shaft 110, the anvil projections 102, and the recess 103 are common components between the anvil 10R1 and the anvil 10N1 or other anvils in the embodiments described above.

The socket 300 is attached to the second shaft 120. The distal end 140 has a recess 140A. The anvil 10N1 fastens the socket 300 by the ring spring fastening.

Each flat portion 121 has a first edge 124 extending in the front-rear direction and a second edge 125 extending in the front-rear direction. The first edge 124 is located at the end of the flat portion 121 in the second circumferential direction (reverse direction). The second edge 125 is located at the end of the flat portion 121 in the first circumferential direction (forward direction). The four flat portions 121 each have the first edge 124 and the second edge 125.

The anvil 10 is rotated in the reverse direction when a bolt received in the socket 300 is loosened.

The intermediate portion 130R connects the first shaft 110, which is a column, and the second shaft 120, which is a square prism. At least a part of the intermediate portion 130R smoothly connects the outer circumferential surface of a front columnar portion 114 of the first shaft 110 and the outer surface of the second shaft 120. The intermediate portion 130R includes support portions 131 and joints 135. Each support portion 131 is connected to the corresponding first edge 124 of the second shaft 120. Each joint 135 is connected to the corresponding second edge 125 of the second shaft 120. The support portions 131 are substantially aligned with the first edges 124 in the circumferential direction. The joints 135 are substantially aligned with the second edges 125 in the circumferential direction. The support portions 131 are located immediately behind the first edges 124. More specifically, the support portions 131 are located on an extension rearward from the first edges 124 in the axial direction. The joints 135 are located immediately behind the second edges 125. More specifically, the joints 135 are located on an extension rearward from the second edges 125 in the axial direction. The joints 135 are located rearward from the support portions 131 in the front-rear direction. The intermediate portion 130R is connected to the second edges 125 at positions rearward from the support portions 131.

The intermediate portion 130R is connected to the four first edges 124. The intermediate portion 130R is connected to the four second edges 125. The support portions 131 are four support portions 131 located at intervals in the circumferential direction. The joints 135 are four joints 135 located at intervals in the circumferential direction.

The socket 300 attached to the second shaft 120 has its rear end coming in contact with the four support portions 131. The rear end of the socket 300 attached to the second shaft 120 is out of contact with the four joints 135.

The socket 300 attached to the second shaft 120 comes in contact with the intermediate portion 130R behind the first edges 124 and is out of contact with the intermediate portion 130R behind the second edges 125. When the striker 9 strikes the anvil 10, the first edges 124 receive higher stress, and the second edges 125 receive lower stress.

The intermediate portion 130R includes a tapered portion 134 connected to the front columnar portion 114. The tapered portion 134 has its rear end connected to the front end of the front columnar portion 114. The tapered portion 134 has an outer diameter gradually decreasing toward the front. The tapered portion 134 has its front end connected to the flat portions 121 and the flat portion connectors 122. The tapered portion 134 is partially removed to define the support portions 131 and the joints 135. The tapered portion 134 has curved portions in its partially removed portions. The intermediate portion 130R has curved portions 132 connected to the flat portions 121. Each curved portion 132 is between the corresponding joint 135 and support portion 131 in the circumferential direction. Curves 133 are defined at the boundaries between the outer surface of the tapered portion 134 and the curved portions 132. Each curve 133 connects the corresponding joint 135 and support portion 131. The curve 133 slopes frontward in the second circumferential direction (reverse direction).

As shown in FIG. 26, the intermediate portion 130R includes, in the plane parallel to the flat portion 121, a first portion 1301 located in the second circumferential direction (reverse direction) from the center line CX of the flat portion 121 in the circumferential direction and connected to the first edge 124, and a second portion 1302 located in the first circumferential direction (forward direction) from the center line CX and connected to the second edge 125. The first portion 1301 and the second portion 1302 have different shapes. The center line CX passes through the center of the flat portion 121 in the circumferential direction and extends in the axial direction.

The anvil 10R1 is rotated in the reverse direction when a bolt received in the socket 300 is loosened. The anvil 10R1 includes the first portion 1301 in the reverse direction. This increases the strength and the durability of the anvil 10 when the anvil 10 is rotated in the reverse direction with the socket 300 receiving the bolt.

In other words, the intermediate portion 130R is shaped to increase the strength and the durability of the anvil 10R1 when the anvil 10R1 is rotated in the forward direction. The intermediate portion 130R is hereafter referred to as a reverse-rotation intermediate portion 130R as appropriate.

In a plane parallel to the flat portion 121, the reverse-rotation intermediate portion 130R is mirror-symmetric to the forward-rotation intermediate portion 130N. As shown in FIGS. 21 and 26, the reverse-rotation intermediate portion 130R has a shape inverted upside down from the forward-rotation intermediate portion 130N.

The anvil 10 shown in, for example, FIG. 16, includes the intermediate portion 130 having substantially the same shape as the forward-rotation intermediate portion 130N, but may include the reverse-rotation intermediate portion 130R in place of the intermediate portion 130. In this case, the recess 123 has a shape mirror-symmetric to that of the example in FIG. 16.

### Eighth Embodiment

An eighth embodiment will be described. The same reference numerals herein denote the same or corresponding components as those in the above embodiment, and such components will be described briefly or will not be described.

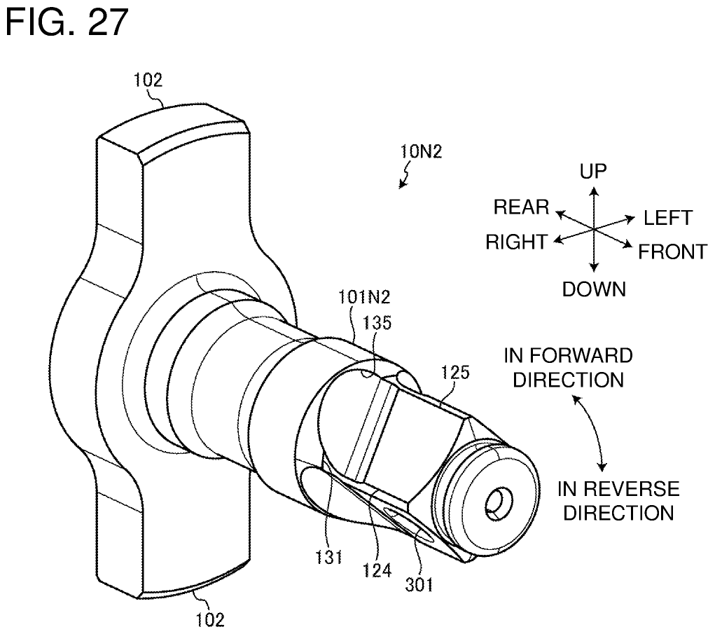

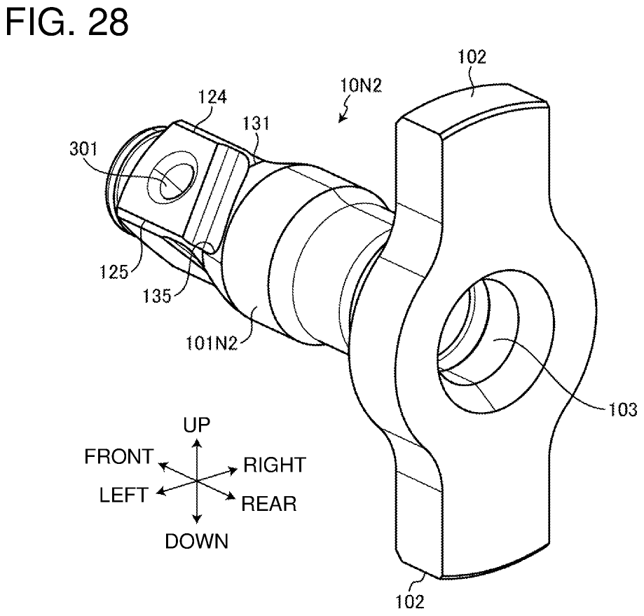

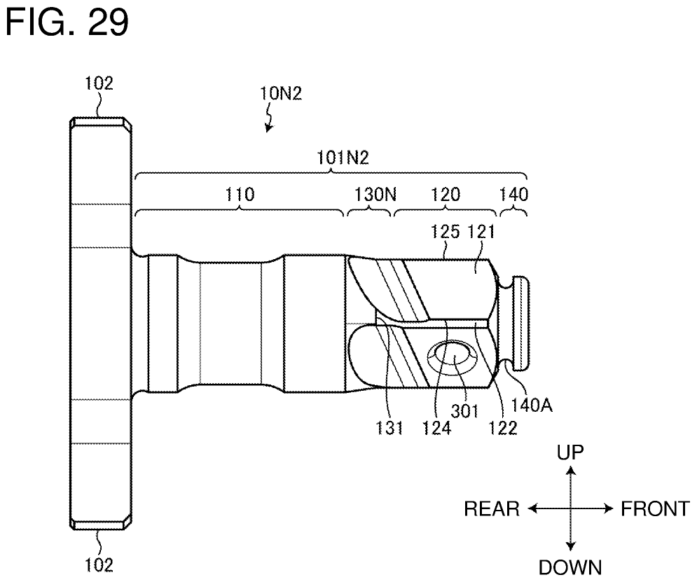

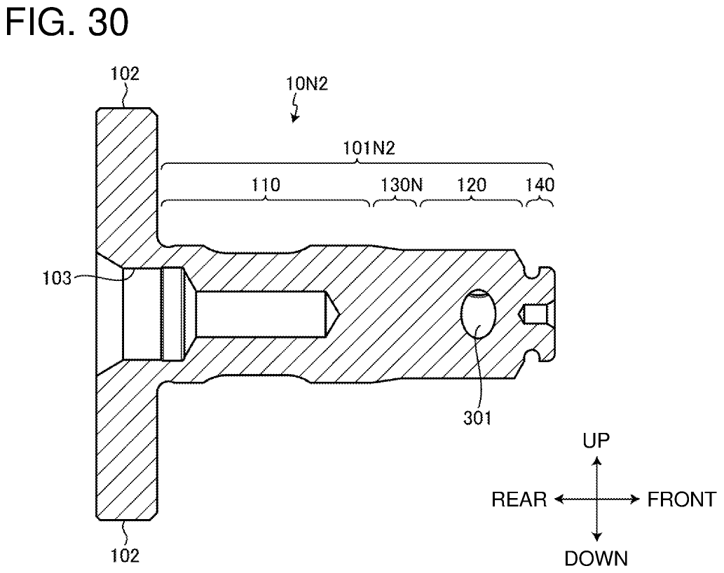

FIG. 27 is a perspective view of an anvil 10N2 in the present embodiment as viewed from the right front. FIG. 28 is a perspective view of the anvil 10N2 as viewed from the left rear. FIG. 29 is a side view of the anvil 10N2. FIG. 30 is a sectional view of the anvil 10N2.

The anvil 10N2 is a modification of the anvil 10N1 in the sixth embodiment described above. The anvil 10N2 includes an anvil shaft 101N2 including a forward-rotation intermediate portion 130N.

As in the embodiment described above, a first shaft 110 is at least partially supported by the anvil bearing 46. The anvil 10N2 includes the first shaft 110, anvil projections 102, and a recess 103, each having the same structure (the same shape and the same dimensions) as the first shaft 110, the anvil projections 102, and the recess 103 on the anvil 10N1 or other anvils in the embodiments described above. The first shaft 110, the anvil projections 102, and the recess 103 are common components between the anvil 10N2 and the anvil 10N1 or other anvils in the embodiments described above.

The socket 300 is attached to the second shaft 120. A distal end 140 has a recess 140A. The anvil 10N2 fastens the socket 300 by the ring spring fastening.

A second shaft 120 in the anvil 10N2 has a structure different from the structure of the second shaft 120 in the anvil 10N1. The second shaft 120 in the anvil 10N2 has a pin hole 301 to receive a pin. The socket 300 has a pin hole to receive the pin. When the socket 300 is attached to the second shaft 120 and the pin is placed into the pin hole in the socket 300 and into the pin hole 301 in the second shaft 120, the socket 300 attached to the second shaft 120 is fastened to the second shaft 120. The method for fastening the socket 300 using a pin is hereinafter referred to as pin fastening as appropriate.

In the embodiment, the socket 300 is fastened to the anvil 10N2 with a combination of the ring spring fastening and the pin fastening.

The anvil 10N2 is rotated in the forward direction when a bolt received in the socket 300 is tightened. The anvil 10N2 includes the forward-rotation intermediate portion 130N, thus increasing the strength and the durability of the anvil 10N2 when the anvil 10N2 is rotated in the forward direction with the socket 300 receiving the bolt.

### Ninth Embodiment

A ninth embodiment will be described. The same reference numerals herein denote the same or corresponding components as those in the above embodiment, and such components will be described briefly or will not be described.

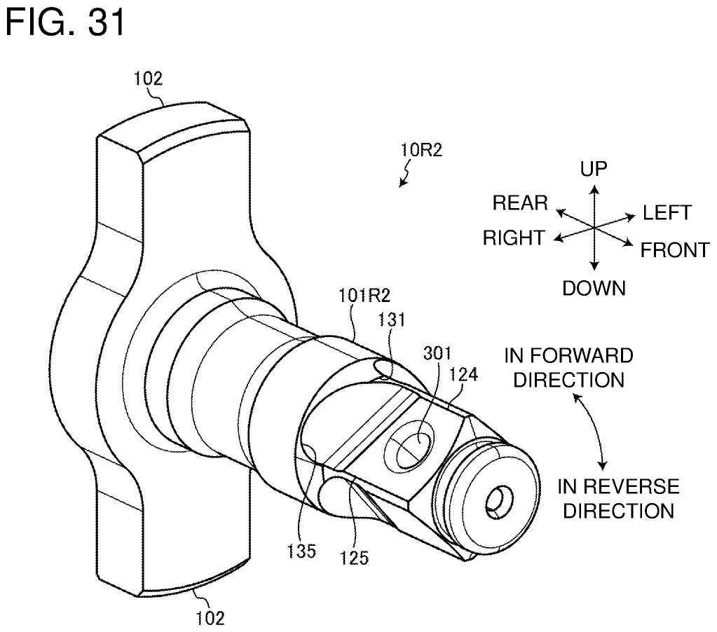

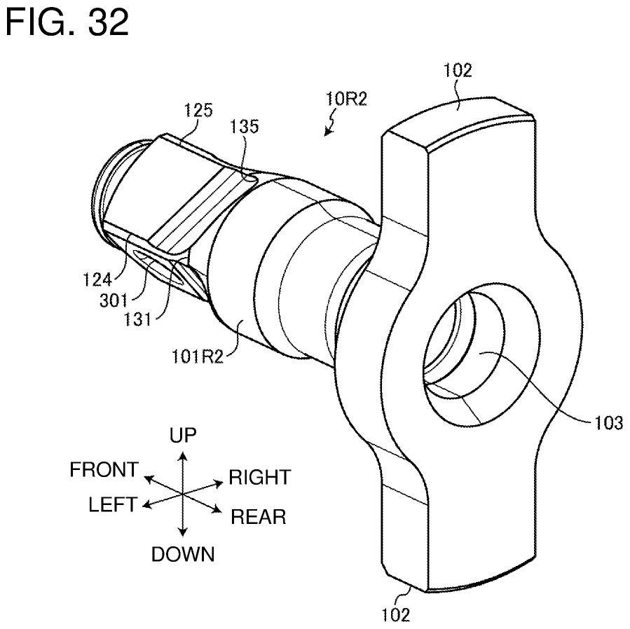

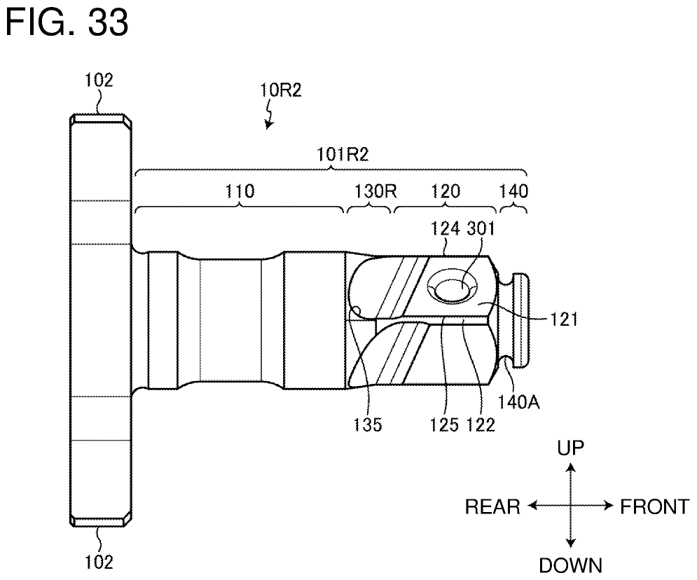

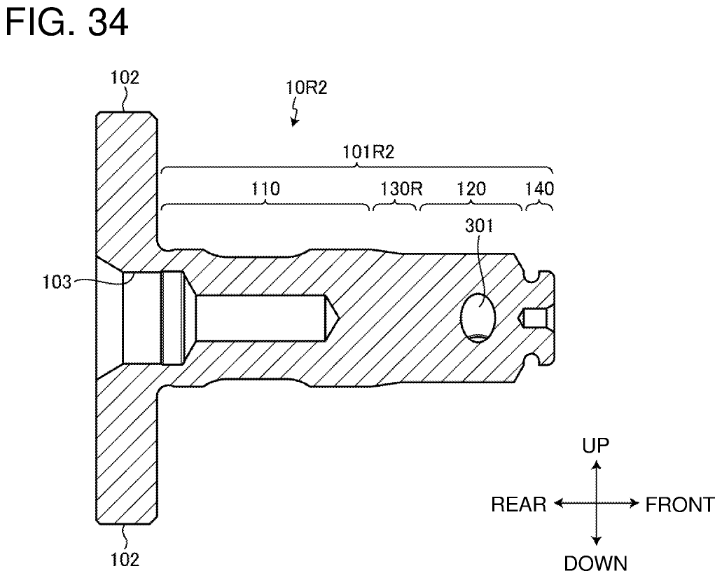

FIG. 31 is a perspective view of an anvil 10R2 in the present embodiment as viewed from the right front. FIG. 32 is a perspective view of the anvil 10R2 as viewed from the left rear. FIG. 33 is a side view of the anvil 10R2. FIG. 34 is a sectional view of the anvil 10R2.

The anvil 10R2 is a modification of the anvil 10R1 in the seventh embodiment described above. The anvil 10R2 includes an anvil shaft 101R2 including a reverse-rotation intermediate portion 130R.

As in the embodiment described above, a first shaft 110 is at least partially supported by the anvil bearing 46. The anvil 10R2 includes the first shaft 110, anvil projections 102, and a recess 103, each having the same structure (the same shape and the same dimensions) as the first shaft 110, the anvil projections 102, and the recess 103 on the anvil 10N1 or other anvils in the embodiments described above. The first shaft 110, the anvil projections 102, and the recess 103 are common components between the anvil 10R2 and the anvil 10N1 or other anvils in the embodiments described above.

The socket 300 is attached to the second shaft 120. The distal end 140 has a recess 140A. The socket 300 is fastened to the anvil 10R2 by the ring spring fastening.

A second shaft 120 in the anvil 10R2 has a structure different from the structure of the second shaft 120 in the anvil 10R1. The second shaft 120 in the anvil 10R2 has a pin hole 301 to receive a pin. In the embodiment, the socket 300 is fastened to the anvil 10R2 with two methods, or the ring spring fastening and the pin fastening.

The anvil 10R2 is rotated in the reverse direction when a bolt received in the socket 300 is loosened. The anvil 10R2 includes the reverse-rotation intermediate portion 130R. This increases the strength and the durability of the anvil 10R2 when the anvil 10R2 is rotated in the reverse direction with the socket 300 receiving the bolt.

### Tenth Embodiment

A tenth embodiment will be described. The same reference numerals herein denote the same or corresponding components as those in the above embodiment, and such components will be described briefly or will not be described.

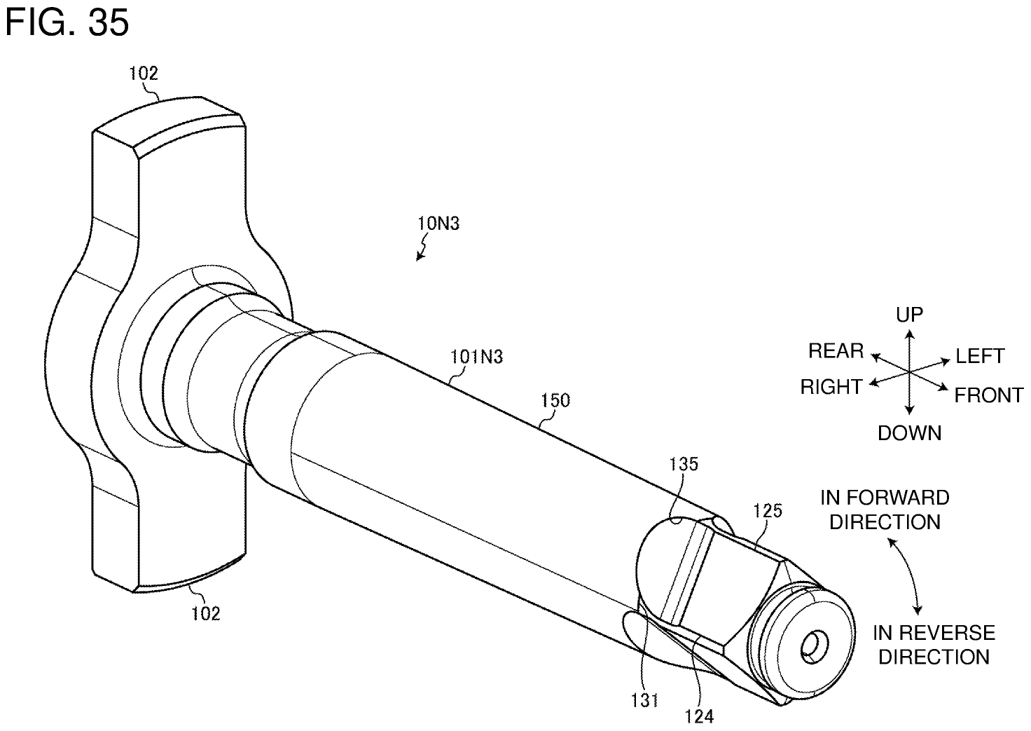

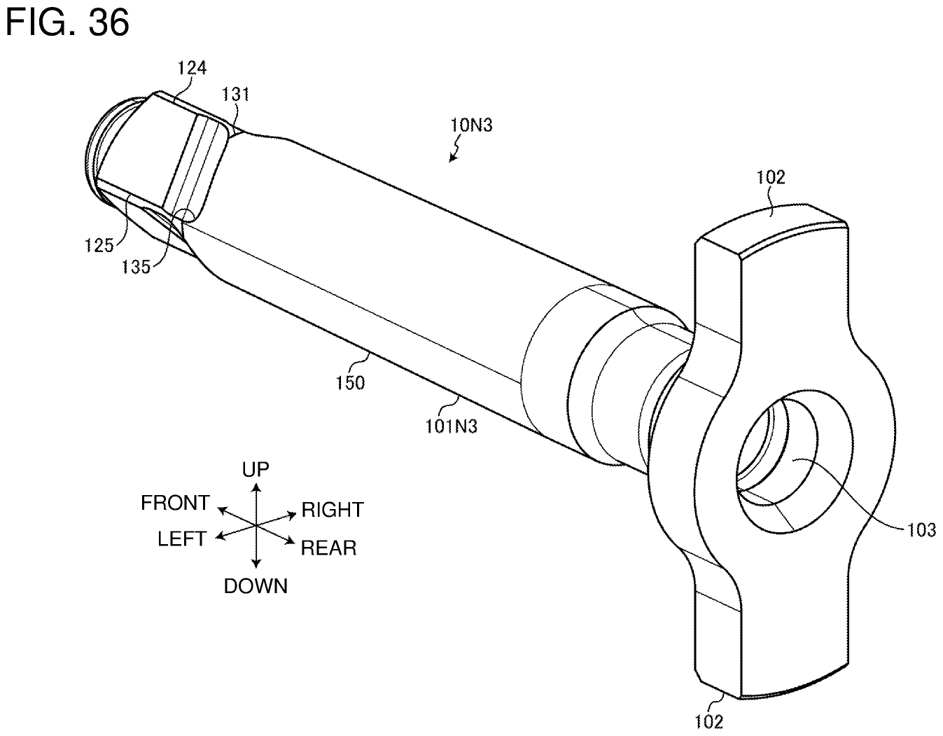

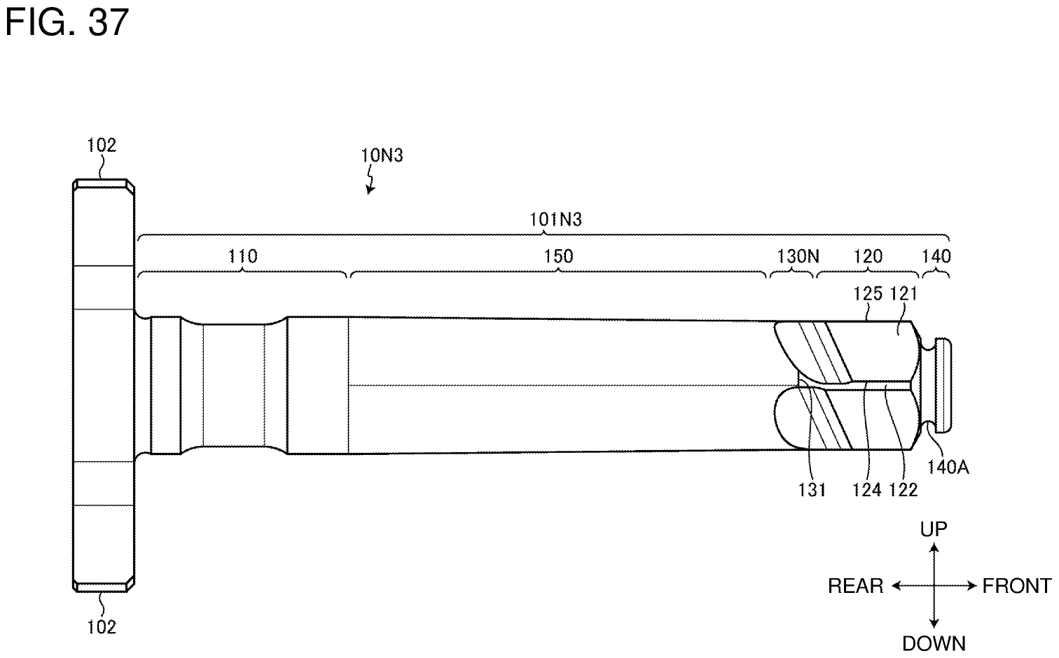

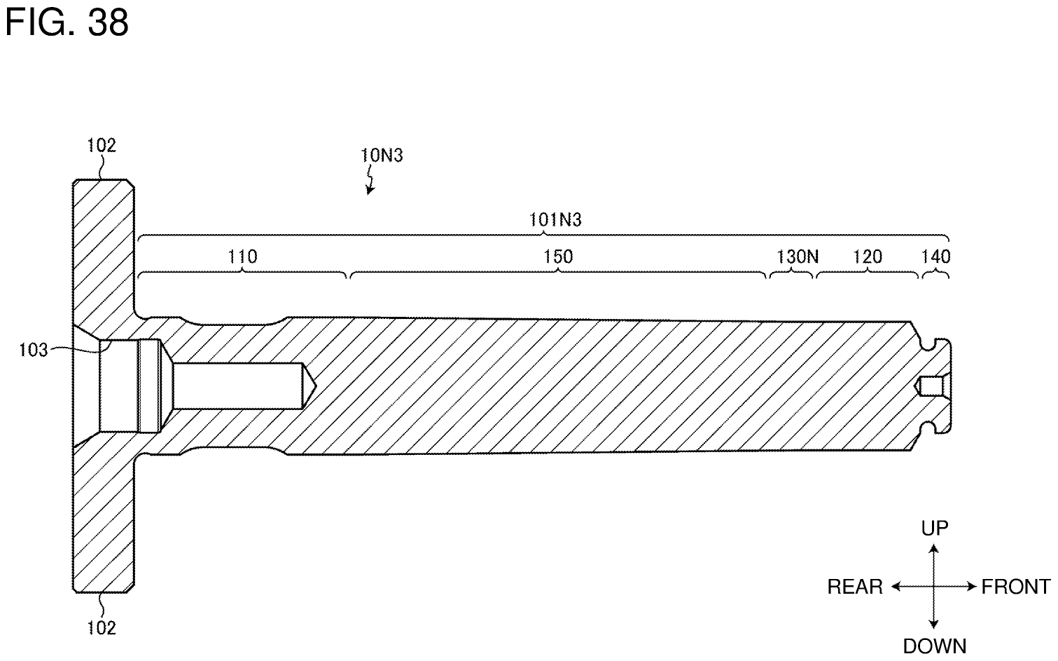

FIG. 35 is a perspective view of an anvil 10N3 in the present embodiment as viewed from the right front. FIG. 36 is a perspective view of the anvil 10N3 as viewed from the left rear. FIG. 37 is a side view of the anvil 10N3. FIG. 38 is a sectional view of the anvil 10N3.

The anvil 10N3 is a modification of the anvil 10N1 in the sixth embodiment described above. The anvil 10N3 includes an anvil shaft 101N3 including a forward-rotation intermediate portion 130N.

The anvil shaft 101N3 includes an intermediate portion 150. The intermediate portion 150 is between a first shaft 110 and the forward-rotation intermediate portion 130N in the axial direction. The anvil shaft 101N3 is longer than the anvil shaft 101N1 in the sixth embodiment described above.

As in the embodiment described above, the first shaft 110 is at least partially supported by the anvil bearing 46. The anvil 10N3 includes the first shaft 110, anvil projections 102, and a recess 103, each having the same structure (the same shape and the same dimensions) as the first shaft 110, the anvil projections 102, and the recess 103 on the anvil 10N1 or other anvils in the embodiments described above. The first shaft 110, the anvil projections 102, and the recess 103 are common components between the anvil 10N3 and the anvil 10N1 or other anvils in the embodiments described above.

The socket 300 is attached to the second shaft 120. A distal end 140 has a recess 140A. The socket 300 is fastened to the anvil 10N3 by the ring spring fastening.

The anvil 10N3 is rotated in the forward direction when a bolt received in the socket 300 is tightened. The anvil 10N3 includes the forward-rotation intermediate portion 130N. This increases the strength and the durability of the anvil 10N3 when the anvil 10N3 is rotated in the forward direction with the socket 300 receiving the bolt.

### Eleventh Embodiment

An eleventh embodiment will be described. The same reference numerals herein denote the same or corresponding components as those in the above embodiment, and such components will be described briefly or will not be described.

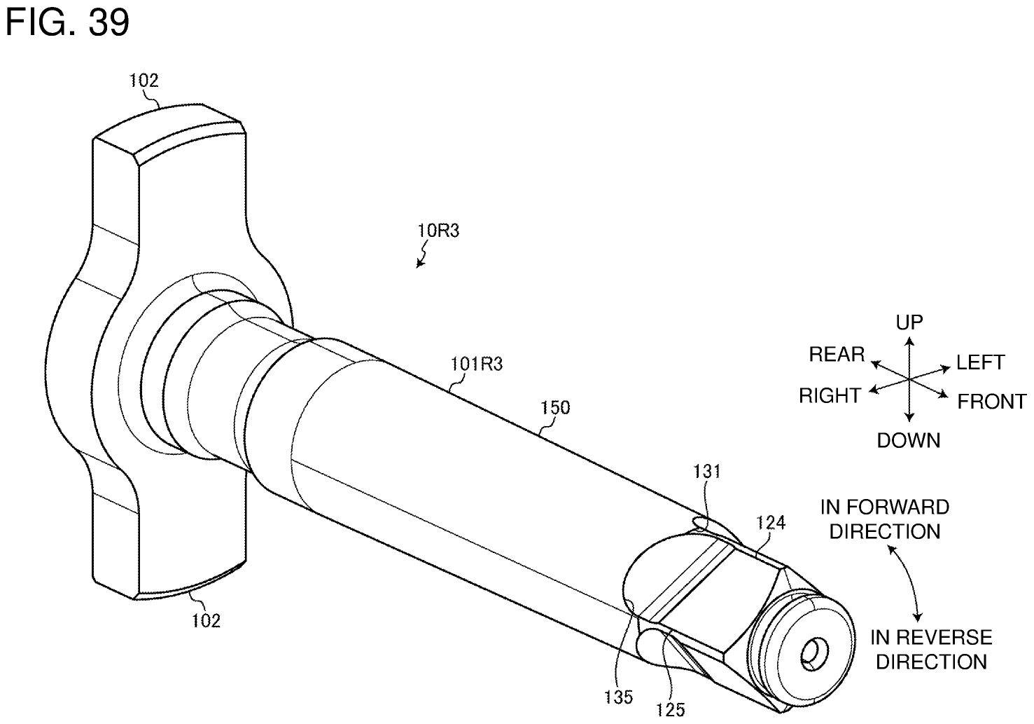

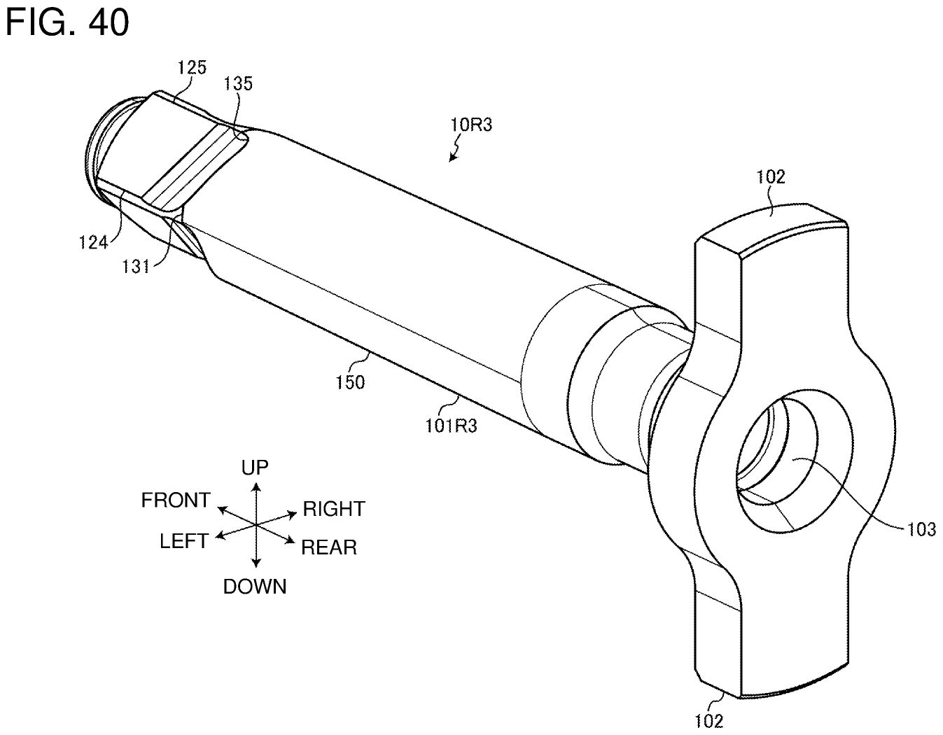

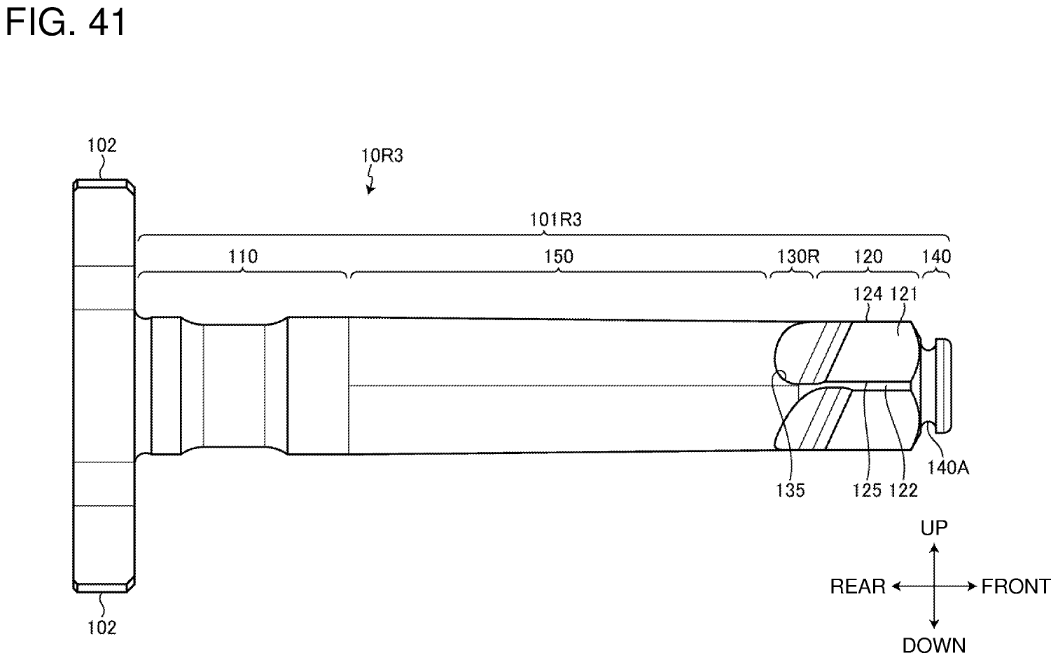

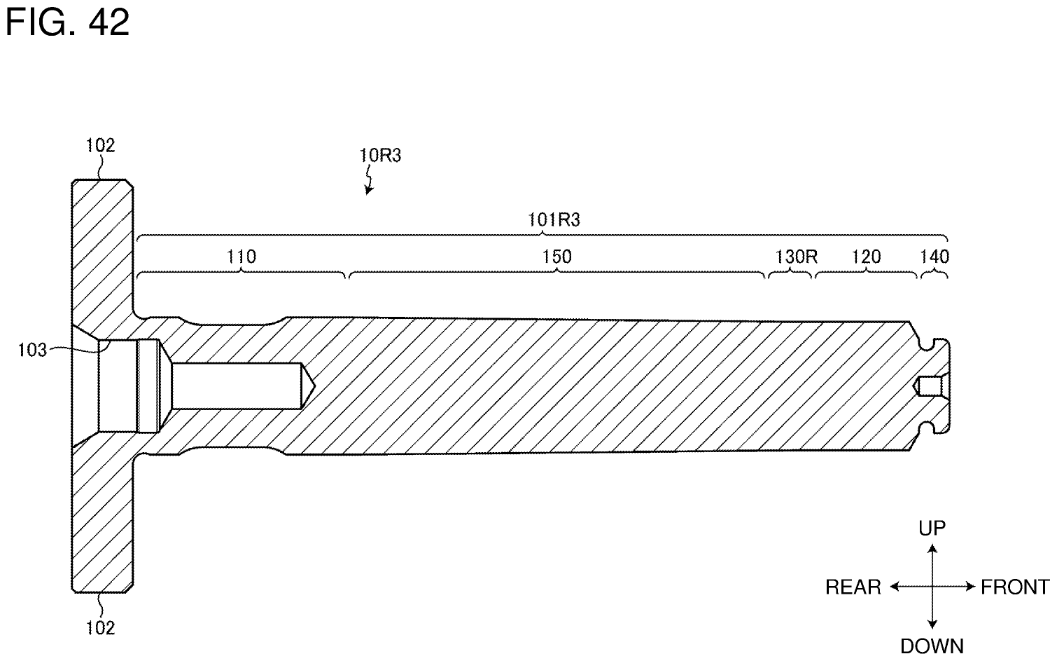

FIG. 39 is a perspective view of an anvil 10R3 in the present embodiment as viewed from the right front. FIG. 40 is a perspective view of the anvil 10R3 as viewed from the left rear. FIG. 41 is a side view of the anvil 10R3. FIG. 42 is a sectional view of the anvil 10R3.

The anvil 10R3 is a modification of the anvil 10R1 according to the seventh embodiment described above. The anvil 10R3 includes an anvil shaft 101R3 including the reverse-rotation intermediate portion 130R.

The anvil shaft 101R3 includes an intermediate portion 150. The intermediate portion 150 is between the first shaft 110 and the reverse-rotation intermediate portion 130R in the axial direction. The anvil shaft 101R3 is longer than the anvil shaft 101R1 in the seventh embodiment described above.

As in the embodiment described above, a first shaft 110 is at least partially supported by the anvil bearing 46. The anvil 10R3 includes the first shaft 110, anvil projections 102, and a recess 103, each having the same structure (the same shape and the same dimensions) as the first shaft 110, the anvil projections 102, and the recess 103 on the anvil 10N1 or other anvils in the embodiments described above. The first shaft 110, the anvil projections 102, and the recess 103 are common components between the anvil 10R3 and the anvil 10N1 or other anvils in the embodiments described above.

The socket 300 is attached to the second shaft 120. A distal end 140 has a recess 140A. The socket 300 is fastened to the anvil 10R3 by the ring spring fastening.

The anvil 10R3 is rotated in the reverse direction when a bolt received in the socket 300 is loosened. The anvil 10R3 includes the reverse-rotation intermediate portion 130R. This increases the strength and the durability of the anvil 10R3 when the anvil 10R3 is rotated in the reverse direction with the socket 300 receiving the bolt.

### Twelfth Embodiment

A twelfth embodiment will be described. The same reference numerals herein denote the same or corresponding components as those in the above embodiment, and such components will be described briefly or will not be described.

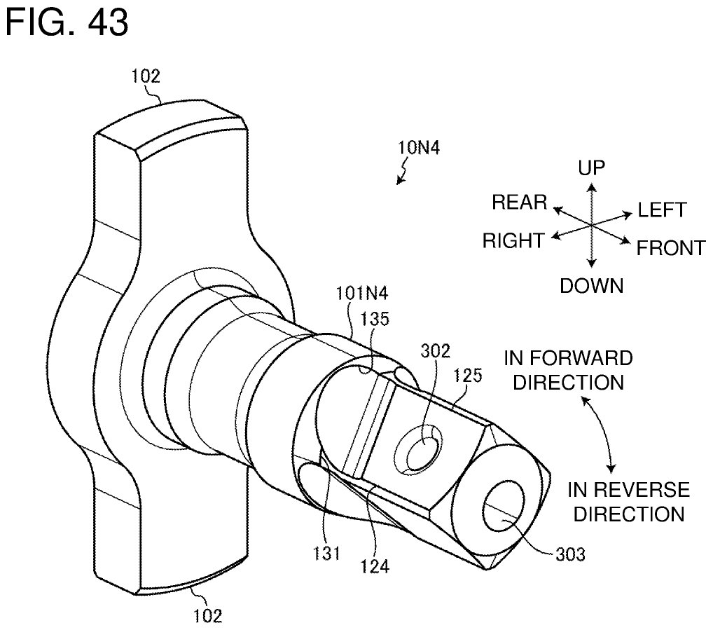

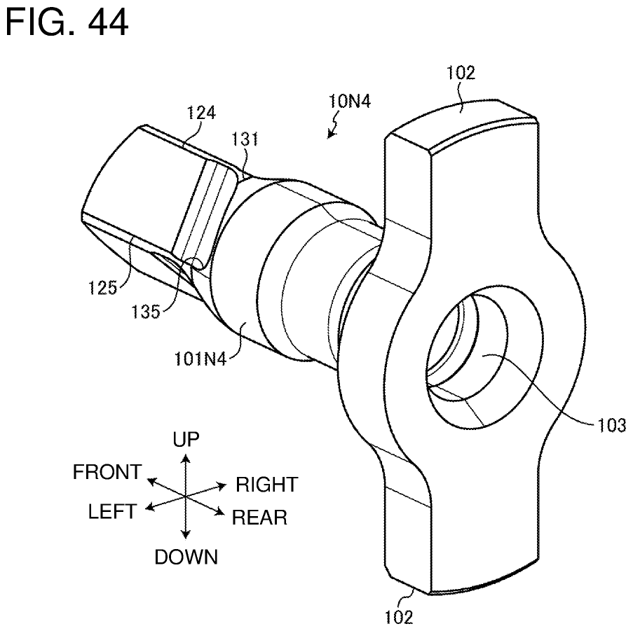

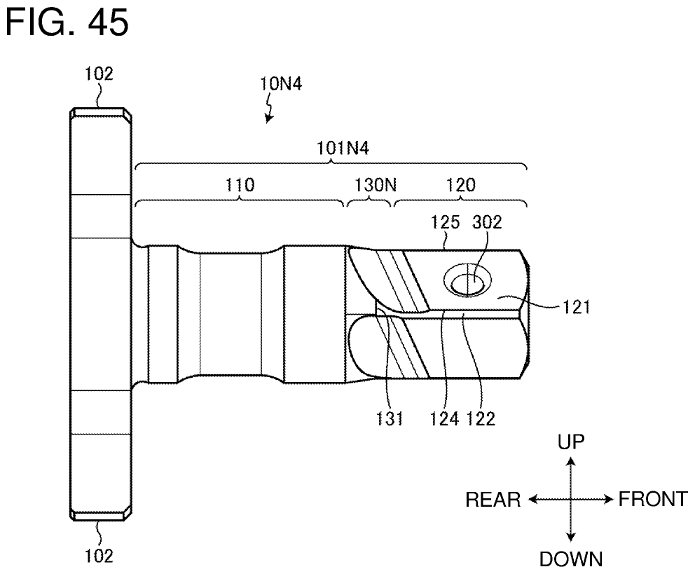

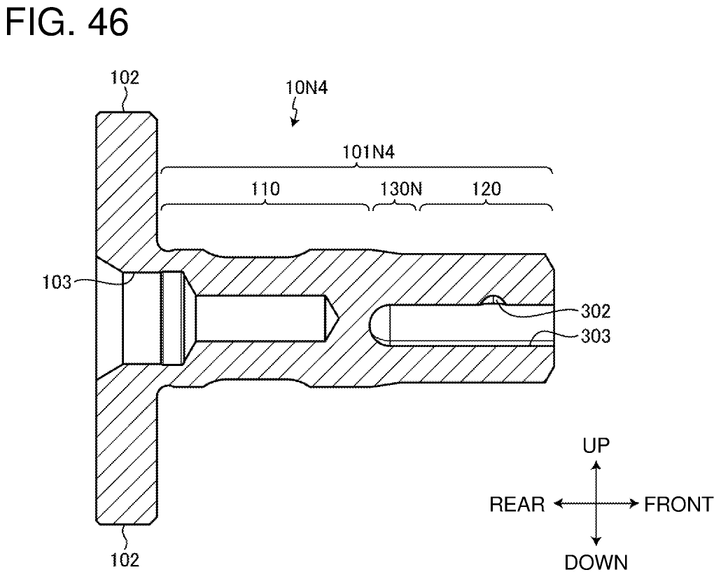

FIG. 43 is a perspective view of an anvil 10N4 in the present embodiment as viewed from the right front. FIG. 44 is a perspective view of the anvil 10N4 as viewed from the left rear. FIG. 45 is a side view of the anvil 10N4. FIG. 46 is a sectional view of the anvil 10N4.

The anvil 10N4 is a modification of the anvil 10N1 in the sixth embodiment described above. The anvil 10N4 includes an anvil shaft 101N4 including a forward-rotation intermediate portion 130N.

As in the embodiment described above, a first shaft 110 is at least partially supported by the anvil bearing 46. The anvil 10N4 includes the first shaft 110, anvil projections 102, and a recess 103, each having the same structure (the same shape and the same dimensions) as the first shaft 110, the anvil projections 102, and the recess 103 on the anvil 10N1 or other anvils in the embodiments described above. The first shaft 110, the anvil projections 102, and the recess 103 are common components between the anvil 10N4 and the anvil 10N1 or other anvils in the embodiments described above.

A second shaft 120 in the anvil 10N4 has a structure different from the structure of the second shaft 120 in the anvil 10N1. The second shaft 120 in the anvil 10N4 has a pin hole 302 and a reception hole 303. The reception hole 303 extends rearward from the front end face of the second shaft 120. The pin hole 302 connects the outer circumferential surface of the second shaft 120 and the reception hole 303. The reception hole 303 receives an elastic member (not shown). The pin hole 302 supports a pin (not shown) in a movable manner. The elastic member generates an elastic force for moving the pin radially outward. When the socket 300 is attached to the second shaft 120, the pin moves radially outward to fasten the socket 300, which is attached to the second shaft 120, to the second shaft 120. The method for fastening the socket 300 using a pin movable under an elastic force from the elastic member is hereafter referred to as pin-detent fastening.

The anvil 10N4 is rotated in the forward direction when a bolt received in the socket 300 is tightened. The anvil 10N4 includes the forward-rotation intermediate portion 130N. This increases the strength and the durability of the anvil 10N4 when the anvil 10N4 is rotated in the forward direction with the socket 300 receiving the bolt.

### Thirteenth Embodiment

A thirteenth embodiment will be described. The same reference numerals herein denote the same or corresponding components as those in the above embodiment, and such components will be described briefly or will not be described.

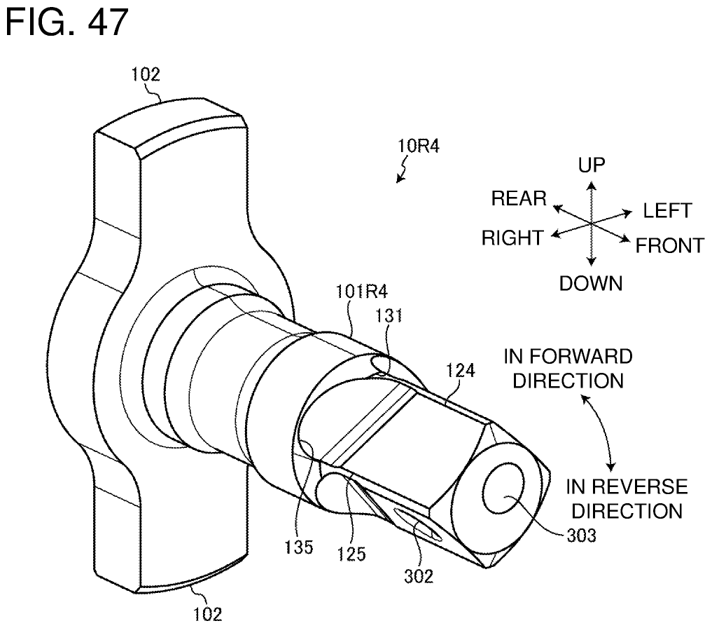

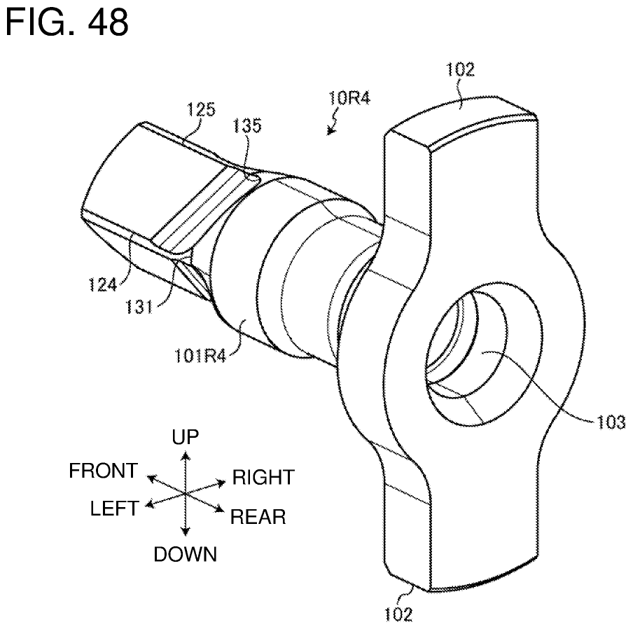

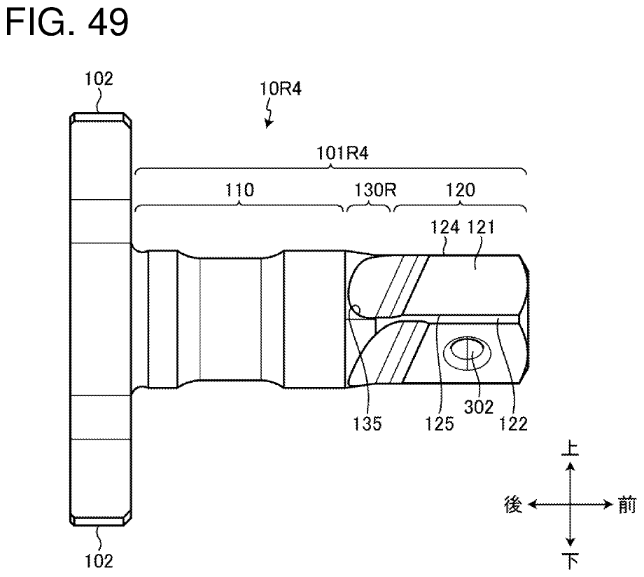

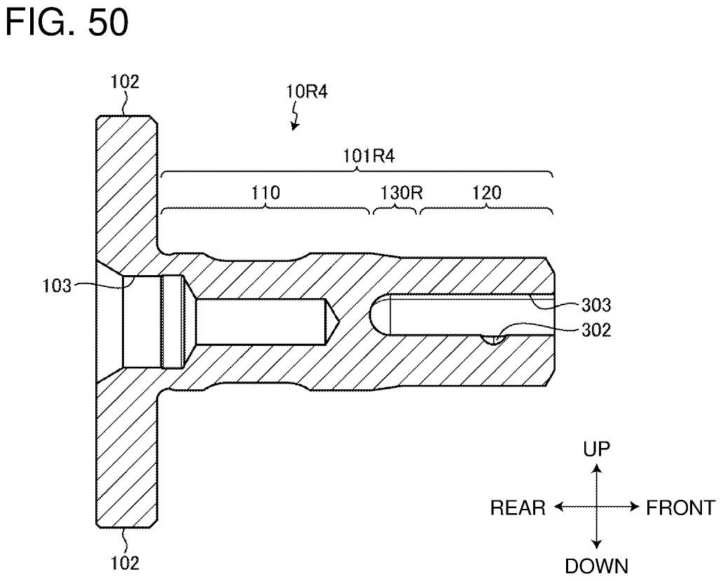

FIG. 47 is a perspective view of an anvil 10R4 in the present embodiment as viewed from the right front. FIG. 48 is a perspective view of the anvil 10R4 as viewed from the left rear. FIG. 49 is a side view of the anvil 10R4. FIG. 50 is a sectional of the anvil 10R4.

The anvil 10R4 is a modification of the anvil 10R1 in the seventh embodiment described above. The anvil 10R4 includes an anvil shaft 101R4 including a reverse-rotation intermediate portion 130R.

As in the embodiment described above, a first shaft 110 is at least partially supported by the anvil bearing 46. The anvil 10R4 includes the first shaft 110, anvil projections 102, and a recess 103, each having the same structure (the same shape and the same dimensions) as the first shaft 110, the anvil projections 102, and the recess 103 on the anvil 10N1 or other anvils in the embodiments described above. The first shaft 110, the anvil projections 102, and the recess 103 are common components between the anvil 10R4 and the anvil 10N1 or other anvils in the embodiments described above.

A second shaft 120 in the anvil 10R4 has a structure different from the structure of the second shaft 120 in the anvil 10R1. The second shaft 120 in the anvil 10R4 has a pin hole 302 and a reception hole 303. The socket 300 is fastened to the anvil 10R4 by the pin-detent fastening.

The anvil 10R4 is rotated in the reverse direction when a bolt received in the socket 300 is loosened. The anvil 10R4 includes the reverse-rotation intermediate portion 130R. This increases the strength and the durability of the anvil 10R4 when the anvil 10R4 is rotated in the reverse direction with the socket 300 receiving the bolt.

### Fourteenth Embodiment

A fourteenth embodiment will be described. The same reference numerals herein denote the same or corresponding components as those in the above embodiment, and such components will be described briefly or will not be described.

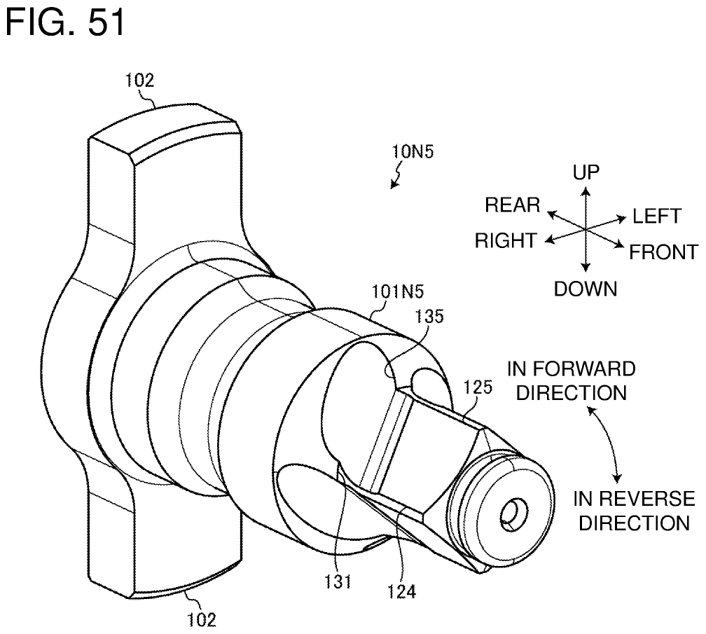

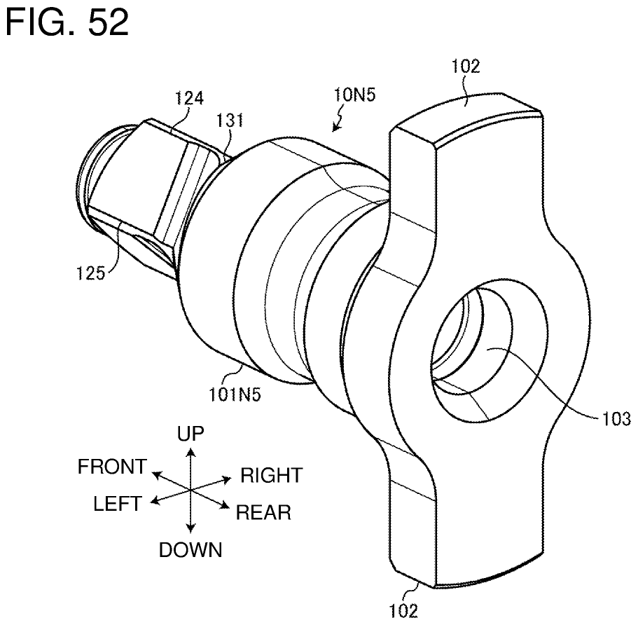

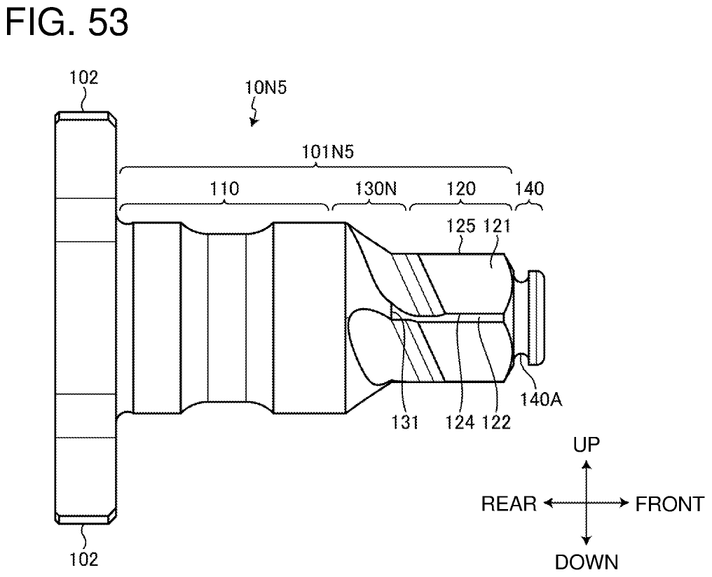

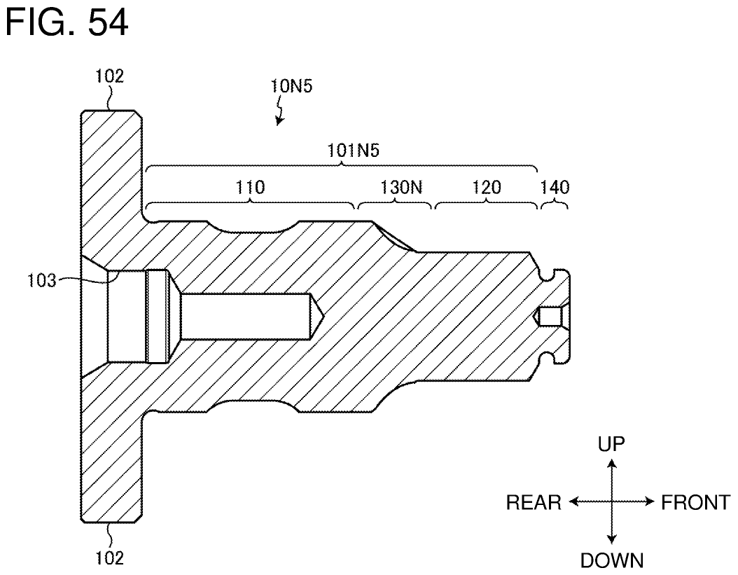

FIG. 51 is a perspective view of an anvil 10N5 in the present embodiment as viewed from the right front. FIG. 52 is a perspective view of the anvil 10N5 as viewed from the left rear. FIG. 53 is a side view of the anvil 10N5. FIG. 54 is a sectional of the anvil 10N5.

The anvil 10N5 is a modification of the anvil 10N1 in sixth embodiment described above. The anvil 10N5 includes an anvil shaft 101N5 including a forward-rotation intermediate portion 130N. The socket 300 is fastened to a second shaft 120 by the ring spring fastening.

The anvil 10N5 has a first shaft 110 thicker than the first shaft 110 in the anvil 10N1 or other anvils in the embodiments described above. The anvil 10N5 includes anvil projections 102 and a recess 103, each having the same structure (the same shape and the same dimensions) as the anvil projections 102 and the recess 103 on the anvil 10 or anvils in the embodiments described above. The anvil projections 102 and the recess 103 are common components between the anvil 10N5 and the anvil 10 or other anvils in the embodiments described above.

The anvil 10N5 is rotated in the forward direction when a bolt received in the socket 300 is tightened. The anvil 10N5 includes the forward-rotation intermediate portion 130N. This increases the strength and the durability of the anvil 10N5 when the anvil 10N5 is rotated in the forward direction with the socket 300 receiving the bolt.

### Fifteenth Embodiment

A fifteenth embodiment will be described. The same reference numerals herein denote the same or corresponding components as those in the above embodiment, and such components will be described briefly or will not be described.

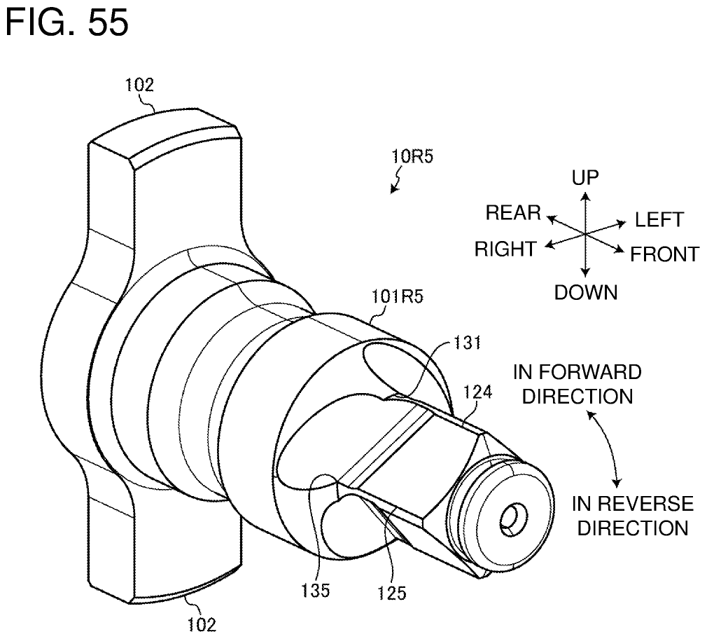

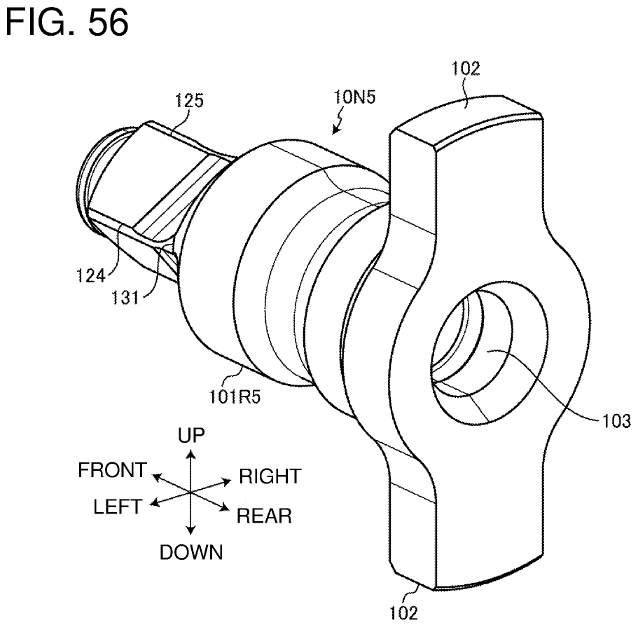

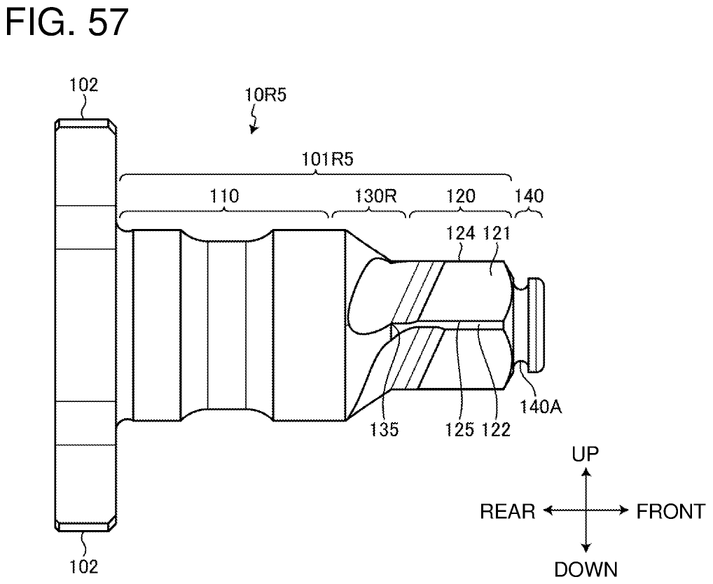

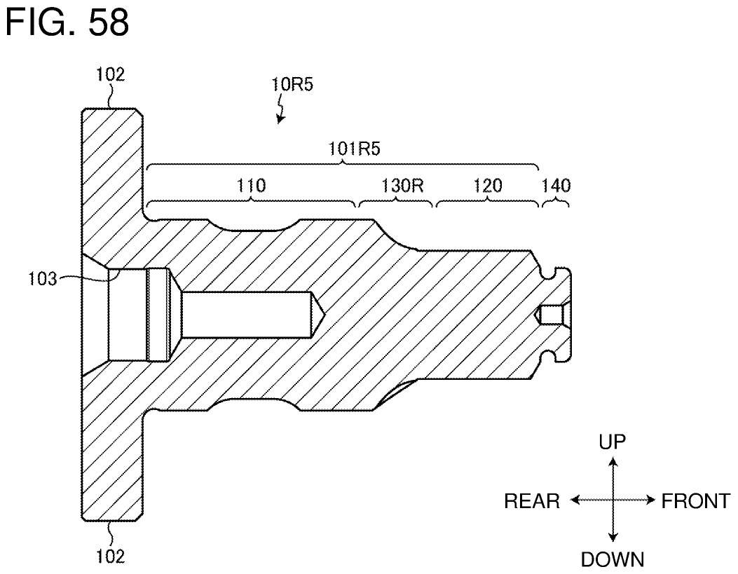

FIG. 55 is a perspective view of an anvil 10R5 in the present embodiment as viewed from the right front. FIG. 56 is a perspective view of the anvil 10R5 as viewed from the left rear. FIG. 57 is a side view of the anvil 10R5. FIG. 58 is a side view of the anvil 10R5.

The anvil 10R5 is a modification of the anvil 10R1 in the seventh embodiment described above. The anvil 10R5 includes an anvil shaft 101R5 including a reverse-rotation intermediate portion 130R. The socket 300 is fastened to a second shaft 120 by the ring spring fastening.

The anvil 10R5 has a first shaft 110 thicker than the first shaft 110 in the anvil 10N1 or other anvils in the embodiments described above. The anvil 10R5 includes anvil projections 102 and a recess 103, each having the same structure (the same shape and the same dimensions) as the anvil projections 102 and the recess 103 on the anvil 10 or anvils in the embodiments described above. The anvil projections 102 and the recess 103 are common components between the anvil 10R5 and the anvil 10 or other anvils in the embodiments described above.

The anvil 10R5 is rotated in the reverse direction when a bolt received in the socket 300 is loosened. The anvil 10R5 includes the reverse-rotation intermediate portion 130R. This increases the strength and the durability of the anvil 10R5 when the anvil 10R5 is rotated in the reverse direction with the socket 300 receiving the bolt.

### Sixteenth Embodiment

A sixteenth embodiment will be described. The same reference numerals herein denote the same or corresponding components as those in the above embodiment, and such components will be described briefly or will not be described.

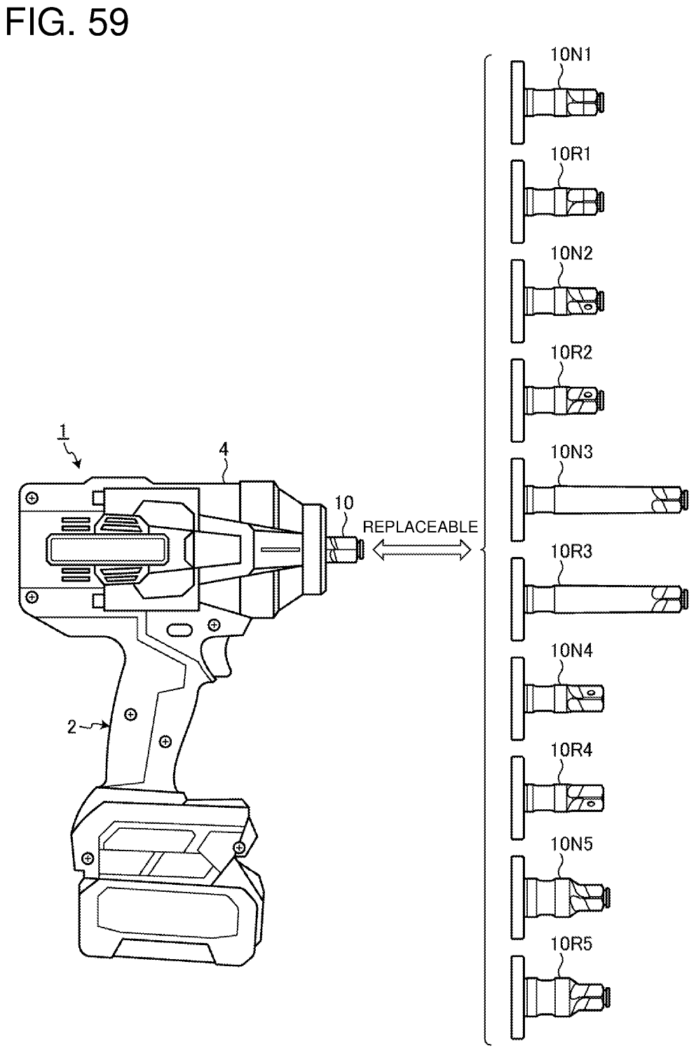

FIG. 59 is a diagram describing an anvil set in the present embodiment. The anvil set includes the anvils 10N1, 10R1, 10N2, 10R2, 10N3, 10R3, 10N4, 10R4, 10N5, and 10R5 described in the embodiments described above.

As described in the above embodiments, the anvils 10N1, 10N2, 10N3, 10N4, and 10N5 each include the forward-rotation intermediate portion 130N. The anvils 10R1, 10R2, 10R3, 10R4, and 10R5 each include the reverse-rotation intermediate portion 130R. The forward-rotation intermediate portion 130N and the reverse-rotation intermediate portion 130R have different shapes.

The first shaft 110, the anvil projections 102, and the recess 103 on each of the anvils 10N1, 10N2, 10N3, 10N4, 10R1, 10R2, 10R3, and 10R4 are components common to one another having the same structures (the same shapes and the same dimensions). The anvil bearing 46 thus supports the anvils 10N1, 10R1, 10N2, 10R2, 10N3, 10R3, 10N4, and 10R4 to be replaceable with one another. The anvil bearing 46 can support the first shaft 110 in the anvil 10N1, 10R1, 10N2, 10R2, 10N3, 10R3, 10N4, or 10R4. The hammer 47 can strike the anvil projections 102 on the anvil 10N1, 10R1, 10N2, 10R2, 10N3, 10R3, 10N4, or 10R4.

The forward-rotation intermediate portion 130N and the second shaft 120 in each of the anvils 10N1, 10N2, 10N3, and 10N4 have structures different from the structures of the reverse-rotation intermediate portion 130R and the second shaft 120 in each of the anvils 10R1, 10R2, 10R3, and 10R4. This allows the operator to attach any one of the above anvils to the impact tool 1 for an intended operation.

In a bolt tightening operation, the anvil 10N1, 10N2, 10N3, or 10N4, including the forward-rotation intermediate portion 130N, is attached to the impact tool 1. This increases the strength and the durability of the anvil when the anvil is rotated in the forward direction.

In a bolt loosening operation, the anvil 10R1, 10R2, 10R3, or 10R4, including the reverse-rotation intermediate portion 130R, is attached to the impact tool 1. This increases the strength and the durability of the anvil 10 when the anvil 10 is rotated in the reverse direction.

The anvils in the anvil set may include the anvil projections 102 and the recess 103 as components common to the anvils. In other words, the anvil set may include the anvils 10N1, 10R1, 10N2, 10R2, 10N3, 10R3, 10N4, 10R4, 10N5, and 10R5.

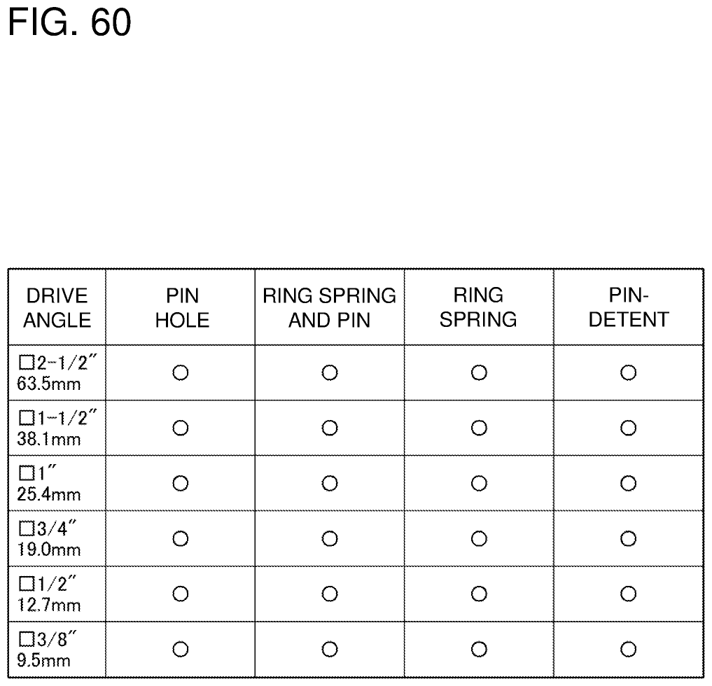

FIG. 60 is a table describing the anvil set in the embodiment. The anvil set may include multiple anvils each including the second shaft 120 of a different dimension. FIG. 60 shows a usable anvil with a circle. As shown in FIG. 60, the second shaft 120 may have a dimension of two-and-a-half inches (63.5 mm), one-and-a-half inches (38.1 mm), an inch (25.4 mm), three-quarters of an inch (19.0 mm), a half an inch (12.7 mm), or three-eighths of an inch (9.5 mm). As described above, the second shaft 120 has a rectangular cross section orthogonal to the rotation axis AX. The dimension of the second shaft 120 corresponds to a distance between a pair of outer surfaces facing each other (the dimension of each flat portion 121 in the vertical direction or in the lateral direction). The socket 300 may be fastened by the pin fastening, a combination of the ring spring fastening and the pin fastening, the ring spring fastening, or the pin-detent fastening.

### Seventeenth Embodiment

A seventeenth embodiment will be described. The same reference numerals herein denote the same or corresponding components as those in the above embodiment, and such components will be described briefly or will not be described.

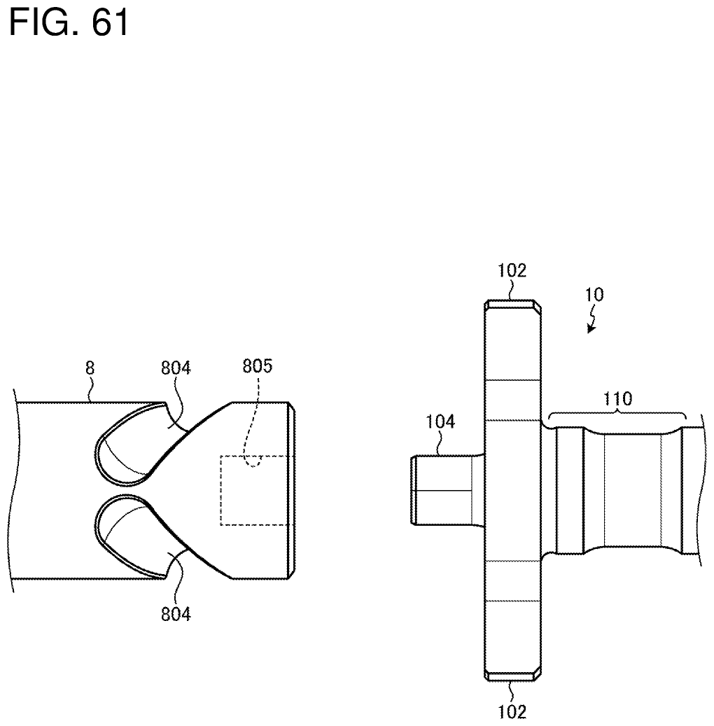

FIG. 61 is a diagram describing a spindle 8 and an anvil 10 in the present embodiment. In the above embodiments, the anvil 10 has the recess 103 on its rear surface, and the spindle 8 has its front end received in the recess 103. As shown in FIG. 61, the anvil 10 may include a protrusion 104 protruding rearward from the rear surface of the anvil 10. The spindle 8 may have a recess 805 on its front end. The protrusion 104 may be received in the recess 805. The protrusion 104 may be common to the multiple anvils included in the anvil set.

### Other Embodiments

In the above embodiments, the striker 9 may not include the hammer 47. The striker 9 may strike the anvil in an oil-pulse impact (soft impact) manner.

In the above embodiments, the second shaft 120 may not be a square prism, and may be a triangular prism or a hexagonal prism. The second shaft 120 may have a regular polygonal cross section.

In the above embodiments, each flat portion connector 122 may be a corner connecting two adjacent flat portions 121 at an acute angle or may be a corner connecting two adjacent flat portions 121 in an arc (in a curved manner).

In the above embodiments, the impact tool 1 may use utility power (alternating current power supply) in place of the battery pack 25.

### REFERENCE SIGNS LIST

1 impact tool (impact wrench)
2 housing
2L left housing
2R right housing
2S screw
2T screw
3 cover
4 hammer case
6 motor
7 reducer
8 spindle
9 striker
10 anvil
10N1 anvil
10R1 anvil
10N2 anvil
10R2 anvil
10N3 anvil
10R3 anvil
10N4 anvil
10R4 anvil
10N5 anvil
10R5 anvil
12 fan
13 battery mount
14 trigger lever
15 forward-reverse switch lever
16 operation display
16A operation button
16B indicator
17 light
19 inlet
20 outlet
21 motor compartment
22 grip
23 battery holder
24 bearing box
25 battery pack
26 stator
27 rotor
28 stator core
29 front insulator
30 rear insulator
31 coil
32 rotor core
33 rotor shaft
34 rotor magnet
37 sensor board
38 busbar unit
39 rotor bearing
39F front rotor bearing
39R rear rotor bearing
41 pinion gear
42 planetary gear
42P pin
43 internal gear
44 spindle bearing
46 anvil bearing
47 hammer
48 hammer ball
50 coil spring
51 first coil spring
52 second coil spring
53 washer
54 support ball
61 washer
62 washer
70 seal
71 outer ring
72 rear lip
73 front lip
80 support
85 ring spring
101 anvil shaft
101N1 anvil shaft
101R1 anvil shaft
101N2 anvil shaft
101R2 anvil shaft
101N3 anvil shaft
101R3 anvil shaft
101N4 anvil shaft
101R4 anvil shaft
101N5 anvil shaft
101R5 anvil shaft
102 anvil projection
103 recess
104 protrusion
110 first shaft
111 recess
112 rear columnar portion
113 recess
114 front columnar portion
120 second shaft
121 flat portion
121A flat portion
121B flat portion
121C flat portion
121D flat portion
122 flat portion connector
122A flat portion connector
122B flat portion connector
122C flat portion connector
122D flat portion connector
123 recess
123A front edge
123B rear edge
124 first edge
125 second edge
126 projection
130 intermediate portion
130N intermediate portion (forward-rotation intermediate portion)
130R intermediate portion (reverse-rotation intermediate portion)
131 support portion
131A support portion
131B support portion
131C support portion
131D support portion
132 curved portion
133 curve
134 tapered portion
135 joint
140 distal end
140A recess
150 intermediate portion
241 recess
242 recess
300 socket
301 pin hole
302 pin hole
303 reception hole
401 first cylinder
402 second cylinder
402R rear surface
402S inner circumferential surface
403 case connector
404 third cylinder
404R rear surface
404S inner circumferential surface
405 fourth cylinder
405R rear surface
405S inner circumferential surface
461 outer ring
461F front surface
461R rear surface
461S inner circumferential surface
461T outer circumferential surface
462 rear support
462F front surface
462R rear surface
462S inner circumferential surface
463 front support
463F front surface
463R rear surface
463S inner circumferential surface
464 rear protrusion
464R rear surface
464T outer circumferential surface
465 front protrusion
465F front surface
465S inner circumferential surface
465T outer circumferential surface
466 recess
471 base
473 rear ring
474 support ring
474A larger-diameter portion
474B smaller-diameter portion
474C step
475 hammer projection
476 recess
477 hammer groove
478 support groove
801 spindle shaft
802 flange
803 protrusion
804 spindle groove
805 recess
1010 anvil
1101 anvil shaft
1301 first portion
1302 second portion
2010 anvil
2101 anvil shaft
3010 anvil
3101 anvil shaft
AX rotation axis
CX center line

What is claimed is:

1. An impact wrench, comprising:
a motor including a rotor rotatable about a rotation axis extending in a front-rear direction;
a spindle rotatable with a rotational force from the rotor;
an anvil located frontward from at least a part of the spindle, the anvil including
an anvil shaft extending in an axial direction parallel to the rotation axis, the anvil shaft including
a first shaft having a circular cross section orthogonal to the rotation axis,
a second shaft located frontward from the first shaft and having a rectangular cross section orthogonal to the rotation axis, the second shaft including
four flat portions each having
a first edge at an end of the flat portion in a first circumferential direction of the rotation axis, and
a second edge at an end of the flat portion in a second circumferential direction of the rotation axis, and
four flat portion connectors, and
an intermediate portion between the first shaft and the second shaft, the intermediate portion including support portions each connected to the first edge, the intermediate portion being connected to the second edge of each of the four flat portions at positions rearward from the support portions, and
an anvil projection protruding outward from the anvil shaft in a radial direction of the rotation axis; and
a hammer supported by the spindle, the hammer including a hammer projection configured to strike the anvil projection in a rotation direction.

2. The impact wrench according to claim 1, wherein
the second shaft receives a socket, and
the socket comes in contact with the support portions being four support portions.

3. The impact wrench according to claim 2, wherein
the anvil is rotated in the first circumferential direction when a bolt received in the socket is tightened.

4. The impact wrench according to claim 3, wherein
the intermediate portion includes joints each connected to the second edge,
the joints are located rearward from the support portions, and
the socket comes in contact with the four support portions and is out of contact with the joints being four joints.

5. The impact wrench according to claim 4, wherein
the intermediate portion has curved portions between the joints and the support portions, and the curved portions are connected to the four flat portions, and
the socket is out of contact with the curved portions.

6. The impact wrench according to claim 1, further comprising:
an anvil bearing supporting at least a part of the first shaft.

7. An impact wrench, comprising:
a motor including a rotor rotatable about a rotation axis extending in a front-rear direction;
a spindle rotatable with a rotational force from the rotor;
an anvil located frontward from at least a part of the spindle, the anvil including
an anvil shaft extending in an axial direction parallel to the rotation axis, the anvil shaft including
a first shaft having a circular cross section orthogonal to the rotation axis,
a second shaft located frontward from the first shaft and having a rectangular cross section orthogonal to the rotation axis, the second shaft including
four flat portions each having
a first edge at an end of the flat portion in a first circumferential direction of the rotation axis, and
a second edge at an end of the flat portion in a second circumferential direction of the rotation axis, and
four flat portion connectors, and
an intermediate portion between the first shaft and the second shaft, the intermediate portion including, in a plane parallel to each of the four flat portions, a first portion and a second portion, the first portion being located in the first circumferential direction from a center line of a corresponding flat portion of the four flat portions in a circumferential direction and connected to the first edge, the second portion being located in the second circumferential direction from the center line and connected to the second edge, the first portion and the second portion having different shapes, and
an anvil projection protruding outward from the anvil shaft in a radial direction of the rotation axis; and
a hammer supported by the spindle, the hammer including a hammer projection configured to strike the anvil projection in a rotation direction.

8. The impact wrench according to claim 7, wherein
the intermediate portion includes support portions each connected to the first edge, and is connected to the second edge of each of the four flat portions at positions rearward from the support portions.

9. The impact wrench according to claim 8, wherein
the intermediate portion includes joints each connected to the second edge and located rearward from the support portions,
the second shaft receives a socket, and
the socket comes in contact with the support portions and is out of contact with the joints.

10. The impact wrench according to claim 9, wherein
the intermediate portion has curved portions between the joints and the support portions, and the curved portions are connected to the four flat portions,
recesses are located between the intermediate portion and the four flat portions in the axial direction,
each of the recesses connects the first edge and the second edge,
each of the recesses has a front edge defining a front end of the recess and a rear edge defining a rear end of the recess, and the front edge and the rear edge are parallel to each other,
the front edge has a first end connected to the first edge and a second end connected to the second edge, and the first end and the second end are at different positions, and
a distance between the first end of the front edge and the support portions is one-sixth to one-fifth inclusive of a distance between a front end of the anvil and a rear end of the intermediate portion in the axial direction.

11. The impact wrench according to claim 10, wherein
an angle formed between the front edge and a reference line orthogonal to the center line is 15 to 25 degrees inclusive.

12. An impact wrench, comprising:
a motor including a rotor rotatable about a rotation axis extending in a front-rear direction;
a spindle rotatable with a rotational force from the rotor;
an anvil located frontward from at least a part of the spindle, the anvil including
an anvil shaft extending in an axial direction parallel to the rotation axis, the anvil shaft including
a first shaft having a circular cross section orthogonal to the rotation axis,
a second shaft located frontward from the first shaft and having a rectangular cross section orthogonal to the rotation axis, the second shaft including
four flat portions, and
four flat portion connectors, and
an intermediate portion between the first shaft and the second shaft, and
an anvil projection protruding outward from the anvil shaft in a radial direction of the rotation axis;
a hammer supported by the spindle, the hammer including a hammer projection configured to strike the anvil projection in a rotation direction; and
an anvil bearing supporting the anvil,
wherein the anvil is a first anvil including the intermediate portion in a first shape or a second anvil including the intermediate portion in a second shape, and
the anvil bearing supports the first anvil to be replaceable with the second anvil.

13. The impact wrench according to claim 12, wherein
each of the four flat portions has
a first edge at an end of the flat portion in a first circumferential direction of the rotation axis, and
a second edge at an end of the flat portion in a second circumferential direction of the rotation axis, and
the intermediate portion includes support portions each connected to the first edge, and is connected to the second edge of each of the four flat portions at positions rearward from the support portions.

14. The impact wrench according to claim 13, wherein
the intermediate portion includes joints each connected to the second edge and located rearward from the support portions,
the second shaft receives a socket, and
the socket comes in contact with the support portions and is out of contact with the joints.

15. The impact wrench according to claim 14, wherein
the anvil is rotated in the first circumferential direction when a bolt received in the socket is tightened.

16. The impact wrench according to claim 14, wherein
the anvil is rotated in the second circumferential direction when a bolt received in the socket is loosened.

17. The impact wrench according to claim 2, further comprising:
an anvil bearing supporting at least a part of the first shaft.

18. The impact wrench according to claim 3, further comprising:
an anvil bearing supporting at least a part of the first shaft.

19. The impact wrench according to claim 4, further comprising:
an anvil bearing supporting at least a part of the first shaft.

20. The impact wrench according to claim 5, further comprising:
an anvil bearing supporting at least a part of the first shaft.
